(19) United States
(12) Patent Application Publication
(10) Pub. No.: US 2025/0359621 A1
(43) Pub. Date: Nov. 27, 2025

(54) POWERED FOOTWEAR ATTACHMENT

(71) Applicant: Dephy, Inc., Boxborough, MA (US)

(72) Inventors: Luke Mooney, Sudbury, MA (US); William Marvin, Canton, MA (US); Jonathan Cummings, Concord, MA (US); Spencer Parker, Boxborough, MA (US)

(73) Assignee: Dephy, Inc., Boxborough, MA (US)

(21) Appl. No.: 19/214,959

(22) Filed: May 21, 2025

Related U.S. Application Data
(60) Provisional application No. 63/650,829, filed on May 22, 2024.
(60) Provisional application No. 63/729,096, filed on Dec. 6, 2024.

(51) Int. Cl. A43B 7/14; A43B 3/38; A43B 3/44; B25J 9/00; B25J 19/00

(52) U.S. Cl. CPC A43B 7/14; A43B 3/38; A43B 3/44; B25J 9/0006; B25J 19/007

(57) ABSTRACT

A power footwear attachment is described. An apparatus can include a shoe, a footplate, a footplate adapter, and a spacer. The footplate adapter can be disposed on a posterior portion of the footplate and configured to couple with an actuator adapter coupled with an actuator module. The spacer can be disposed between the posterior portion and an upper of the shoe. The spacer can compress upon application of force to the footplate by the actuator module. An apparatus can include an actuator module, an arm, and an actuator adapter. The actuator adapter can be coupled to a second end of the arm and include one or more magnets configured to engage with a footplate adapter disposed on a posterior portion of a footplate of a shoe and a latch configured to engage with the footplate adapter.

### CROSS REFERENCE TO RELATED APPLICATIONS

This application claims the benefit of priority under 35 U.S.C. § 119 to U.S. Provisional Patent Application No. 63/650,829, filed May 22, 2024, and U.S. Provisional Patent Application No. 63/729,096, filed Dec. 6, 2024, each of which is hereby incorporated by reference herein in its entirety.

### BACKGROUND

Exoskeletons can be worn by a user to facilitate movement of limbs of the user.

### SUMMARY

This disclosure is generally directed to a lower leg exoskeleton that can be attached and detached to a footwear. The footwear can include a footplate adapter disposed on a footplate of the footwear to couple with an actuator module of the exoskeleton. The actuator module can include an actuator adapter to couple to the footplate adapter. The footwear can be worn by a user, and the attachment of the actuator module can enable augmentation of movement of the user, thereby facilitating movement of the limbs of the user.

The systems and methods of the present disclosure can include an apparatus. The apparatus can include a shoe including an upper and an outsole. The apparatus can include a footplate including a posterior portion and a bottom portion, the bottom portion of the footplate disposed between the upper and the outsole. The apparatus can include a footplate adapter disposed on the posterior portion of the footplate and configured to couple with an actuator adapter coupled with an actuator module. The apparatus can include a spacer disposed between the posterior portion of the footplate and the upper, the spacer configured to compress upon application of force to the footplate by the actuator module.

In various implementations, the posterior portion of the footplate and the upper can be separated by a gap, and the spacer is disposed in the gap. The shoe can include an upper midsole disposed between the upper and the footplate and a lower midsole disposed between the footplate and the outsole. The spacer can have a first durometer, the upper midsole can have a second durometer, and the lower midsole can have a third durometer. The first durometer can be less than the second durometer and the third durometer. The footplate can include a heel portion, a forefoot portion, and a midfoot portion extending between the heel portion and the forefoot portion. The heel portion and the midfoot portion can be partially encapsulated by the upper midsole and the lower midsole. The forefoot portion can be entirely encapsulated by the upper midsole and the lower midsole. A back portion of the upper midsole can define a recess, and the spacer can be disposed in the recess. The spacer can include a protrusion disposed over an upper edge of the posterior portion of the footplate. The spacer can include at least one of a foam, elastomer, gel, or a combination thereof.

In various implementations, the footplate adapter can include a ferrous pin disposed on a lower portion of the posterior portion of the footplate and configured to couple with a distal portion of the actuator adapter. The footplate adapter can include a catch disposed on an upper portion of the posterior portion of the footplate and configured to engage with a latch of the actuator adapter. The catch can include a ramp configured to engage with the latch. The footplate can include fibers configured to increase at least one of stiffness, strength, or flexibility of the footplate. The footplate adapter can be disposed on an outer surface of the posterior portion of the footplate.

Another aspect of the present disclosure is directed towards a method. The method can include disposing a bottom portion of a footplate between an upper and an outsole of a shoe. The method can include disposing a footplate adapter on a posterior portion of the footplate, the footplate adapter configured to couple with an actuator adapter coupled with an actuator module. The method can include disposing a spacer between the posterior portion of the footplate and the upper, the spacer configured to compress upon application of force to the footplate by the actuator module.

In various implementations, the method can include separating the posterior portion of the footplate and the upper by a gap. The method can include disposing the spacer in the gap. The method can include disposing an upper midsole between the upper and the footplate. The method can include disposing a lower midsole between the footplate and the outsole. The method can include partially encapsulating a heel portion of the footplate and a midfoot portion of the footplate by the upper midsole and the lower midsole. The method can include entirely encapsulating a forefoot portion of the footplate by the upper midsole and the lower midsole. The method can include disposing a protrusion of the spacer over an upper edge of the posterior portion of the footplate.

In various implementations, the spacer can include at least one of a foam, elastomer, gel, or a combination thereof. The method can include disposing fibers in the footplate to increase at least one of stiffness, strength, or flexibility of the footplate. The method can include disposing the footplate adapter on an outer surface of the posterior portion of the footplate.

Another aspect of the present disclosure is directed towards an apparatus. The apparatus can include an actuator module. The apparatus can include an arm having a first end and a second end, the first end of the arm coupled with the actuator module. The apparatus can include an actuator adapter coupled with the second end of the arm and including one or more magnets configured to engage with a footplate adapter disposed on a posterior portion of a footplate of a shoe and a latch configured to engage with the footplate adapter.

In various implementations, the actuator adapter can include a distal portion and a proximal portion, the one or more magnets disposed on the distal portion and the latch disposed on the proximal portion. The actuator adapter can define a recess disposed between the distal portion and the proximal portion; the recess configured to receive a catch disposed on an upper portion of the posterior portion of the footplate. The distal portion can include a concave portion configured to receive a ferrous pin disposed on a lower portion of the posterior portion of the footplate. The latch can be configured to engage with a catch disposed on an upper portion of the posterior portion of the footplate. Application of force to the latch can release the actuator adapter from the footplate adapter.

In various implementations, the apparatus can include a tab coupled with the latch. Application of force to the tab can release the actuator adapter from the footplate adapter. The latch can be spring-loaded. The apparatus can include the footplate of the shoe and the footplate adapter disposed on the posterior portion of the footplate of the shoe. The footplate adapter can include a ferrous pin disposed on a lower portion of the posterior portion of the footplate and a catch disposed on an upper portion of the posterior portion of the footplate. The one or more magnets can be configured to engage with the ferrous pin. The latch can be configured to engage with the catch. The catch can include a ramp configured to engage with the latch. The actuator module can be configured to provide a force to the actuator adapter.

Another aspect of the present disclosure is directed towards a method. The method can include coupling a first end of an arm with an actuator module. The method can include coupling an actuator adapter having one or more magnets and a latch with a second end of the arm. The method can include engaging the one or more magnets with a footplate adapter disposed on a posterior portion of a footplate of a shoe. The method can include engaging the latch with the footplate adapter.

In various implementations, the method can include decoupling the actuator adapter with the footplate adapter by releasing the latch. The method can include coupling the actuator adapter with the footplate adapter by setting the latch. The method can include coupling a recess of the actuator adapter with a catch disposed on an upper portion of the posterior portion of the footplate. The method can include engaging the latch with a catch disposed on an upper portion of the posterior portion of the footplate. The actuator adapter can include a distal portion and a proximal portion, the one or more magnets disposed on the distal portion and the latch disposed on the proximal portion. The method can include coupling a concave portion of the distal portion with a ferrous pin disposed on a lower portion of the posterior portion of the footplate.

In various implementations, the method can include applying, by the actuator module, a force to rotate the arm and the actuator adapter. The method can include disposing the footplate adapter on the posterior portion of the footplate of the shoe. The method can include disposing a ferrous pin on a lower portion of the posterior portion of the footplate. The method can include disposing a catch on an upper portion of the posterior portion of the footplate.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 is a schematic diagram of a lower limb exoskeleton, according to some embodiments of the present disclosure.

FIG. 2 is a human lower leg and its components, according to some embodiments of the present disclosure.

FIG. 3 is a sagittal plane of the human lower leg, according to some embodiments of the present disclosure.

FIG. 4 is a transverse plane of the human lower leg, according to some embodiments of the present disclosure.

FIG. 5 is a talocrural plane of a human ankle, according to some embodiments of the present disclosure.

FIG. 6 is a skeletal view of the human lower leg, according to some embodiments of the present disclosure.

FIG. 7 is a front view of an example footwear, according to some embodiments of the present disclosure.

FIG. 8 is a side view of the footwear of FIG. 7, according to some embodiments of the present disclosure.

FIG. 9 is a rear view of the footwear of FIG. 7, according to some embodiments of the present disclosure.

FIG. 10 is a side view of a schematic of another example footwear, according to some embodiments of the present disclosure.

FIG. 11 is a side cross-sectional view a portion of the footwear of FIG. 10, according to some embodiments of the present disclosure.

FIG. 12 is a side view of a schematic of another example footwear, according to some embodiments of the present disclosure.

FIG. 13 is a side cross-sectional view a portion of the footwear of FIG. 12, according to some embodiments of the present disclosure.

FIG. 14 is an exploded view of a schematic of another example footwear, according to some embodiments of the present disclosure.

FIG. 15 is a side cross-sectional view of the footwear of FIG. 14, according to some embodiments of the present disclosure.

FIG. 16 is a perspective view of a portion of the footwear of FIG. 14, according to some embodiments of the present disclosure.

FIG. 17 is various views of the footwear of FIG. 14, according to some embodiments of the present disclosure.

FIG. 18 is various profiles of an example footwear, according to some embodiments of the present disclosure.

FIG. 19 is a perspective view of a schematic of an example footplate, according to some embodiments of the present disclosure.

FIG. 20 is a side cross-sectional view of a portion of an example apparatus including a footplate, according to some embodiments of the present disclosure.

FIG. 21 is various perspective views of the footplate of FIG. 20, according to some embodiments of the present disclosure.

FIG. 22 is a perspective view of the footplate of FIG. 20, according to some embodiments of the present disclosure.

FIG. 23 is another perspective view of the footplate of FIG. 20, according to some embodiments of the present disclosure.

FIG. 24 is another side cross-sectional view of the footplate of FIG. 20, according to some embodiments of the present disclosure.

FIG. 25 is a side view of an example apparatus including the footplate of FIG. 20, according to some embodiments of the present disclosure.

FIG. 26 is a perspective view of a translational disconnect mechanism of the apparatus of FIG. 25, according to some embodiments of the present disclosure.

FIG. 27 is another perspective view of the translational disconnect mechanism of the apparatus of FIG. 25, according to some embodiments of the present disclosure.

FIG. 28 is a cross-sectional view of the translational disconnect mechanism of the apparatus of FIG. 25, according to some embodiments of the present disclosure.

FIG. 28 is a perspective view of the portion of FIG. 28, according to some embodiments of the present disclosure.

FIG. 29 is a perspective view of the translational disconnect mechanism of the apparatus of FIG. 25, according to some embodiments of the present disclosure.

FIG. 30 is a side view of an example footwear including an example adapter, according to some embodiments of the present disclosure.

FIG. 31 is a perspective view of the footwear of FIG. 30, according to some embodiments of the present disclosure.

FIG. 32 is a side view of the footwear of FIG. 30 including an example apparatus, according to some embodiments of the present disclosure.

FIG. 33 is a rear view of the footwear and the apparatus of FIG. 32, according to some embodiments of the present disclosure.

FIG. 34 is a perspective view of an example disconnection of the footwear of FIG. 30 from the apparatus of FIG. 32, according to some embodiments of the present disclosure.

FIG. 35 is a side view of an example rotational disconnect mechanism of an example apparatus attached to an example footplate, according to some embodiments of the present disclosure.

FIG. 36 is a closeup view of the rotational disconnect mechanism of FIG. 35, according to some embodiments of the present disclosure.

FIG. 37 is another closeup view of the rotational disconnect mechanism of FIG. 35, according to some embodiments of the present disclosure.

FIG. 38 is a closeup perspective view of the rotational disconnect mechanism of FIG. 35, according to some embodiments of the present disclosure.

FIG. 39 is a rear cross-sectional view of the rotational disconnect mechanism of FIG. 35, according to some embodiments of the present disclosure.

FIG. 40 is a perspective view of the footplate of FIG. 35, according to some embodiments of the present disclosure.

FIG. 41 is a rear cross-sectional view of the apparatus of FIG. 35, according to some embodiments of the present disclosure.

FIG. 42 is a perspective view of the apparatus and the footplate of FIG. 35, according to some embodiments of the present disclosure.

FIG. 43 is a side view of an example footwear including a footplate adapter, according to some embodiments of the present disclosure.

FIG. 44 is a perspective view of the footwear of FIG. 43, according to some embodiments of the present disclosure.

FIG. 45 is a back view of the footwear of FIG. 43 and an example apparatus, according to some embodiments of the present disclosure.

FIG. 46 is another back view of the footwear of FIG. 43 and the apparatus of FIG. 45, according to some embodiments of the present disclosure.

FIG. 47 is a side closeup view of the footwear of FIG. 43 and the apparatus of FIG. 45, according to some embodiments of the present disclosure.

FIG. 48 is a closeup view of a rotational disconnect mechanism of the footwear of FIG. 43 and the apparatus of FIG. 45, according to some embodiments of the present disclosure.

FIG. 49 is perspective closeup views of the rotational disconnect mechanism of FIG. 48, according to some embodiments of the present disclosure.

FIG. 50 is perspective closeup views of the rotational disconnect mechanism of FIG. 48, according to some embodiments of the present disclosure.

FIG. 51 is perspective closeup views of the rotational disconnect mechanism of FIG. 48, according to some embodiments of the present disclosure.

FIG. 52 is a perspective view of another example apparatus and an example footplate apparatus including a magnetic disconnect mechanism, according to some embodiments of the present disclosure.

FIG. 53 is a close up view of the apparatus and the footplate apparatus of FIG. 52, according to some embodiments of the present disclosure.

FIG. 54 is a side view of a portion of the apparatus and the footplate apparatus of FIG. 52, according to some embodiments of the present disclosure.

FIG. 55 is a close up cross-sectional view of a portion of the apparatus and the footplate apparatus of FIG. 52, according to some embodiments of the present disclosure.

FIG. 56 is a close up view of a portion of the apparatus and the footplate apparatus of FIG. 52, according to some embodiments of the present disclosure.

FIG. 57 is a perspective view of a portion of the apparatus and the footplate apparatus of FIG. 52, according to some embodiments of the present disclosure.

FIG. 58 is a perspective view of a portion of the apparatus and the footplate apparatus of FIG. 52, according to some embodiments of the present disclosure.

FIG. 59 is a perspective view of a portion of the footplate apparatus of FIG. 52, according to some embodiments of the present disclosure.

FIG. 60 is an exploded perspective view of a portion of the footplate apparatus of FIG. 52, according to some embodiments of the present disclosure.

FIG. 61 is another exploded perspective view of the portion of FIG. 60, according to some embodiments of the present disclosure.

FIG. 62 is a back view of a portion of the apparatus and the footplate apparatus including the magnetic disconnect mechanism of FIG. 52, according to some embodiments of the present disclosure.

FIG. 63 is a perspective view of a portion of the apparatus and the footplate apparatus including the magnetic disconnect mechanism of FIG. 52, according to some embodiments of the present disclosure.

FIG. 64 is a perspective view of a portion of the apparatus and the footplate apparatus including the magnetic disconnect mechanism of FIG. 52, according to some embodiments of the present disclosure.

FIG. 65 is a perspective view of a portion of the apparatus and the footplate apparatus including the magnetic disconnect mechanism of FIG. 52, according to some embodiments of the present disclosure.

FIG. 66 is an exploded view of the magnetic disconnect mechanism of FIG. 52, according to some embodiments of the present disclosure.

FIG. 67 is a perspective view of the magnetic disconnect mechanism of FIG. 52, according to some embodiments of the present disclosure.

FIG. 68 is a side view of an example footwear including an example footplate adapter, according to some embodiments of the present disclosure.

FIG. 69 is a perspective view of the footwear and footplate adapter of FIG. 68, according to some embodiments of the present disclosure.

FIG. 70 is a rear view of the footwear and footplate adapter of FIG. 68 and an example apparatus including a magnetic disconnect mechanism, according to some embodiments of the present disclosure.

FIG. 71 is another rear view of the footwear and footplate adapter of FIG. 68 and the apparatus of FIG. 70, according to some embodiments of the present disclosure.

FIG. 72 is a side view of the footwear and footplate adapter of FIG. 68 and the apparatus of FIG. 70, according to some embodiments of the present disclosure.

FIG. 73 is a closeup view of the magnetic disconnect mechanism of FIG. 70, according to some embodiments of the present disclosure.

FIG. 74 is another closeup view of the magnetic disconnect mechanism of FIG. 70, according to some embodiments of the present disclosure.

FIG. 75 is a flow diagram of an example method for forming an example apparatus, according to some embodiments of the present disclosure.

FIG. 76 is a flow diagram of another example method for forming an example apparatus, according to some embodiments of the present disclosure.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

This disclosure is generally directed to attachment between an actuator module and a footwear component of a lower leg exoskeleton. A footplate can be integrated into a sole of the footwear component with an attachment system that connects to an actuator assembly.

Exoskeletons (e.g., lower limb exoskeleton, knee exoskeleton, back exoskeleton, etc.) can include devices worn by a person to augment physical abilities. Exoskeletons can be considered passive (e.g., not requiring an energy source such as a battery) or active (e.g., requiring an energy source to power electronics and usually one or many actuators). Exoskeletons may be capable of providing large amounts of force, torque and/or power to the human body in order to assist with motion. The systems and methods can provide a footwear integrated with a footplate enabling simplified connection and disconnection of a lower leg exoskeleton to the footwear. The exoskeleton can integrate with the footwear to provide force to augment motion. For example, the footwear can include a footplate with a footplate adapter facilitating connection between the footwear and an actuator module of the exoskeleton. Upon connection, the actuator module can provide the force, torque, and/or power to the footplate to assist motion of the human body.

The ability of the exoskeleton to provide augmentation to the human can be dependent on the device's ability to transmit significant force to the body in a comfortable manner. To improve the ability or performance with which the device can transfer or transmit force to the body, the systems and methods of the present disclosure can provide an improved or more precise and exacting mechanical fit to the human body. For example, the systems and methods can provide various component configurations to improve the fit and function on different body sizes that can be characterized and mechanically adjusted to accommodate variations in human body morphology. These components and/or built-in mechanical adjustments allow the rigid mechanical structure and soft goods components to conform to different body metrics while maintaining critical mechanical alignments and relationships for efficient force transmission and augmentation.

Exoskeletons may be integrated with a footwear such that the footwear is not removable from an actuator module of the exoskeleton. The integration with the footwear may reduce a number of use cases of the exoskeleton, and may increase a difficulty of putting on and taking off the footwear, thereby increasing inconvenience.

To address the above-mentioned technical problem, the systems and methods can simplify connection of the actuator module to the footwear such that the footwear is removably coupled to the actuator module and the user can selectively put on and take off the actuator module while wearing the footwear. The systems and methods can thus enable greater flexibility and use of the footwear. The systems and methods of the present disclosure, as described herein, provide a footwear with a footplate including an attachment assembly, allowing the footwear to be attached to an actuation assembly. The attachment assembly provides for simple and efficient attachment methods of the actuation assembly to the footwear, allowing a user to connect and disconnect the actuation assembly, and customize situations for augmented movement (e.g., by connecting the actuation assembly). The systems and methods of the present disclosure can include a number of attachment methods, such as but not limited to, a translational, rotational, and magnetic attachment mechanisms.

### I. Exoskeleton Overview

Exoskeletons can transfer energy to the human and may not interfere with the natural range of motion of the body. Exoskeletons can convert the energy source into useful mechanical force, torque or power. Onboard electronics (e.g., controllers) can control the exoskeleton. Output force and torque sensors can also be used to make controlling easier.

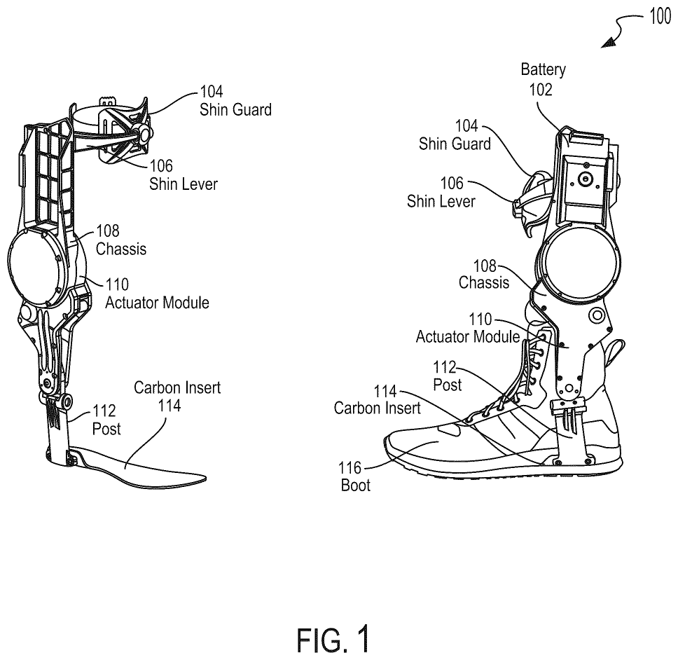

FIG. 1 illustrates a schematic diagram of a lower limb exoskeleton 100 (e.g., lower limb exoskeleton assembly, lower limb exoskeleton system, exoskeleton boot, mechanical exoskeleton, exoskeleton device, etc.). The exoskeleton 100 can include a battery 102 that can include an assembly that is installed onto the actuator module and supplies electrical energy to the system. The exoskeleton 100 can include a shin guard 104 that can include a part of the assembly that interfaces with the user's shin. The exoskeleton 100 can include a shin lever 106 that can include a mechanical structure that connects the shin guard to a chassis. The chassis 108 can include a mechanical structure that connects the static components. The exoskeleton 100 can include an actuator module 110 that can include all the component in the lower limb exoskeleton assembly excluding the boot. The exoskeleton 100 can include a post 112 that can include a mechanical structure that connects to the boot. The exoskeleton 100 can include a carbon insert 114 that can include a carbon fiber structure located inside of the sole (e.g., sole 248) of the boot. The exoskeleton 100 can include a boot 116 that connects to the user and the actuator module. The exoskeleton 100 can include a spool shaft that can include a shaft that is driven by the motor and winds the belt around itself. The belt can include a tensile member that is pulled by the spool shaft and applies a force to the ankle lever. The exoskeleton 100 can include an ankle lever that can include a lever used to transmit torque to the ankle. Lower limb exoskeletons can be used to augment the ankle joint.

The lower limb exoskeleton 100 can include a rugged system used for field testing. The lower limb exoskeleton 100 can include an integrated ankle lever guard (e.g., nested lever). The lower limb exoskeleton 100 can include a mechanical shield to guard the belt and ankle lever transmission from the environment. The housing structure of the system can extend to outline the range of travel of the ankle lever on the lateral and medial side. The lower limb exoskeleton 100 can include a shin lever self-centering mechanism. A self-centering mechanism can be incorporated into the shin lever. Degrees of freedom can be incorporated into the lower limb exoskeleton to reduce skin sheer and increase the comfort to the user. The lower limb exoskeleton 100 can include a self-centering mechanism to push the shin lever to the shin lever's center of travel if the shin lever is not already there. This mechanism can be composed of one or more springs. The self-centering mechanism on the lower limb exoskeleton can use repelling magnets to push the shin lever to its center of travel. The magnets can be attracted each other and pull the shin lever to its center of travel.

According to the systems and methods of the present disclosure, an exoskeleton can augment a user's activities. Rigid and compliant structures can be integrated directly into footwear. This can allow for benefits for the purposes of human augmentation. For example, these structures can include a way to apply force to the ankle and lower limbs without injury or discomfort. Design constraints can include mechanical interference between the device, joint or limbs and avoidance of sensitive, and or highly flexible areas on the lower leg and foot. An engineered composite structure under the foot with a rigid mounting point for the mechanical exoskeleton can be used. This can be expanded to further integrate the compliant and rigid structures found in footwear designs to stabilize and support the foot with the structures to support and attach to the ankle exoskeleton. These structures can be optimized for attributes such as high strength, lower mass, robustness and elasticity.

In some embodiments, the exoskeleton can include a composite plate integrated into the sole of an article of footwear. The composite plate can provide a rigid mounting point for an ankle exoskeleton and reaction plate to translate forces to the ground for the purposes of augmenting human movement. A composite underfoot structure can be located under the foot. The underfoot structure can be layered between layers of cushioning material (e.g., ethylene-vinyl acetate (EVA) foam, polyurethane (PU) foam, etc.). The underfoot structure can be a full length underfoot structure (e.g., from the toe area to the heel area) or a partial underfoot structure (e.g., from the metatarsal flex area to the heel area).

In some embodiments, the exoskeleton can be a precise mechanical fit to the human body. Various component configurations to improve the precise mechanical fit and function on different body sizes can be characterized and mechanically adjusted to accommodate variations in human body morphology. Components and/or built-in mechanical adjustments can allow a rigid mechanical structure and soft goods components to conform to different body metrics while maintaining critical mechanical alignments and relationships for efficient force transmission and augmentation.

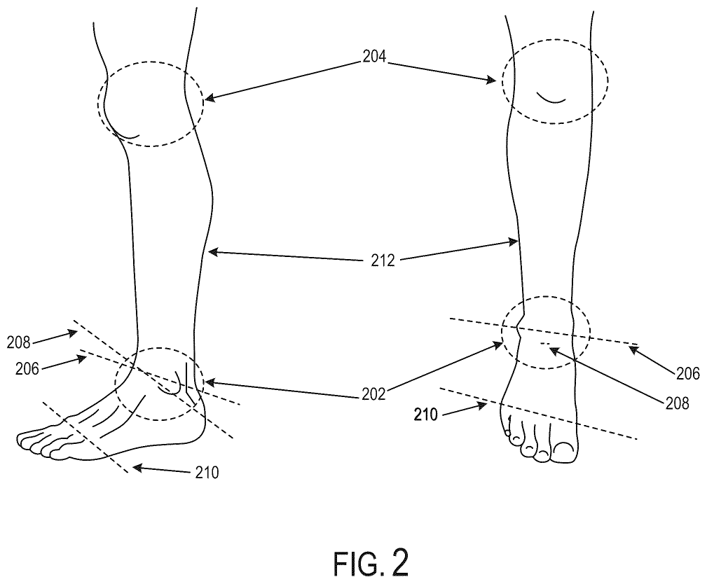

FIG. 2 illustrates a human lower leg and its components. The human lower leg can include a human ankle joint 202 which can be a physiological joint that enables ankle dorsiflexion/plantar flexion and inversion/eversion. The human lower leg can include a human knee joint 204 which can be a physiological joint that enables flexion and extension of a knee. The human lower leg can include a human talocrural joint which can be a physiological joint that enables plantar flexion and dorsiflexion and rotates around a talocrural axis 206. The human lower leg can include a human subtalar joint which can be a physiological joint that enables eversion and inversion, such as around a subtalar axis 208. The human lower leg can include a metatarsophalangeal joint which can be a physiological joint that enables flexion of toes and rotates around a metatarsophalangeal axis 210. The human lower leg can include a shank 212 which can be a portion of a body between the human ankle joint 202 and the human knee joint 204.

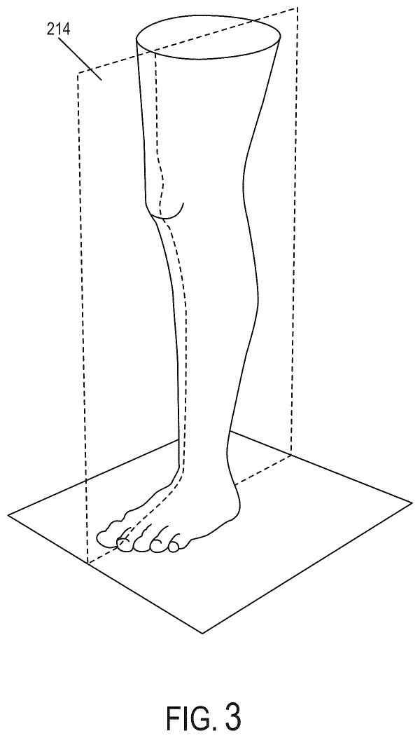

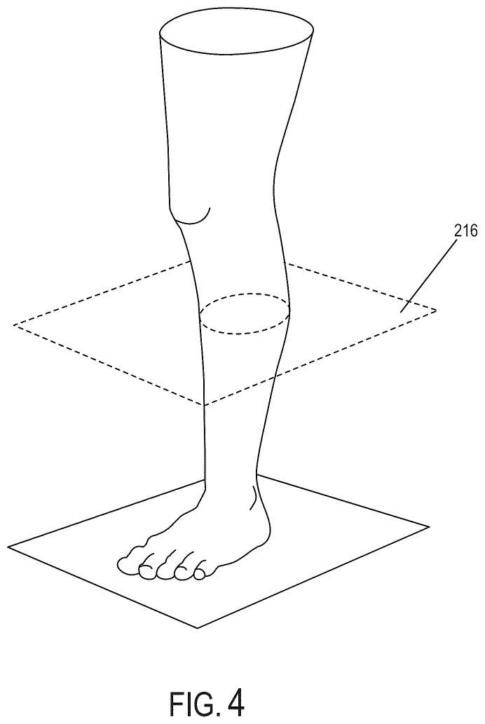

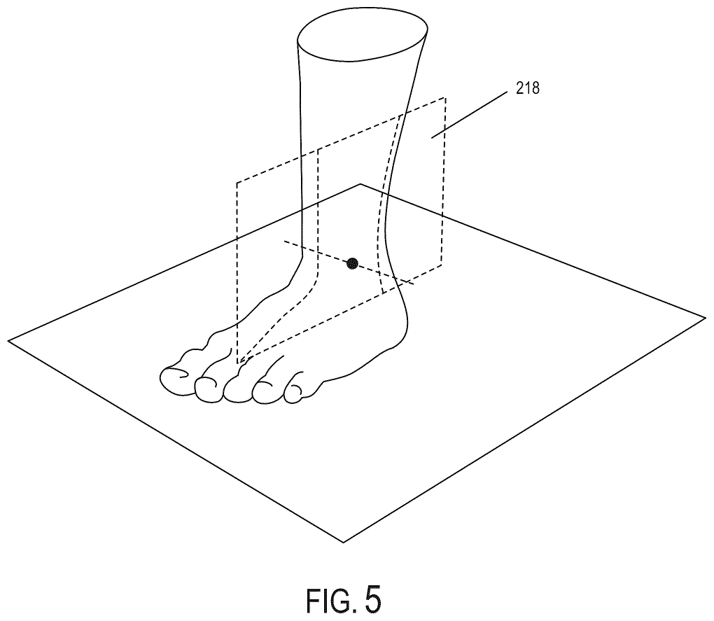

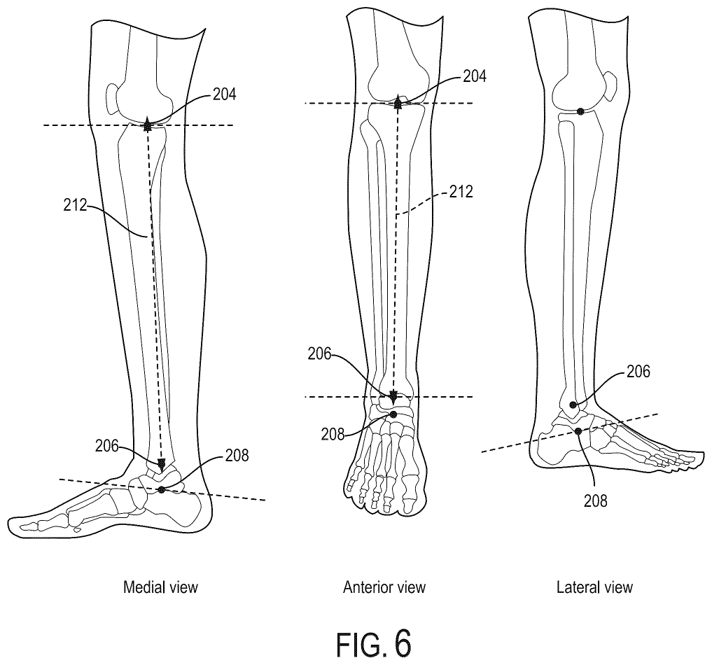

FIG. 3 illustrates a sagittal plane 214 of the human lower leg. The sagittal plane 214 of the human lower leg can be a plane that intersects the center of the human ankle joint 202 and the center of the human knee joint 204. FIG. 4 illustrates a transverse plane 216 of the human lower leg. The transverse plane 216 of the human lower leg can be a plane that is perpendicular to a frontal plane of the human lower leg and the sagittal plane 214 of the human lower leg. FIG. 5 illustrates a talocrural plane 218 of a human ankle. The talocrural plane 218 of the human ankle can be a plane that is perpendicular to the talocrural axis 206. Various skeletal views of the human lower leg can be seen in FIG. 6. The skeletal views of the human lower leg can include various components of the human lower leg, as described in conjunction with but not limited to FIG. 2.

### II. Example Footwear and Footplate

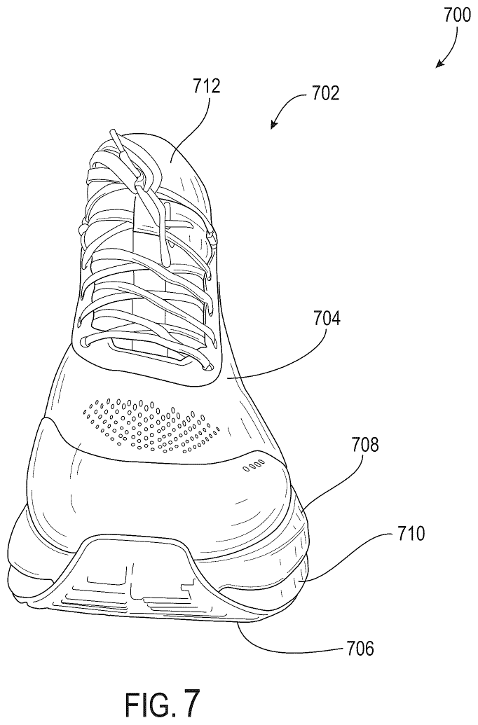

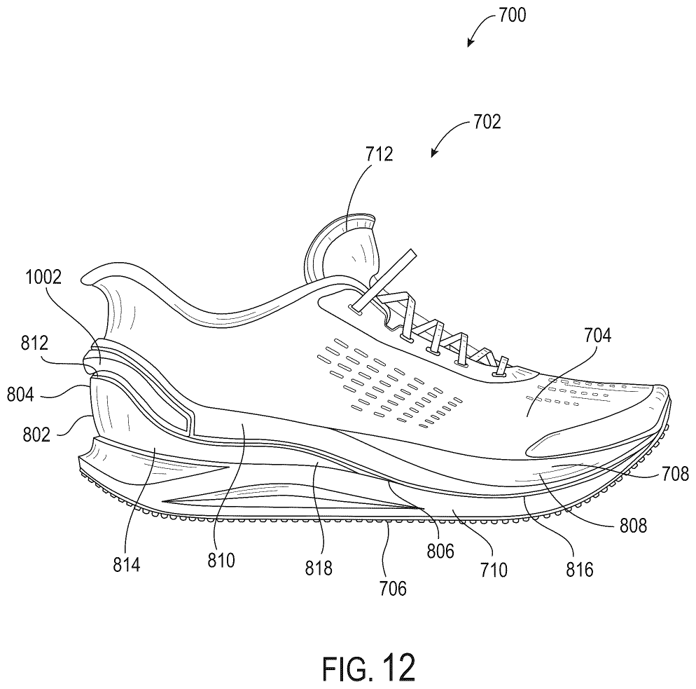

FIGS. 7-13 depict an example apparatus 700 (e.g., system, device, etc.). The apparatus 700 can be an example of the lower leg exoskeleton 100. The apparatus 700 can be worn by a user. The apparatus 700 can include at least one shoe 702 (e.g., footwear, etc.). The shoe 702 can be an example of the boot 116. The shoe 702 can be worn by the user and can include at least one upper 704 (e.g., vamp, topline, etc.). The upper 704 can enclose and protect a foot of the user from external elements, such as water or debris. The upper 704 can provide structure and support to the shoe 702, and be formed of a material to allow for air flow within the shoe 702. For example, the upper 704 can include one or more openings or mesh to allow air to flow within the shoe 702. The upper 704 can be formed from a material such as, but not limited to, mesh, canvas, fabric, or any other material.

The shoe 702 can include at least one outsole 706 (e.g., sole, tread, bottom, etc.). The outsole 706 can be coupled to the upper 704 by at least one of an adhesive, stitching, or any other method to couple the outsole 706 to the upper 704. The outsole 706 can provide traction to the shoe 702 and can include one or more treads or patterns to provide the traction. The outsole 706 can be formed from a material such as polymers, rubber, or any other durable material. The outsole 706 protects the foot from and provides overall stability and support to the shoe 702. A length and width of the outsole 706 can be same as a length and width of the upper 704. In some implementations, the length and the width of the outsole 706 is greater than or less than the length and the width of the upper 704.

The shoe 702 can include at least one midsole (e.g., cushioning layer, foam, core sole, etc.). The shoe 702 can include an upper midsole 708 (e.g., top midsole, etc.) and a lower midsole 710 (e.g., bottom midsole, etc.). The upper midsole 708 can be above the lower midsole 710, and the upper midsole 708 may not be in contact with the lower midsole 710. The upper midsole 708 can be in contact with the upper 704 and the low midsole 710 can be in contact with the outsole 706. At least one of the upper midsole 708 or the lower midsole 710 can provide cushioning to the foot to the user and absorb impact forces from walking, running, jumping, etc. by distributing the impact across the at least one of the upper midsole 708 or the lower midsole 710. At least one of the upper midsole 708 or the lower midsole 710 can enhance comfort of the shoe 702 and be formed from a material such as, but not limited to, a polymer, a foam, or a gel foam.

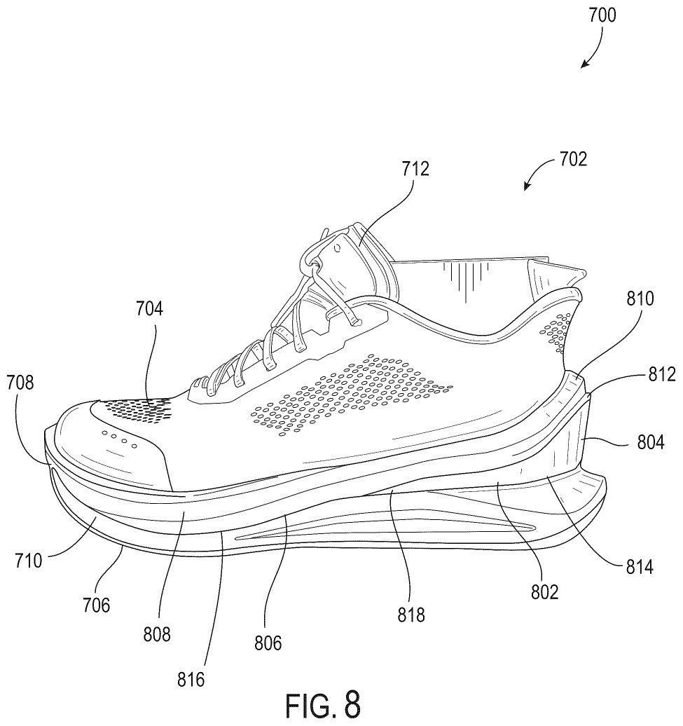

Referring now to FIG. 8, the apparatus 700 can include at least one footplate 802 (e.g., base plate, footbed, etc.). The footplate 802 can be an example of the carbon insert 114. The footplate 802 can be located between the upper 704 and the outsole 706. The footplate 802 can include a posterior portion 804 (e.g., back portion, etc.) and a bottom portion 806 (e.g., front portion, etc.). The bottom portion 806 can extend from the posterior portion 804 and be disposed between the upper 704 and the outsole 706. The upper midsole 708 can be disposed between the upper 704 and the footplate 802. The lower midsole 710 can be disposed between the outsole 706 and the footplate 802. The footplate 802 can have a length equal to a length of the upper 704. In some implementations, the length of the footplate 802 is greater than or less than the length of the upper 704.

The shoe 702 can accommodate the footplate 802 between the upper midsole 708 and the lower midsole 710, and the footplate 802 can comfortably augment loads to the user, maintain comfort in response to augmentation being not applied, allow the user to easily take on and off the shoe 702, allow the user to easily don and doff an actuator assembly (e.g., actuator module 2016, etc.) while either wearing the shoe 702 or not wearing the shoe 702, and not inhibit the user when moving through walking or running environments (e.g., the shoe 702 should not catch, hook, or interfere with the environment). The footplate 802 can be lightweight and be robust to jamming and typical environments that a shoe may be worn in (e.g., dirt, mud, sand, snow, ice, rocks/pebbles, etc.). For example, the footplate 802 includes protection against contaminants, such as dirt.

The footplate 802 can be integrated into the shoe 702 by being co-molded (e.g., formed, integrated, etc.) with at least one of the upper midsole 708 or the lower midsole 710. For example, at least one of the upper midsole 708 or the lower midsole 710 can be overmolded around the footplate 802. The upper midsole 708 and the lower midsole 710 can sandwich the footplate 802. In various implementations, an adhesive can be used to adhere (e.g., couple, bond, etc.) the footplate 802 to the upper midsole 708 and the lower midsole 710. The adhesive can include, for example, epoxy, polymers, or any other adhesive. In various implementations, the footplate 802 can be coupled to at least one of the upper midsole 708 or the lower midsole 710 by fasteners, welding (e.g.,. thermoplastic welding, heat bonding, etc.), or hook-and-loop systems. In various implementations, at least one of the upper midsole 708 or the lower midsole 710 defines a receiving space, and the footplate 802 is located in the receiving space. In various implementations, the footplate 802 may not be coupled to the upper midsole 708 or the lower midsole 710.

To achieve comfort and maintain efficiency, dimensions (e.g., thickness, etc.) of at least one of the upper midsole 708 or the lower midsole 710 can be configured to transmit forces between the footplate 802, the foot, and the ground. For example, a thickness of the lower midsole 710 between the footplate 802 and outsole 706 at a heel of the foot can be minimized to limit lower midsole 710 compression but can be thick enough to maintain comfort. In various implementations, the thickness of the lower midsole 710 is between 10 to 35 mm, inclusive at the heel of the foot. In various embodiments, the thickness of the lower midsole 710 is less than 10 mm or greater than 35 mm. The lower midsole 710 thickness between the footplate 802 and the outsole 706 at a forefront toe area can be minimized to limit lower midsole 710 compression but thick enough to disperse a ground reaction force across the footplate. In various implementations, the thickness of the lower midsole 710 between the footplate 802 and the outsole 706 at the forefront toe area is between 5 to 20 mm, inclusive. In various embodiments, the thickness of the midsole at the forefront toe area is less than 5 mm or greater than 20 mm.

The footplate 802 can be formed of a material, such as a metal, ceramic, polymer, or composite material. The footplate 802 may be formed from a composite material. Composites with high-strength fibers can allow for the footplate 802 to be high-strength, lightweight, and flexible. The footplate 802 can be formed of at least one of thermoset composites or thermoplastic composites. To support thermoplastic molding, the footplate 802 can include a large radii to promote demolding and layer adhesion during the molding process. For example, the footplate 802 can be thermoformed, compression molded, injection molded, etc. and including the large radii can facilitate demolding the footplate 802 from, for example, the mold used for injection molding. In various implementations, the radii can be between 3 to 10 mm. In various implementations, the radii is less than 3 mm or greater than 10 mm. In various implementations, the footplate 802 can be additively manufactured, machined, or by composite layup, among others.

The footplate 802 can include fibers configured to increase at least one of stiffness, strength, or flexibility of the footplate 802. The footplate 802 can include a number of layers, such as a number of composite layers. The layers of the footplate 802 can include the fibers, and the fibers can be oriented in different directions. For example, the footplate 802 can include multiple layers with different fiber orientations. To determine the fiber orientations, the footplate 802 can be manufactured by, for example, manual lay-up, such that orientations of the fibers of each composite layer can be adjusted as the footplate 802 is manufactured. For example, the composite layers of the footplate 802 can be stacked in a laminate schedule or stacking sequence to determine and customize the fiber orientation of each layer of the footplate 802.

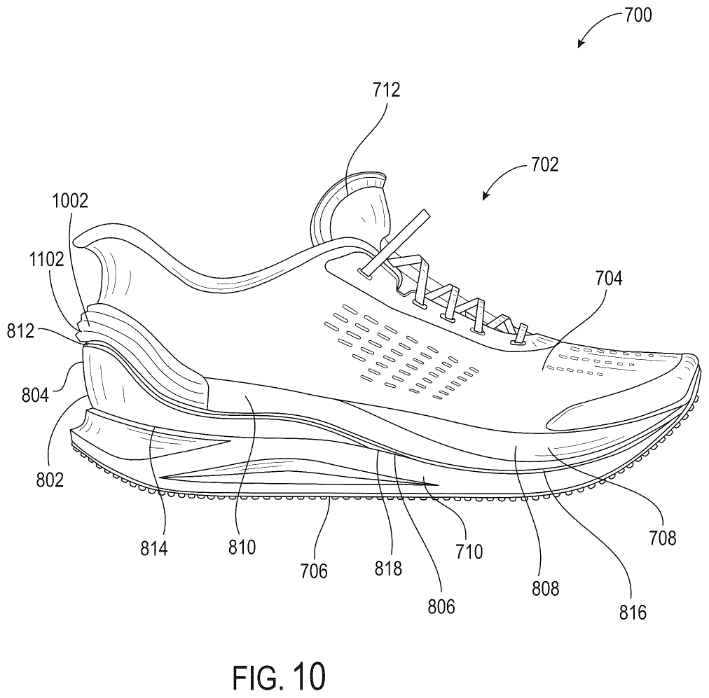

As shown in at least FIGS. 10-13, among others, the apparatus 700 can include at least one spacer 1002 (e.g., cushion, etc.) The spacer 1002 can be disposed between the posterior portion 804 and the upper 704. The spacer 1002 can be in contact with the footplate 802 and the upper midsole 708. The spacer 1002 can be in contact with the upper 704. In some implementations, the spacer 1002 is contiguous or integrated with the upper midsole 708. The spacer 1002 can compress upon application of force by the footplate 802, and absorb impact and enhance comfort of the shoe 702. To compress, the spacer 1002 can be formed from a material including at least one of a foam, elastomer, gel, or a combination thereof. The spacer 1002 can minimize discomfort during augmentation by absorbing impact such that the impact is not transferred to a foot of the user.

The spacer 1002 can be formed from a first material having a first durometer. The upper midsole 708 can be formed from a second material having a second durometer. The lower midsole 710 can be formed from a third material having a third durometer. The first durometer can be less than at least one of the second durometer or the third durometer. In some implementations, the first durometer is greater than or equal to at least one of the second durometer or the third durometer. The durometers of the spacer 1002, the upper midsole 708, and the lower midsole 710 can be varied to either disperse the force caused by deflection of the footplate 802 during augmentation or accommodate movement of the footplate 802 without exerting a significant force. In some implementations, the spacer 1002 can have a same material as at least one of the upper midsole 708 or the lower midsole 710 and in other implementations, the spacer 1002 can be formed from a different material.

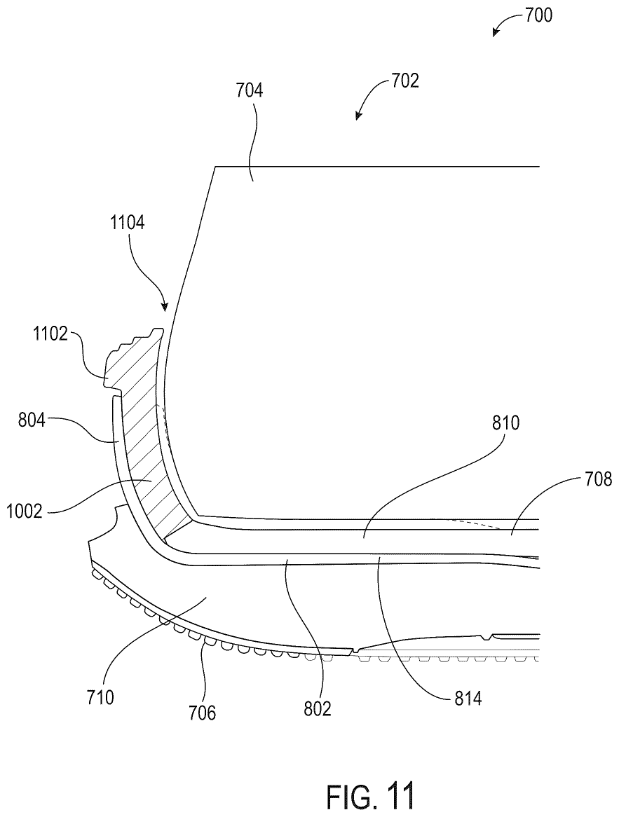

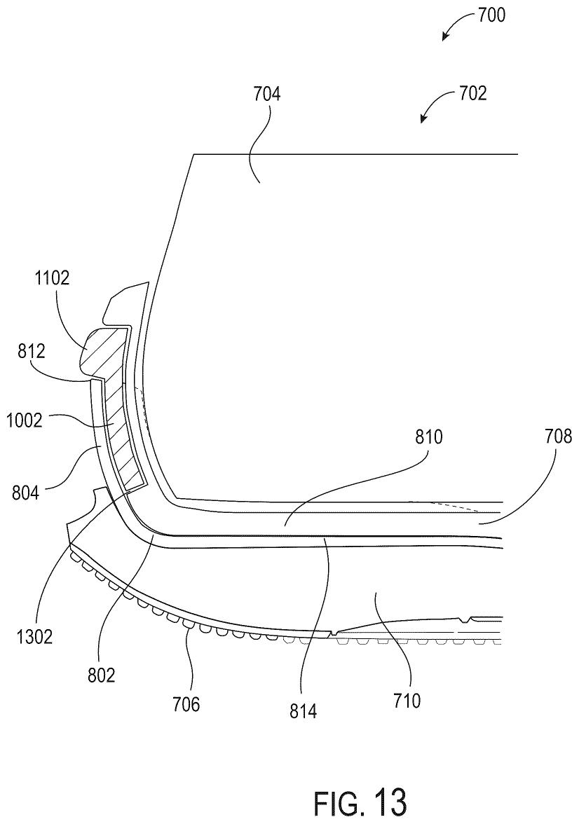

As shown in FIGS. 11 and 13, among others, the spacer 1002 can include at least one protrusion 1102. The posterior portion 804 of the footplate 802 can include at least one upper edge 812 as shown in FIG. 8, among others. The protrusion 1102 can be disposed over the upper edge 812. For example, the protrusion 1102 can extend over and be in contact with the upper edge 812. The protrusion 1102 can be in contact with the upper edge 812.

A geometry of the upper midsole 708 behind the heel (e.g., aligned with the upper edge 812, etc.) can be molded with a receiving space (e.g., voids, cavity, etc.) to reduce stiffness of the upper midsole 708 without changing a durometer of the upper midsole 708. For example, in some implementations, as shown in at least FIG. 11, among others, the upper midsole 708 can define a gap 1104. The posterior portion 804 and the upper 704 can be separated by the gap 1104 such that in response to the footplate 802 deflecting, the footplate 802 does not exert a force on an area of the upper midsole 708 around the gap 1104. The spacer 1002 can be disposed in the gap 1104. The spacer 1002 can mitigate contaminants from entering the shoe 702 via the gap 1104.

The upper midsole 708 can include a front portion 808 and a back portion 810. The back portion 810 can align with the posterior portion 804 and the front portion 808 can align with the bottom portion 806. For example, the back portion 810 can be in contact with the posterior portion 804 and the front portion 808 can be in contact with the bottom portion 806. In some implementations, as shown in at least FIG. 13, among others, the back portion 810 can define a recess 1302 (e.g., cavity, receiving space, etc.). In such implementations, the spacer 1002 can be disposed at least partially in the recess 1302. The spacer 1002 can be coupled to the upper midsole 708 in the recess 1302. In some implementations, the recess 1302 extends from the back portion 810 to the front portion 808. In such implementations, the footplate 802 can be disposed in the recess 1302.

In various implementations, the spacer 1002 can have a length less than or equal to at least one of the recess 1302 or the gap 1104. In other implementations, the spacer 1002 has a length greater than the recess 1302 or the gap 1104. In some implementations, the spacer 1002 has a length less than or equal to the upper midsole 708, and can be located between the upper midsole 708 and the footplate 802. In some implementations, the spacer 1002 has a length greater than the upper midsole 708.

Referring back to FIG. 8, the footplate 802 can include one or more portions. The footplate 802 can include a heel portion 814, a forefoot portion 816 (e.g., ball portion, etc.), and a midfoot portion 818 (e.g., arch portion, etc.) extending between the heel portion 814 and the forefoot portion 816. The posterior portion 804 can include the heel portion 814 and, in some implementations, a portion of the midfoot portion 818. The bottom portion 806 can include the forefoot portion 816 and, in some implementations, a portion of the midfoot portion 818. The heel portion 814 can correspond to a heel position of the foot of the user while in the shoe 702. The forefoot portion 816 can correspond to a forefoot position of the foot, and the midfoot portion 818 can correspond to a midfoot position of the foot.

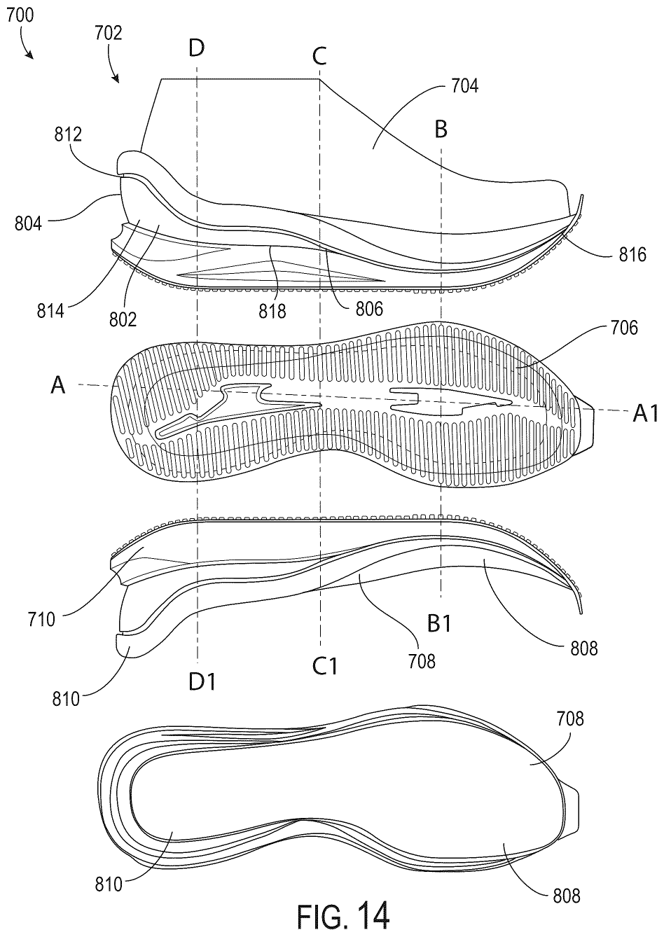

As shown in at least FIGS. 14-16, among others, the heel portion 814 and the midfoot portion 818 can be partially encapsulated by the upper midsole 708 and the lower midsole 710. The midfoot portion 818 can be partially exposed (e.g., to the environment, not in contact with the upper midsole 708 or the lower midsole 710, etc.), and can transition to being fully encapsulated by the upper midsole 708 and the lower midsole 710. The forefoot portion 816 can be fully encapsulated such that the forefoot portion 816 does not include a portion exposed to the environment.

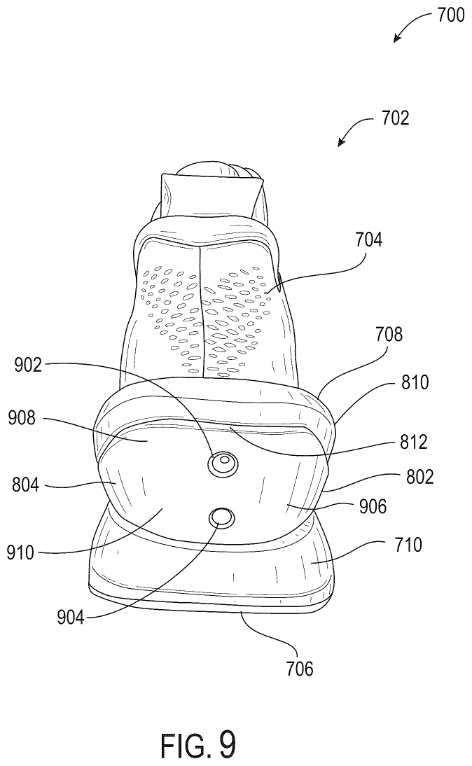

The heel portion 814 can be entirely exposed and in some implementations, can be partially exposed. The heel portion 814 can be exposed to reduce an overall thickness and weight to the footplate 802 and to expose a mounting point. Referring back to FIG. 9, the posterior portion 804 and the heel portion 814 can define at least one aperture. The posterior portion 804 can define a first aperture 902 and a second aperture 904. The first aperture 902 and the second aperture 904 can be the mounting point. The posterior portion 804 can include an outer surface 906, and the first aperture 902 and the second aperture 904 can extend from the outer surface 906 of the posterior portion 804 to an inner surface of the posterior portion 804. The posterior portion 804 can include an upper portion 908 and a lower portion 910. The upper portion 908 can include the upper edge 812. The first aperture 902 can be defined by the upper portion 908 and the second aperture 904 can be defined by the lower portion 910. In various implementations, the first aperture 902 and the second aperture 904 can include threads. An actuator module can be attached to the footplate 802 via the first aperture 902 and the second aperture 904, as described further herein.

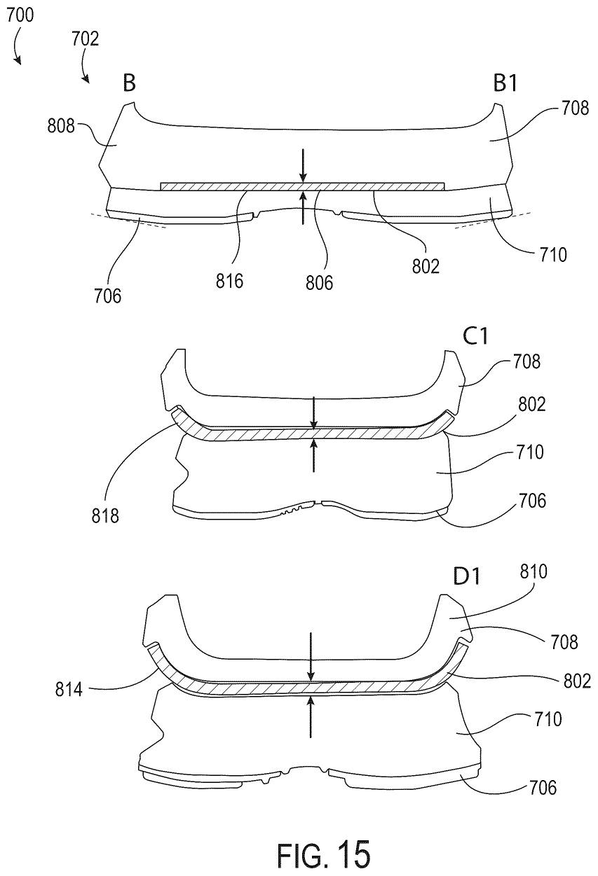

As shown in FIG. 15, among others, from the heel portion 814 to the forefoot portion 816, the footplate 802 can change in thickness. For example, a portion of the forefoot portion 816 can have a thickness of 2 millimeters (mm), a portion of the midfoot portion 818 can have a thickness of 2.5 mm, and a portion of the heel portion 814 can have a thickness of 3.5 mm. At least a portion of the forefoot portion 816 can have a thickness less than at least a portion of the midfoot portion 818, and the at least a portion of the midfoot portion 818 can have a thickness less than at least a portion of the heel portion 814. In various implementations, portions of the forefoot portion 816 has a thickness greater than or less than 2 mm, portions of the midfoot portion 818 has a thickness greater than or less than 2.5 mm, and portions of the heel portion 814 has a thickness greater than or less than 3.5 mm.

In various implementations, at least a portion of the forefoot portion 816 has a thickness greater than at least a portion of the midfoot portion 818 or the heel portion 814. In various implementations, at least a portion of the midfoot portion 818 has a thickness greater than at least a portion of the forefoot portion 816 or the heel portion 814.

From the heel portion 814 to the forefoot portion 816, the footplate 802 can change in a number of layers, orientations of the layers, and convex and concave geometries. For example, the footplate 802 can have a number of composite layers including fibers, and the fibers on different layers of the footplate 802 can be oriented in different directions. The footplate 802 can include concave and convex portions to control twisting, bending, cyclic, and other such forces the user may subject the footplate 802 to during augmented movement. For example, the footplate 802 can counteract force imparted by the user to augment movement of the user. The various orientations, thickness, and geometries of the footplate 802 can facilitate augmentation in various situations.

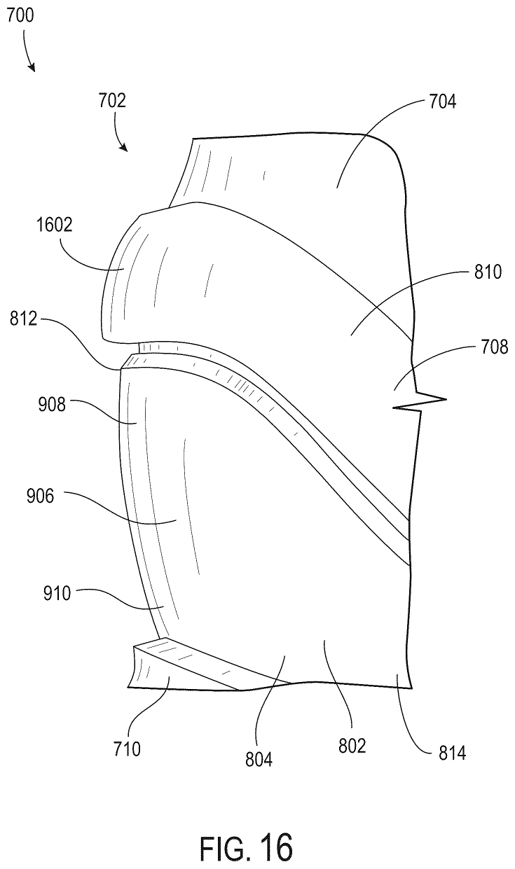

As shown in FIG. 16, among others, the shoe 702 can include a lip 1602. The lip 1602 can be coupled to or integrated with the upper 704. The lip 1602 can be in contact with the upper midsole 708 and can extend over and past the upper edge 812. Consequently, the lip 1602 can protect at least the footplate 802 from inadvertent contact, scuffs, etc. The lip 1602 can mitigate the footplate 802 from being caught or snagged, and can mitigate tripping or damage to the footplate 802. The lip 1602 can be in contact with the spacer 1002. The lip 1602 can be formed of a material, such as at least one of a foam, gel, elastomer, or any combination thereof. The lip 1602 can extend around at least a portion of the upper 704.

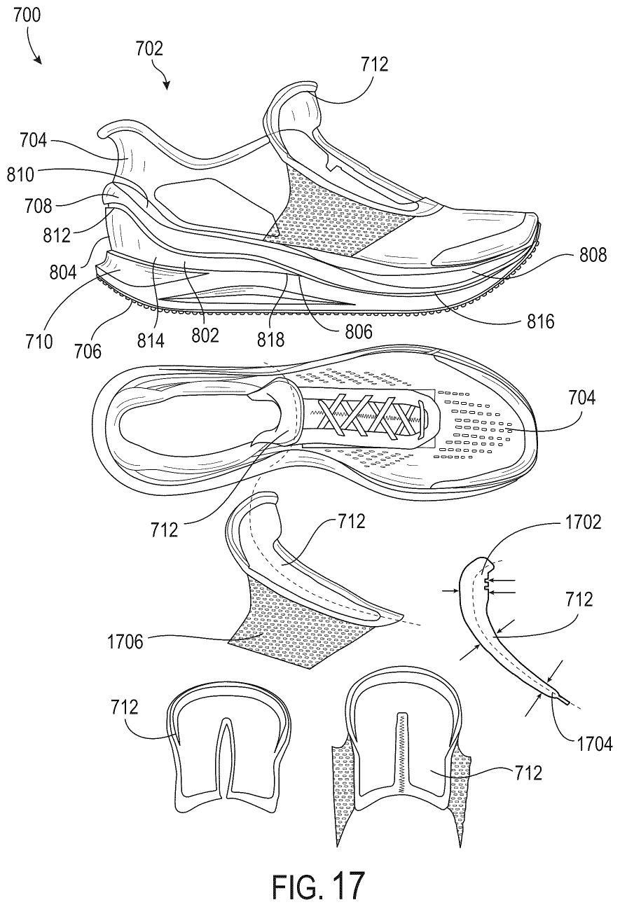

Referring back to FIG. 7, the shoe 702 can include a tongue 712 (e.g., flap, pad, etc.). The tongue 712 can be coupled to the upper 704, and can be formed of a material, such as at least one of a foam, gel, elastomer, or any combination thereof. As shown in FIG. 17, among others, the tongue 712 can include a top portion 1702 and a bottom portion 1704 opposite the top portion 1702. The top portion 1702 can have a thickness of, for example, 20 mm and the bottom portion 1704 can have a thickness of 5 mm. The greater thickness of the tongue at the top portion 1702 can allow the tongue 712 to manage additional loads of force during augmentation of the movement of the user. The top portion 1702 can absorb shock and force to stabilize the foot of the user. The tongue 712 can include a thickness of 20 mm at the top portion 1702, a thickness of 10 mm between the top portion 1702 and the bottom portion 1704, and a thickness of 5 mm at the bottom portion 1704.

The tongue 712 can have a curved shape. To couple the tongue 712 to the upper 704, the shoe 702 can include at least one band 1706. The band 1706 can be formed from a material, such as mesh, polymer, an elastomer, or any combination thereof. The tongue 712 can counteract any forces that may be exerted due to a mass of an actuator module (e.g., actuator module 2016).

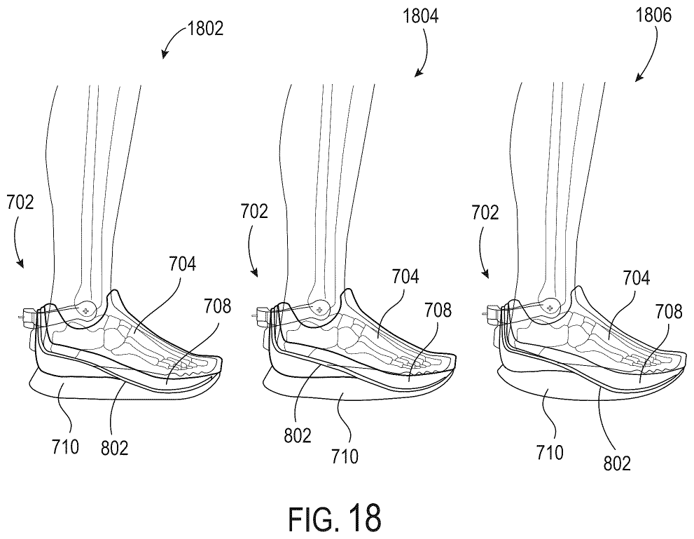

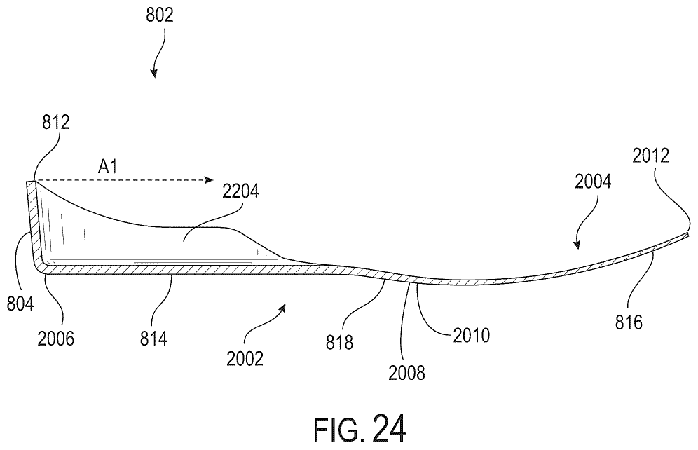

Referring now to FIGS. 18-24, the footplate 802 can be configured to have a stiffness correlating to a specific profile. FIG. 18 depicts three profiles for a shape of the outsole 706. A first profile 1802 can correspond to a running profile, and may also correspond to the footplate 802 having a stiffness that may resist flexing at a metatarsophalangeal (MTP) joint of the foot, causing heel life and skin shear during unpowered (e.g., unaugmented, etc.) plantarflexion. A second profile 1804 can correspond to a rocker profile, which may correspond with the footplate 802 having a stiffness causing instability and fatigue while standing. For example, the second profile 1804 may roll through a gait transition (e.g., changing from walking to running) instead of having the user overcome a stiffness of the shoe 702 and the footplate 802 to change gaits, therefore causing instability and potential fatigue while standing.

Consequently, the footplate 802 can be configured to have a stiffness correlating to a third profile 1806. The third profile 1806 can correspond to a mild rocker profile, and the footplate 802 of the third profile 1806 can have a stiffness between the stiffness of the footplate 802 in the first profile 1802 and the second profile 1804. The footplate 802 can allow for flexing of the MTP joint and provide stiffness to the shoe 702 mitigate rolling transitions between gaits.

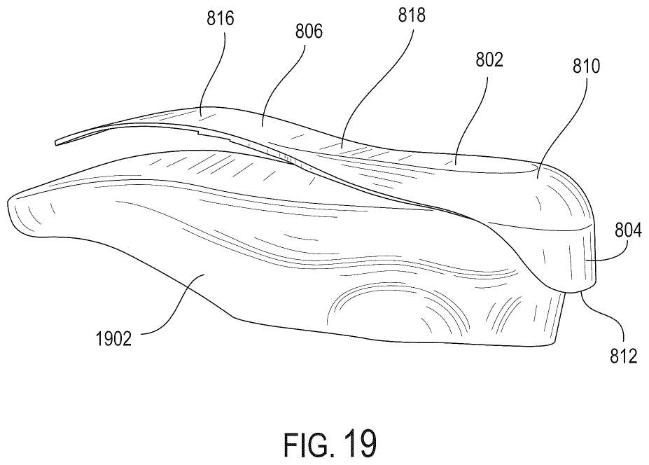

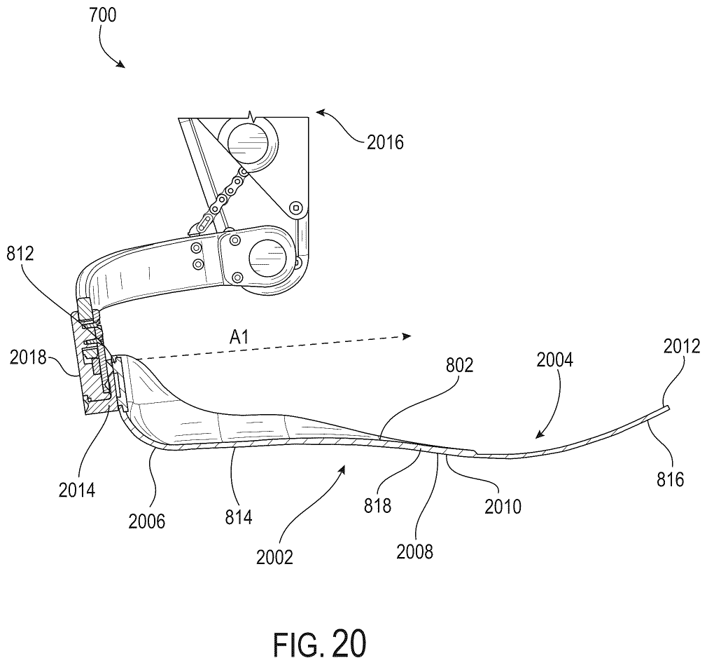

As shown in FIG. 19, among others, the footplate 802 can have a shape to match form of the foot. For example, the footplate 802 can be shaped to match a last 1902 (e.g., form, mold, etc.), which can be a three-dimensional form of the foot of the user. Consequently, a curvature of the footplate 802 can mimic the curvature of the last 1902, as shown in FIGS. 20-25. In some implementations, the footplate 802 can be molded according to the last 1902. For example, the last 1902 can be a mold, and the footplate 802 can be formed according to the last 1902.

As shown in FIGS. 20-21 and 24, among others, and as described above, the footplate 802 can have varying thicknesses between the heel portion 814 and the forefoot portion 816, such as a thickness of the heel portion 814 being greater than a thickness of the forefoot portion 816. The footplate 802 can include at least one convex portion 2002 (e.g., downwards curved section, etc.) and at least one concave portion 2004 (e.g., upwards curved section, etc.). The heel portion 814 and the midfoot portion 818 can include at least a portion of the convex portion 2002, and the midfoot portion 818 and the forefoot portion 816 can include at least a portion of the concave portion 2004. The convex portion 2002 and the concave portion 2004 can have a curvature matching a curvature of the last 1902.

The convex portion 2002 can provide a drop between the heel portion 814 and the midfoot portion 818. For example, the convex portion 2002 can include a first point 2006 and a second point 2008 opposite the first point 2006. The first point 2006 can be located on the heel portion 814 and the second point 2008 can be located on the midfoot portion 818. A vertical distance (e.g., height, thickness, etc.) of the first point 2006 from the upper edge 812 can be less than a vertical distance of the second point 2008 to the upper edge 812. For example, the upper edge 812 can be located on an axis A1 which can extend transverse to the upper edge 812. A distance of the first point 2006 to the axis A1 can be less than a distance of the second point 2008 to the axis A1.

The concave portion 2004 can extend from the convex portion 2002. The concave portion 2004 can have a thickness less than the convex portion 2002 and provide a life relative to the convex portion 2002. For example, the concave portion 2004 can include a first point 2010 and a second point 2012 opposite the first point 2010. The first point 2010 can be same as the second point 2008. A distance of the first point 2010 from the axis A1 can be greater than a distance of the second point 2012 from the axis A1. In some implementations, the distance of the second point 2012 is equal to the distance of the first point 2006 from the axis A1.

The drop from the heel portion 814 to the midfoot portion 818 can be included to promote natural rollover (e.g., moving from heel strike to toe-off, moving from initial contact with ground to removal of foot from ground, etc.) of the foot, even with a stiff footplate 802. A vertical lift (e.g., height increase, etc.) from the midfoot portion 818 to the forefoot portion 816 of the footplate 802 can be included to encourage the natural rollover.

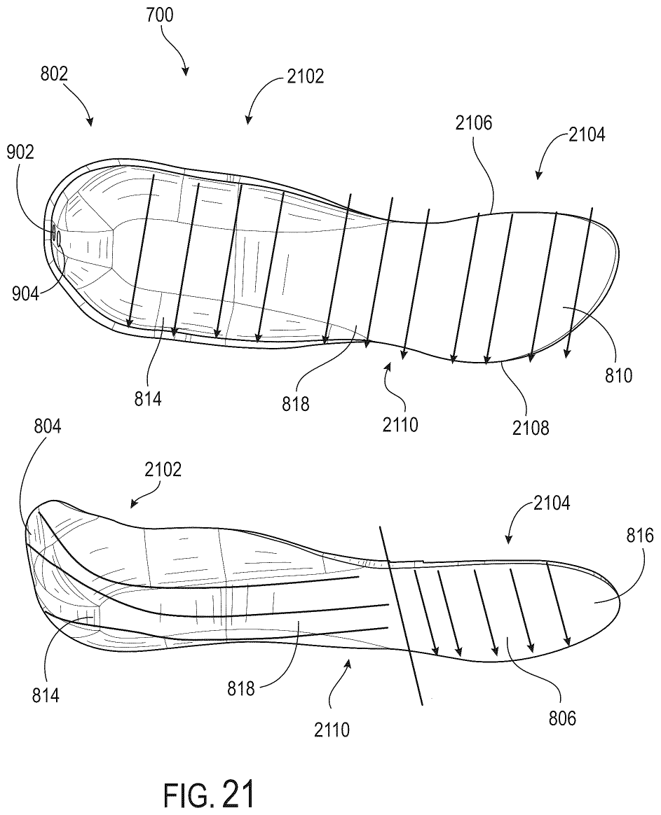

Referring now to FIG. 21, different portions of the footplate 802 can have different thicknesses as well as orientations of the fibers. The footplate 802 can include a first zone 2102. The first zone 2102 can include the heel portion 814 and at least a portion of the midfoot portion 818. The first zone 2102 can have a thickness of about 3.7 mm. In some implementations, the thickness can be greater than or less than 3.7 mm and in other implementations, the thickness of the footplate 802 may vary within the first zone 2102. At least one layer of the footplate 802 in the first zone 2102 can include fibers oriented towards the forefoot portion 816. For example, the fibers can extend in a longitudinal direction (e.g., along a length of the footplate 802, etc.) from the heel portion 814 towards the forefoot portion 816. The fibers in the first zone 2102 oriented in the longitudinal direction can increase at least one of plantarflexion or dorsiflexion stiffness and strength of the footplate 802 during augmentation. In addition, an increased thickness in the footplate 802 can increase stiffness of the footplate 802.

The footplate 802 can include a second zone 2104. The second zone 2104 can include the forefoot portion 816 and, in some implementations, a portion of the midfoot portion 818. The thickness of the footplate 802 in the second zone 2104 can be about 2 mm. In some implementations, the thickness can be greater than or less than 2 mm and in other implementations, the thickness of the footplate 802 may vary within the second zone 2104. A thickness of the second zone 2104 can be less than the first zone 2102. The fibers of the footplate 802 in the second zone 2104 can extend both longitudinally and laterally (e.g., across the footplate 802, laterally, along a width of the footplate 802, etc.) to increase flexibility of the footplate 802 in the forefoot portion 816, allowing for flexibility along metatarsals of the foot. A lateral orientation of the fibers can be perpendicular to the longitudinal orientation, and fibers oriented laterally can extend from a first edge 2106 to a second edge 2108 opposite the first edge 2106 of the footplate 802. The first edge 2106 and the second edge 2108 can define a width of the footplate 802.

The footplate 802 can include a third zone 2110. The third zone 2110 can be between the first zone 2102 and the second zone 2104, and can include at least a portion of the midfoot portion 818. The third zone 2110 can have a thickness between a thickness of the first zone 2102 and the second zone 2104, thereby serving as a thickness transition between the first zone 2102 and the second zone 2104. For example, the third zone 2110 can have a thickness less than the first zone 2102 and greater than the second zone 2104. The thickness of the footplate 802 in the third zone 2110 can be about 3 mm. In some implementations, the thickness can be greater than or less 3 mm and in other implementations, the thickness of the footplate 802 may vary within the third zone 2110. The third zone 2110 can include at least one of fibers extending longitudinally or laterally.

The footplate 802 can include different layers of materials, such as composite materials, to vary a stiffness of the footplate 802 between the zones. For example, the first zone 2102 can have a higher stiffness than the second zone 2104 due to the lateral orientation of the fibers in the first zone 2102. The second zone 2104 can include both longitudinal and lateral oriented fibers to allow flexibility. For example, a first layer of the footplate 802 in the second zone 2104 can include longitudinally oriented fibers and a second layer of the footplate 802 in the second zone 2104 can include laterally oriented fibers. The footplate 802 in the third zone 2110 can include a least one of longitudinally or laterally oriented fibers.

In some implementations, the footplate 802 in the first zone 2102, the second zone 2104, and the third zone 2110 can include at least one of longitudinally oriented fibers, laterally oriented fibers, or fibers oriented in a direction other than longitudinal or lateral. Consequently, a stiffness of the footplate 802 can be varied. In various implementations, the footplate 802 can include different materials, such as a composite material and a steel.

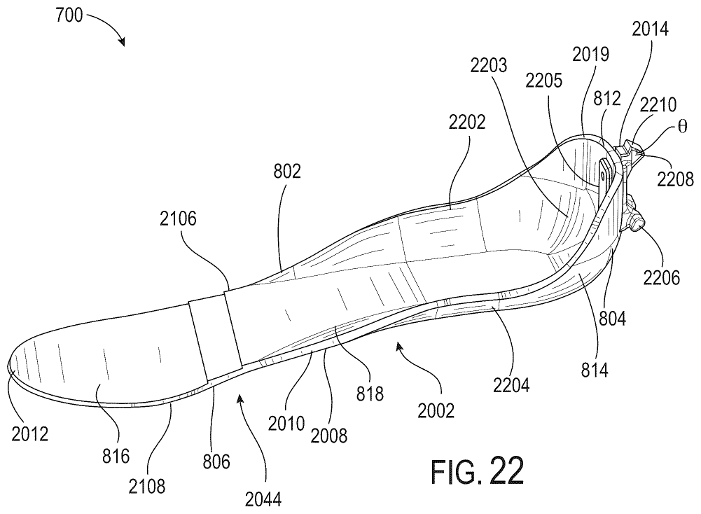

In some implementations, as shown in FIG. 22, among others, the footplate 802 can include one or more side walls. The footplate 802 can include a first side wall 2202 extending from the first edge 2106 and a second side wall 2204 extending from the second edge 2108. The first side wall 2202 can be contiguous with the midfoot portion 818 and the posterior portion 804. The second side wall 2204 can be contiguous with the midfoot portion 818 and the posterior portion 804. In some implementations, the midfoot portion 818 and the posterior portion 804 include the first side wall 2202 and the second side wall 2204. The first side wall 2202 and the second side wall 2204 can increase a stiffness of the footplate 802. In some implementations, the first side wall 2202 includes a portion of the first edge 2106 and the second side wall 2204 includes a portion of the second edge 2108.

Referring back to FIG. 20 and as shown in at least FIGS. 20, 22-23, and 25, among others, the apparatus 700 can include at least one footplate adapter 2014 (e.g., attachment system, etc.). The footplate adapter 2014 can be disposed on the posterior portion 804. Specifically, the footplate adapter 2014 can be disposed on the outer surface 906 of the posterior portion 804. The footplate adapter 2014 can be coupled to the posterior portion 804 via one or more bolts 2302 (e.g., fasteners, screws, etc.). For example, the bolt 2302 can extend through the footplate adapter 2014 and through at least one of the first aperture 902 or the second aperture 904 to couple the footplate adapter 2014 to the footplate 802. In some implementations, the footplate adapter 2014 extends at least partially through at least one of the first aperture 902 or the second aperture 904.

In some implementations, the footplate adapter 2014 can be coupled to the footplate 802 using an adhesive or epoxy. In other implementations, the footplate adapter 2014 can be molded into or integrated with the footplate 802. In some implementations, the apparatus 700 can include a footplate insert 2205. The bolts 2302 can be used to attach the footplate adapter 2014 to the footplate 802, and the footplate insert 2205 can be used as a nut for the bolts 2302. The footplate insert 2205 can define multiple threaded holes corresponding to the first aperture 902 and the second aperture 904. A spacer and screws can be used to mate the footplate insert 2205 to the footplate 802 while an adhesive is drying or curing. Once cured, the spacer and screws can be removed from the footplate insert 2205. For example, the footplate insert 2205 can be coupled to the footplate 802 via adhesion on an inner surface 2203 opposite the outer surface 906. The footplate insert 2205 can be formed of a material, such as a metal, ceramic, polymer, or any other material. Specifically, the footplate insert 2205 can be formed from aluminum or steel, or any combination thereof.

In some implementations, the footplate adapter 2014 can be attached to the footplate by a combination of adhesive and bolts 2302. For example, the adhesive can mitigate smaller movements while the bolts 2302 can resist larger movements. Specifically, the bolt 2302 can be included on the lower portion 910 where augmentations loads are exerting a force against the footplate adapter 2014. In some implementations, the apparatus 700 includes at least one nut to interface with the bolt 2302.

In some implementations, the first aperture 902 and the second aperture 904 are threaded. Consequently, the first aperture 902 and the second aperture 904 can allow for various footplate adapters 2014 to be attached to the footplate 802. For example, the first aperture 902 and the second aperture 904 can allow for the footplate adapter 2014 coupled to the footplate 802 to be switched, and creates a standard attachment to the footplate 802. Consequently, the footplate adapter 2014 can be removably coupled to the footplate 802 via fasteners, such as the bolts 2302.

The apparatus 700 can include at least one actuator module 2016 (e.g., power unit, drive module, etc.). The actuator module 2016 can be an example of the actuator module 110. The actuator module 2016 can actuate and provide augmentation to the movement of the user. For example, the actuator module 2016 can include at least one of a motor, an actuator, and other electrical components to impart a force on the footplate 802 to augment movement of the user and provide a force to the foot of the user.

To attach the actuator module 2016 to the footplate 802, the apparatus 700 can include an actuator adapter 2018 (e.g., connector, etc.). The footplate adapter 2014 can be configured to couple with the actuator adapter 2018. The actuator adapter 2018 can be coupled to the actuator module 2016. The actuator adapter 2018 can move relative to the actuator module 2016, such as rotationally or laterally. The actuator adapter 2018 can connect the actuator module 2016 to the footplate 802 to impart a force on the footplate 802 to augment movement of the user. The actuator adapter 2018 and the footplate adapter 2014 can be manufactured (e.g., formed, etc.) from a variety of materials. For example, at least one of the actuator adapter 2018 or the footplate adapter 2014 can be formed from aluminum or any other metal, plastic, ceramic, composites, or any other material.

In response to the actuator module 2016 exerting a plantarflexing torque (e.g., force, etc.) on the footplate 802, such as the posterior portion 804, the footplate 802 can deflect (e.g., move, etc.) towards the heel. To mitigate discomfort, the footplate 802 can be rigid during the force to limit deflection. For example, the footplate 802 can include a composite with high-stiffness fibers. The fibers can be oriented to increase stiffness of the footplate 802.

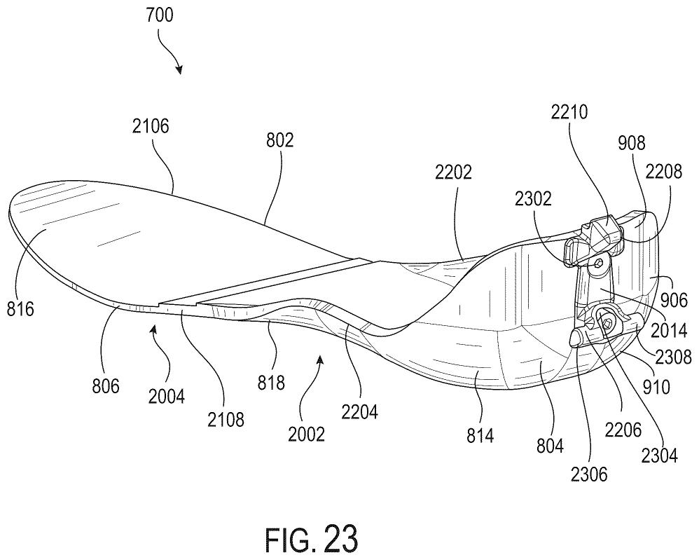

Referring now to FIGS. 22-23, an example of the footplate adapter 2014 can include at least one shaft 2206 (e.g., bar, member, etc.). The shaft 2206 can be disposed on the lower portion 910 of the posterior portion 804. The shaft 2206 can be configured to couple with a portion of the actuator adapter 2018 to connect the footplate 802 to the actuator module 2016. The footplate adapter 2014 can define at least one aperture 2304 at the shaft 2206 such that the shaft 2206 includes a first portion 2306 and a second portion 2308. The first portion 2306 and the second portion 2308 can be separated by the aperture 2304. The shaft 2206 can be coupled to the footplate 802 via the bolt 2302 extending through the aperture 2304.

The footplate adapter 2014 can include at least one catch 2208 (e.g., protrusion, etc.). The catch 2208 can be disposed on the upper portion 908 of the posterior portion 804. The catch 2208 can be configured to engage with another portion of the actuator adapter 2018 different than the portion to couple with the shaft 2206. The catch 2208 can be located above the first aperture 902. In some implementations, the catch 2208 can include a ramp 2210 (e.g., angled surface, etc.) to engage with the another portion, as described further herein. At least one of the catch 2208 or the shaft 2206 can be formed from a metal, such as iron, steel, or stainless steel.

The catch 2208 and the shaft 2206 can be integrally formed such that the catch 2208 is contiguous with the shaft 2206. In various implementations, the catch 2208 and the shaft 2206 are separate. The footplate adapter 2014 can define an aperture 2312 below the catch 2208 and above the shaft 2206. The aperture 2312 can receive the bolt 2302 to couple the footplate adapter 2014 to the footplate 802. In various implementations, the catch 2208 is coupled to the footplate 802 via the aperture 2312 and the bolt 2302.

### III. Example Actuator Adapters

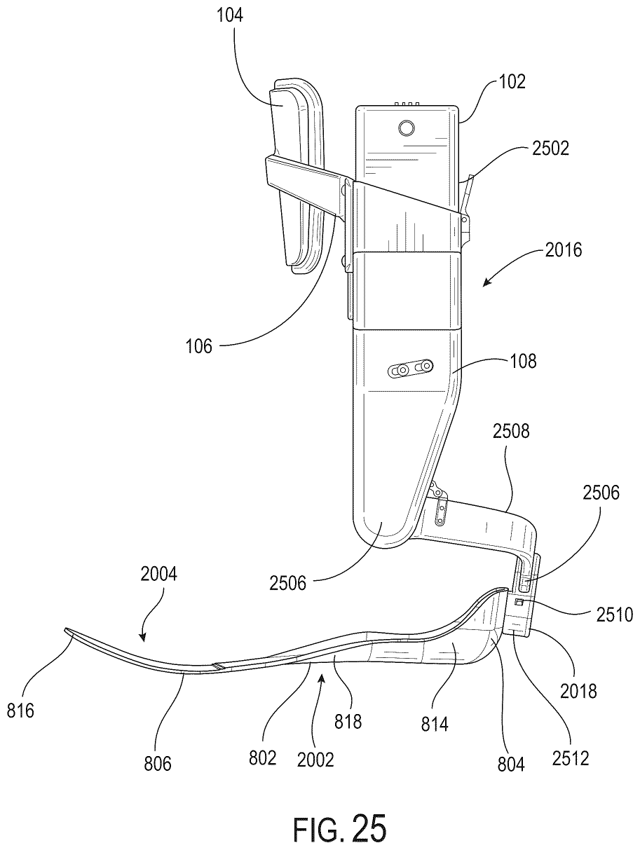

Referring now to FIG. 25, the apparatus 700 can include the battery 102, the shin guard 104, the shin lever 106, and the chassis 108. The battery 102 can be coupled to or included in the actuator module 2016. The apparatus 700 can include at least one housing 2502, and the battery 102 and the actuator module 2016 can be located in the housing 2502. The chassis 108 can be coupled to or included in the actuator module 2016. The apparatus can include the shin guard 104 extending from the housing 2502.

The apparatus 700 can include at least one joint (e.g., artificial joint). The apparatus 700 can include at least one ankle joint 2504 corresponding to an ankle of the foot and at least one subtalar joint 2506 corresponding to a subtalar joint of the foot. The ankle joint 2504 can enable rotation of the actuator module 2016 about the ankle joint 2504. The ankle joint 2504 and the subtalar joint 2506 can augment movement of the foot, and can be coupled by a link 2508 (e.g., arm, member, subtalar and talocrural/ankle joint (STTC) link, etc.). The link 2508 can be rotatably coupled to the ankle joint 2504. The link 2508 can extend at least partially into the subtalar joint 2506, and the link 2508 can rotate about the subtalar joint 2506. For example, the link 2508 can be rotatably coupled to the subtalar joint 2506, thereby enabling the actuator module 2016 to rotate about the subtalar joint 2506 and the sagittal plane 214.

The actuator adapter 2018 can be coupled to the subtalar joint 2506. In various implementations, the actuator adapter 2018 is integrally formed and contiguous with the subtalar joint 2506. In various implementations, the actuator adapter 2018 includes the subtalar joint 2506. In various implementation, the link 2508 is integrally formed with at least one of the ankle joint 2504 or the subtalar joint 2506. In various implementations, the actuator adapter 2018 defines a joint receiving space, and the subtalar joint 2506 is located in the joint receiving space.

The actuator adapter 2018 can be coupled to the footplate adapter 2014, removably coupled with tools, or, attachable and removably coupled without tools. As discussed further herein, the systems and methods of the present disclosure allows the user to quickly and easily attach and detach the actuator adapter 2018 from the footplate adapter 2014 without tools safely, reliably, and ergonomically. The actuator adapter 2018 can be coupled to the footplate adapter 2014 such that the connection does not cause audible and tactile vibrations upon contact of the shoe 702 with a surface (e.g., ground, floor, etc.).

A size and weight of the footplate adapter 2014 can be less than a size and weight of the actuator adapter 2018. In some implementations, the size and weight of the footplate adapter 2014 is greater than or equal to the actuator adapter 2018. In some implementations, a location of the footplate adapter 2014 and the actuator adapter 2018 can be swapped. For example, the actuator adapter 2018 can be coupled to the footplate 802 and the footplate adapter 2014 can be coupled to the actuator module 2016. The actuator adapter 2018 can connect and disconnect from the footplate adapter 2014 without tools, thereby allowing the user to quickly and easily connect and disconnect the actuator module 2016 while wearing the shoe 702, compared to connection mechanism using tools to connect and disconnect.

The actuator adapter 2018 and the footplate adapter 2014 can exert augmentation forces from the actuator module 2016 onto the footplate 802, rigid in at least one of a plantarflexion or dorsiflexion direction, support at least one of an eversion or inversion of a joint (e.g., subtalar joint), etc., protect from contaminants, difficult to jam, and be connected while wearing the shoe 702. The actuator adapter 2018 and the footplate adapter 2014 can be connected while the user is only contacting the actuator adapter 2018, connected with one hand of the user, intuitive to use, indicate that proper engagement has been achieved with either a visual indicator our auditory cue such as a click, and quickly and intuitively be disconnected. In response to the actuator module 2016 becoming disconnected from shank of the user, the actuator adapter 2018 can automatically disengage from the footplate adapter 2014 to mitigate discomfort and damage to the apparatus 700.

The subtalar joint 2506 can allow for a natural range of motion and can be an interface between the footplate adapter 2014 and the actuator adapter 2018. For example, the subtalar joint 2506 can be disposed in the actuator adapter 2018, and contact at least a portion of the footplate adapter 2014. In some implementation, for reliability, the footplate adapter 2014 or the actuator adapter 2018 can include the subtalar joint 2506 such that a coupling between the footplate adapter 2014 and the actuator adapter 2018 is rigid.

The actuator adapter 2018 can include the subtalar joint 2506 which can be coupled to the link 2508. The link 2508 can span and couple the subtalar joint 2506 to the ankle joint 2504. The subtalar joint 2506 can allow the link 2508 to evert and invert with movement of the user. The actuator adapter 2018 and the footplate adapter 2014 can have angles to enable easier engagement by the user of the actuator adapter 2018 with the footplate adapter 2014. In various implementations, the angles are between 40 to 70 degrees inclusive. In various implementations, the angles are less than 40 or greater than 70 degrees.

The actuator adapter 2018 and the footplate adapter 2014 can be designed to have angles mitigating the actuator adapter 2018 and the footplate adapter 2014 from being caught on surfaces, such as stairs. For example, the actuator adapter 2018 and the footplate adapter 2014 may not include 90 degree angles, and may include angles in a range of, for example, 30 to 70 degrees, inclusive. The angles can be in a range greater than or less than 30 to 70, inclusive.

The actuator adapter 2018 and the footplate adapter 2014 can be disconnected in response to the link 2508 undergoing excessive eversion for ergonomics and safety. In various embodiments, excessive eversion can be in response to an angle between link 2508 and actuator adapter 2018 being 120 degrees or greater. In various embodiments excessive eversion can be an angle between link 2508 and actuator adapter 2018 being greater than 90 degrees. In various embodiments, the angle indicating excessive eversion can be less than 90 degrees or greater than 90 degrees.

In response to at least one of the actuator adapter 2018 or the actuator module 2016 being accidentally or intentionally being disconnected from the shank of the user (e.g., shin guard disconnected), the subtalar joint 2506 can cause at least one of the actuator adapter 2018 and the link 2508 to fall to a side of the footplate 802 and simulate excessive eversion. The excessive eversion can cause the actuator adapter 2018 to disengage from the footplate adapter 2014 (e.g., latch 2708 removed from catch 2510, etc.) which can allow the actuator adapter 2018 to become disconnected and mitigate potential discomfort to the user.

### A. Translational Attachment

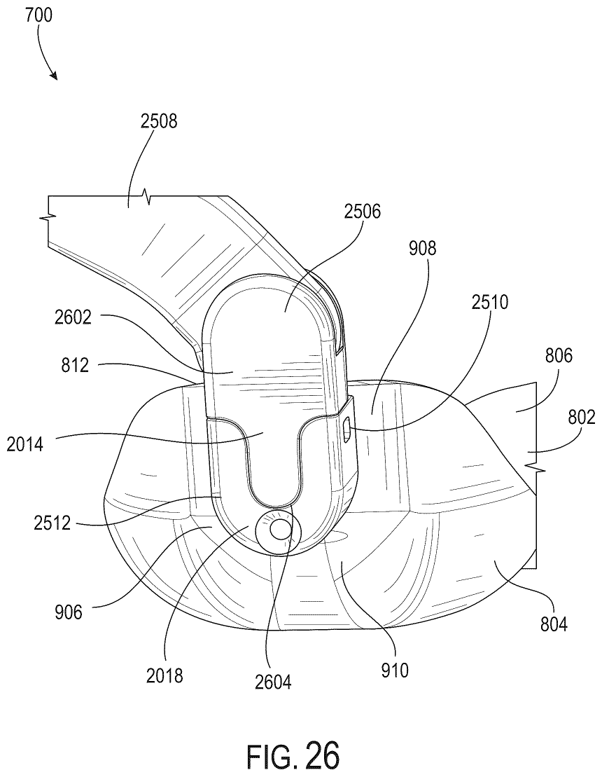

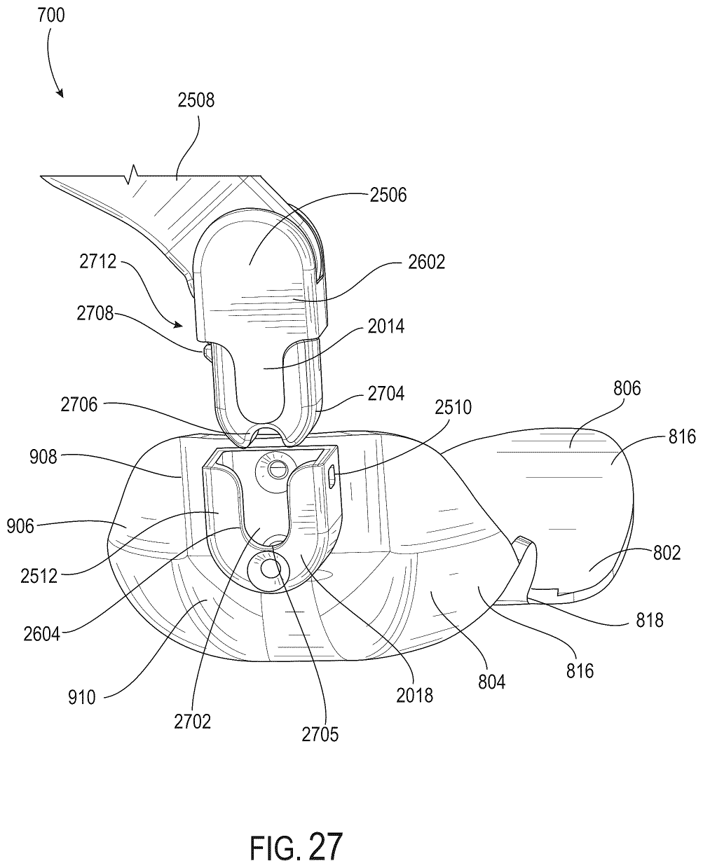

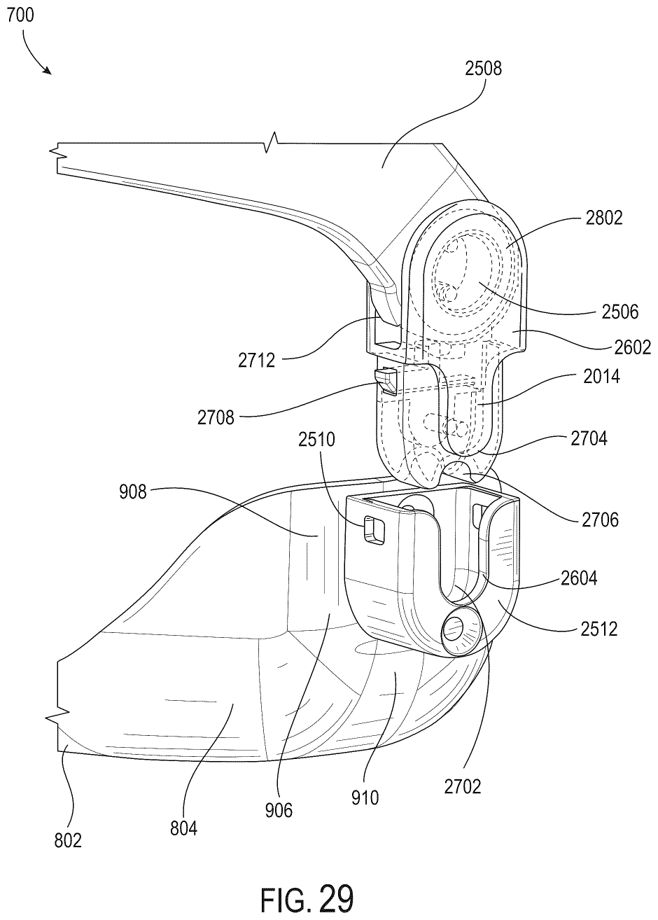

Referring now to FIGS. 26-29, the actuator adapter 2018 can connect to the footplate adapter 2014 using a translational (e.g., linear, etc.) mechanism. In such implementations, the actuator adapter 2018 can be inserted into the footplate adapter 2014 using a translational movement, such as upwards and downwards relative to the outer surface 906. The footplate adapter 2014, in such implementations, can include a receptacle 2702 (e.g., receiving space, etc.). In such implementations, the footplate adapter 2014 may not include the shaft 2206, the catch 2208, or the ramp 2210. The receptacle 2702 can be configured to receive the actuator adapter 2018. The receptacle 2702 can be coupled to the footplate 802 via the bolts 2302. The actuator adapter 2018 can be removably coupled to the footplate 802 via the receptacle 2702, and can slide into and out of the receptacle 2702.

The actuator adapter 2018 can include at least one clip 2704 (e.g., protruding portion, etc.). The clip 2704 can be configured to contact and be disposed in the receptacle 2702 to couple the actuator adapter 2018 to the footplate adapter 2014. The clip 2704 can include at least one concave portion 2706. The footplate adapter 2014 can include at least one shaft 2705. The shaft 2705 can extend in a direction perpendicular to a surface of the receptacle 2702. In some implementations, the shaft 2705 is aligned with the second aperture 904 and extends at least partially into the second aperture 904. The concave portion 2706 can engage with the shaft 2705 and extend at least partially around the shaft 2705. The clip 2704 can be formed from a material, such as steel or stainless steel. The shaft 2705 can be formed from a material, such as steel or stainless steel.

The actuator adapter 2018 can include at least one housing 2602. The housing 2602 can be formed from a material, such as a metal, ceramic, polymer, or any other material. The housing 2602 can be formed from aluminum or steel. The clip 2704 can be defined by the housing 2602. The footplate adapter 2014 can include at least one housing 2512. The housing 2512 can define the receptacle 2702. The housing 2512 can be formed from a material, such as a metal, ceramic, polymer, or any other material. The housing 2602 can be formed from aluminum or steel.

The actuator adapter 2018 can include at least one latch 2708 (e.g., fastener, etc.) The latch 2708 can be located at least partially in the housing 2602. The receptacle 2702 can define at least one catch 2510 (e.g., aperture, opening, etc.), as shown in FIG. 25, among others. The latch 2708 can be spring-loaded and can engage with the catch 2510 to removably couple the actuator adapter 2018 and the footplate adapter 2014. The actuator adapter 2018 can include a spring coupled to the latch 2708 to provide a spring force to maintain engagement of the latch 2708 with the catch 2510 absent a disconnecting force (e.g., user disconnecting the actuator adapter 2018 from the footplate adapter 2014, user pressing on the latch 2708, etc.). The latch 2708 can extend at least partially through the catch 2510 to maintain a connection of the actuator adapter 2018 to the footplate adapter 2014. The latch 2708 and the receptacle 2702 can be formed from a material, such as steel or stainless steel or any other metal, ceramic, polymer, or another material.

The actuator adapter 2018 can include at least one latch depressing feature 2712 (e.g., latch actuator, latch releaser, etc.). To release the actuator adapter 2018 from the receptacle 2702, the user can engage with the latch depressing feature 2712 to engage the spring and remove the latch 2708 from the catch 2510. The latch depressing 2712 can be in contact with the latch 2708, and can move the latch 2708 out of the catch 2510 to disconnect the actuator adapter 2018 from the footplate adapter 2014. The latch depressing features 2712 can be at least one of pushed or pulled to engage the spring and disengage the latch 2708 with the catch 2510.

The link 2508 can be coupled to the actuator adapter 2018 via the subtalar joint 2506. To maintain the actuator adapter 2018 at an angle for engagement with the footplate adapter 2014, the subtalar joint 2506 can include at least one stop to limit a range of motion of the subtalar joint 2506 in eversion and inversion. The range of motion can be between 20 to 50 degrees, inclusive, in either direction (e.g., counterclockwise or clockwise). In some implementations, the range of motion can have a minimum less than 20 degrees and a maximum greater than 50 degrees.

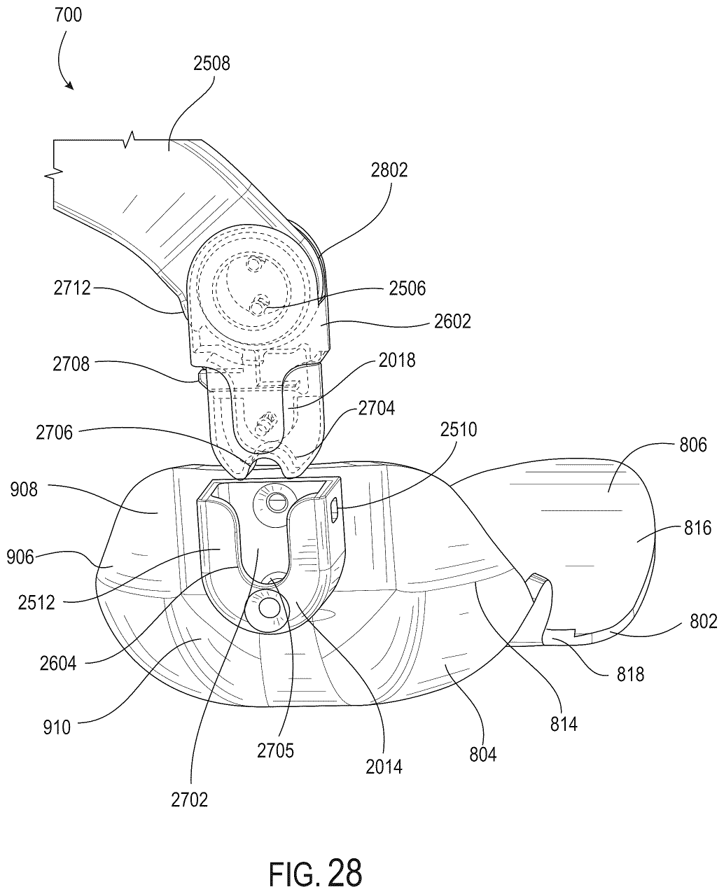

As shown in FIG. 28, among others, the actuator adapter 2018 can include at least one bushing 2802 (e.g., bearing, spacer, etc.) The bushing 2802 can reduce friction of rotation of the link 2508 against other components, such as the housing 2602 or the subtalar joint 2506. The bushing 2802 can be located between at least one of the housing 2602 and the subtalar joint 2506 or the subtalar joint 2506 and the link 2508 to reduce friction and provide rotational support and stability to the link 2508. The bushing 2802 can be or include at least one of ball bearings, metal bushings, or plastic bushings.

The apparatus 700 can include cues (e.g., indicators, notifications, etc.) to indicate complete or incomplete installation or connection of the actuator adapter 2018 with the footplate adapter 2014. The cues can include an audible cue. The audible cue can be created (e.g., generated, etc.) by the latch 2708 moving from a depressed (e.g., in contact with the receptacle 2702, etc.) to an undepressed position (e.g., extending at least partially through the catch 2510, etc.). The audible cue can be generated along with the latch 2708 moving past a mating catch surface (e.g., the catch 2510, etc.), at which point potential energy (e.g., spring energy, etc.) can be converted to kinetic energy of the latch 2708 moving through the catch 2510. The latch 2708 can then collide with the receptacle 2702, or extend through the catch 2510 and create a sound.

As shown in FIG. 26, among others, the cues can include a visual cue 2604. The visual cue 2604 can be used to indicate that the actuator adapter 2018 is fully engaged with the footplate adapter 2014. The visual cue 2604 can include a shape of mating 3-dimensional shapes, as shown in FIG. 26, among others. In response to the actuator adapter 2018 and the footplate adapter 2014 being fully engaged, the shapes can mate to form a continuous surface or line. In some implementations, the visual cue 2604 can be 2-dimensional and can be applied by etching, painting, or other surface treatments. For example, the visual cue 2604 can be a shape painted on the receptacle 2702 and the clip 2704.

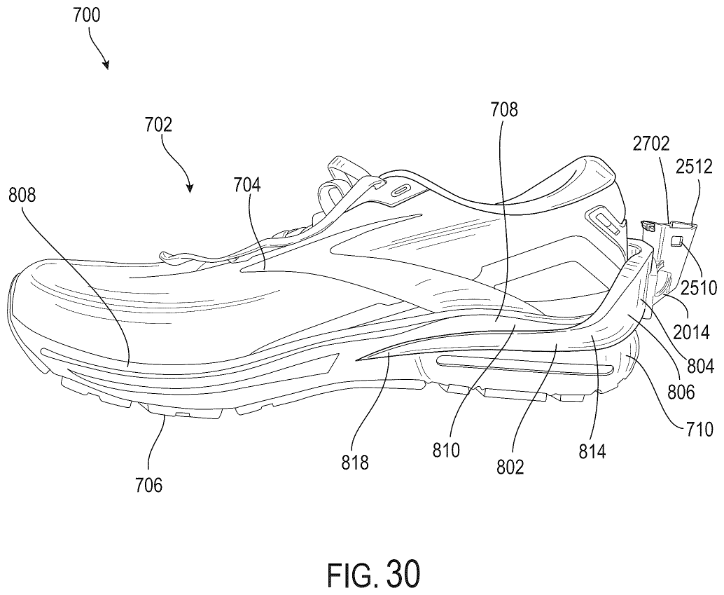

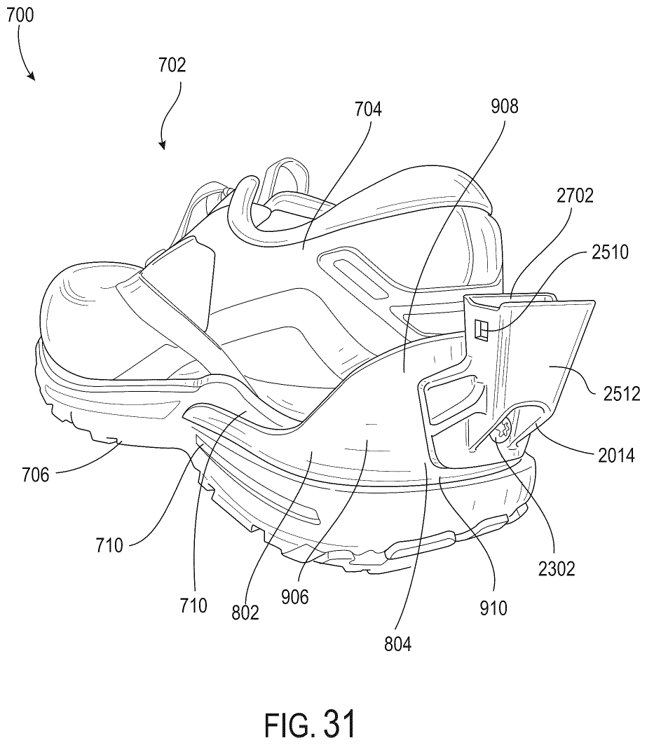

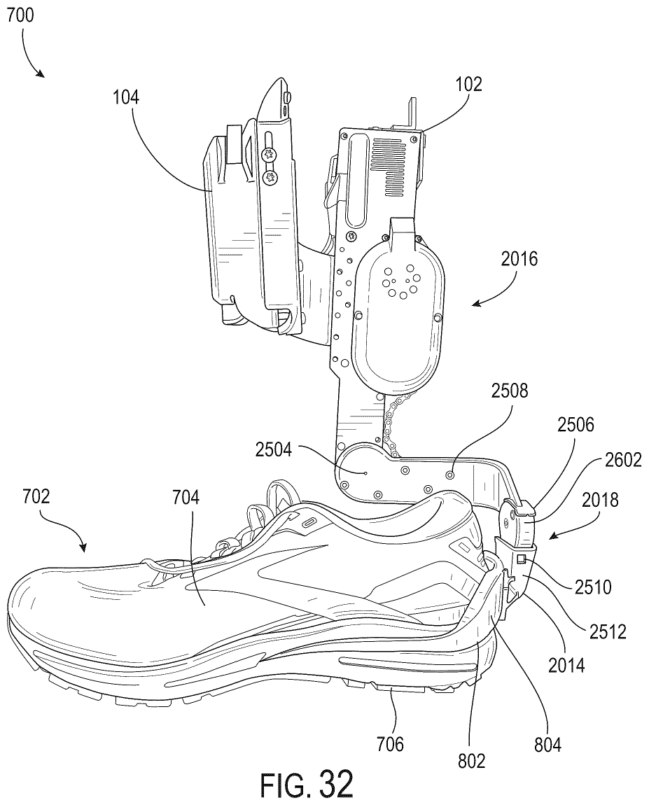

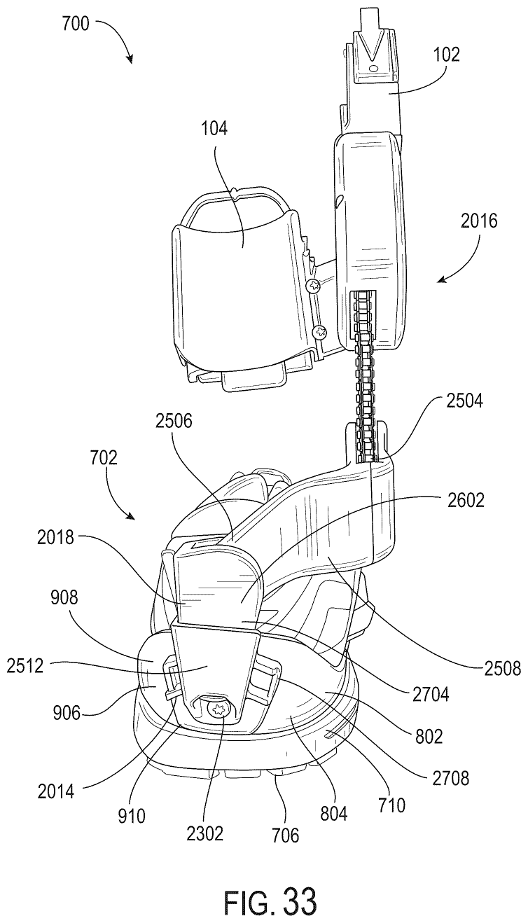

FIGS. 30-34 depict an example shoe 702 including the actuator adapter 2018 and the footplate adapter 2014 as described with respect to FIGS. 26-29. The receptacle 2702 can extend from the posterior portion 804. The footplate adapter 2014 can be coupled to the footplate 802 via at least one of the bolts 2302 or an adhesive. To attach the actuator module 2016, the clip 2704 can be engaged with the receptacle 2702, and the latch 2708 can extend at least partially into the catch 2510. In some implementations, the footplate adapter 2014 does not include the shaft 2705 or the visual cue 2604. In such implementations, the clip 2704 can be inserted into the receptable 2702, and the actuator adapter 2018 and the footplate adapter 2014 can be inserted until the latch 2708 extends partially into the catch 2510.

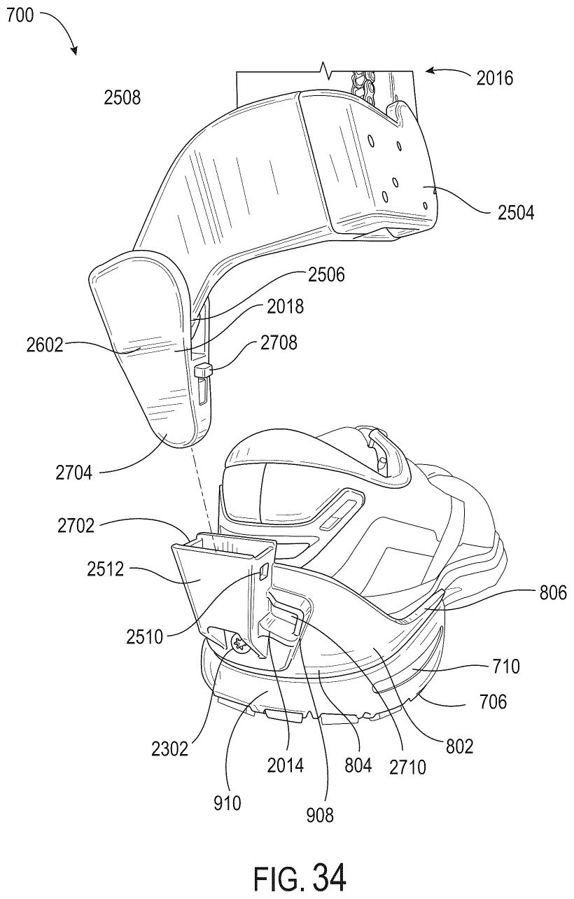

FIG. 34 depicts the actuator adapter 2018 disconnected from the footplate adapter 2014. The latch 2708 can extend past the housing 2602. Upon contact of the latch 2708 with the receptacle 2702, the latch 2708 can be pushed into the housing 2602 such that the latch 2708 does not extend past the housing 2602. The spring coupled to the latch 2708 can store potential energy upon the latch 2708 being pushed into the housing 2602, and once the clip 2704 is inserted such that the latch 2708 aligns with the catch 2510, the spring can convert the potential energy into kinetic energy, and push the latch through at least a portion of the catch 2510.

### B. Rotational Attachment

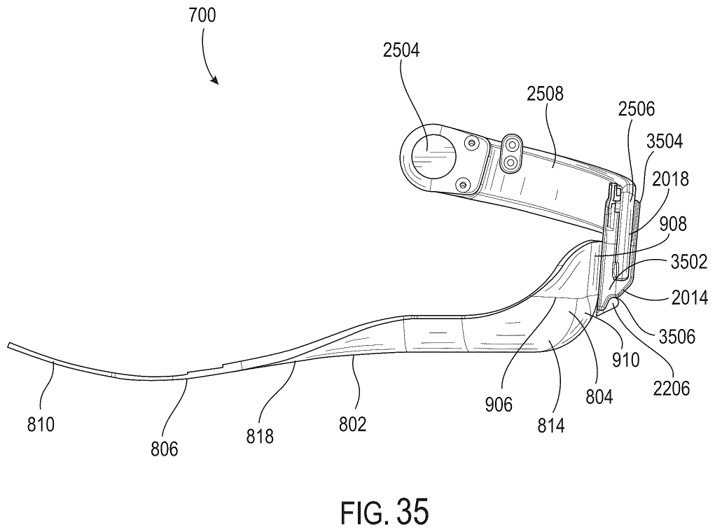

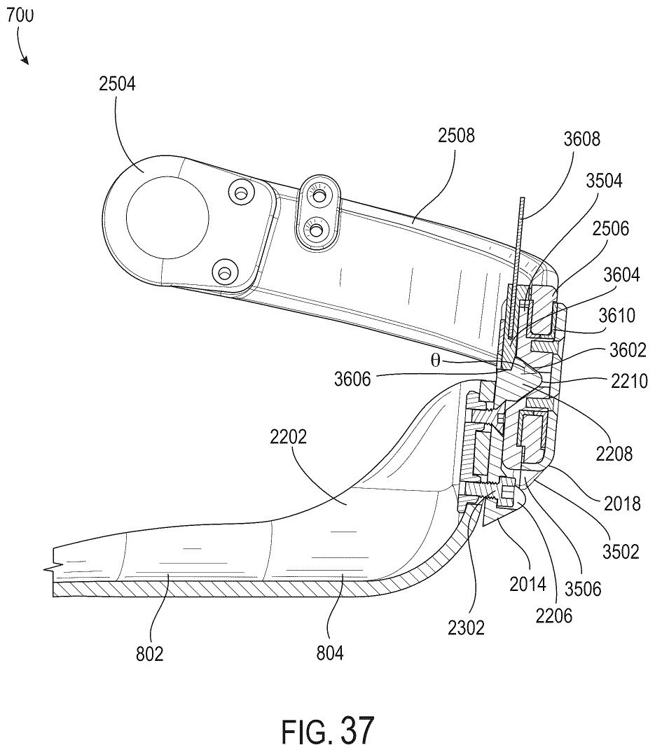

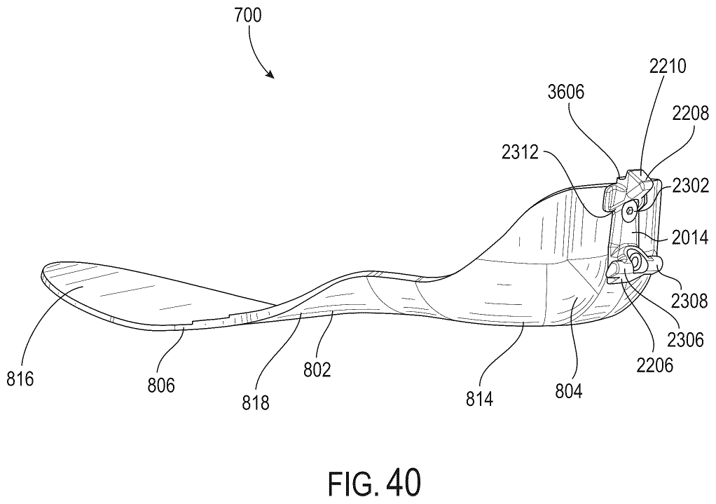

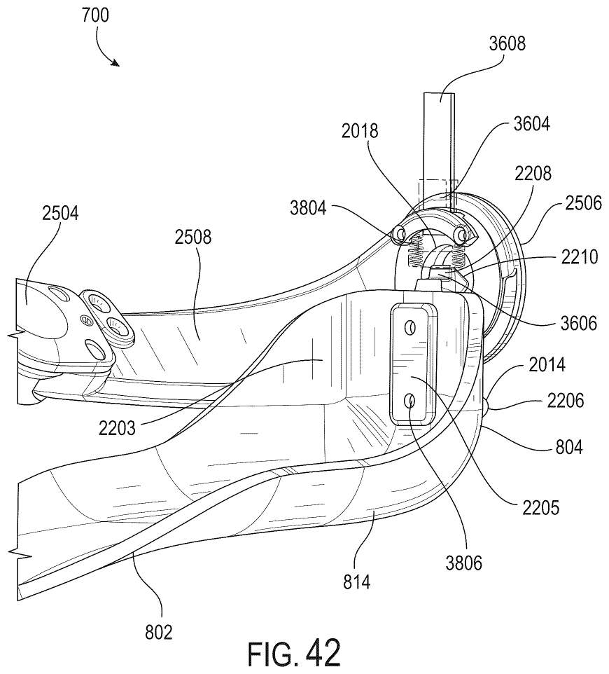

Referring now to FIGS. 35-42, the actuator adapter 2018 can connect to the footplate adapter 2014 using a rotational (e.g., angular, pivoting, axial, etc.) attachment mechanism. The actuator adapter 2018 and the footplate adapter 2014 can be coupled via rotational movement. The footplate adapter 2014 and the actuator adapter 2018 can have mating pivoting features that support relative rotation between the footplate adapter 2014 and the actuator adapter 2018. For example, the footplate adapter 2014 can include the shaft 2206. The actuator adapter 2018 can include one or more portions. The actuator adapter 2018 can include a distal portion 3502 and a proximal portion 3504. The distal portion 3502 can include a concave portion 3506 configured to receive the shaft 2206. The concave portion 3506 can be in contact with the shaft 2206. The concave portion 3506 can have a shape configured to mate and engage with the shaft 2206. In various implementations, the actuator adapter 2018 includes the shaft 2206 and the footplate adapter 2014 includes the concave portion 3506.

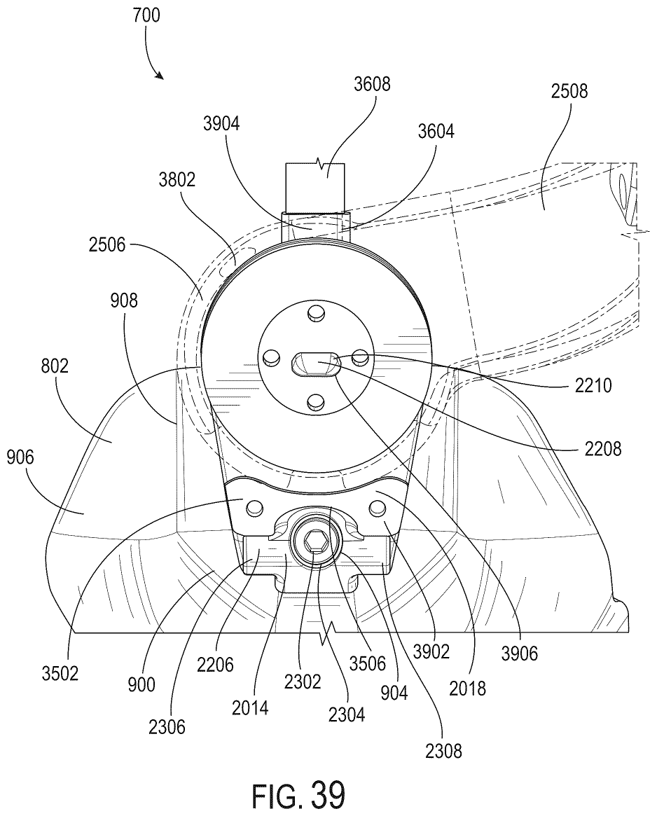

The actuator adapter 2018 and the footplate adapter 2014 can be configured to allow the user to grossly (e.g., approximately, roughly, etc.) align the actuator adapter 2018 to the footplate adapter 2014 to securely mate the actuator adapter 2018 and the footplate adapter 2014 until rotation and connection is complete. For example, as shown in at least FIG. 39, among others, the distal portion 3502 can include at least one protrusion 3902 (e.g., tine, engagement feature, etc.). The protrusion 3902 can contact and engage with the shaft 2206, and can orient the actuator adapter 2018 while the user rotates the link 2508 about the footplate adapter 2014 in a motion that causes the ankle joint 2504 to move towards, for example, the outsole 706. For example, the user can rotate the link 2508 clockwise from a perspective shown in FIG. 39, among others, to engage and secure the actuator adapter 2018 to the footplate adapter 2014. The protrusion 3902 can be contiguous with the concave portion 3506. The protrusion 3902 can define a portion of the concave portion 3506, and can be in contact with the outer surface 906 and the shaft 2206.

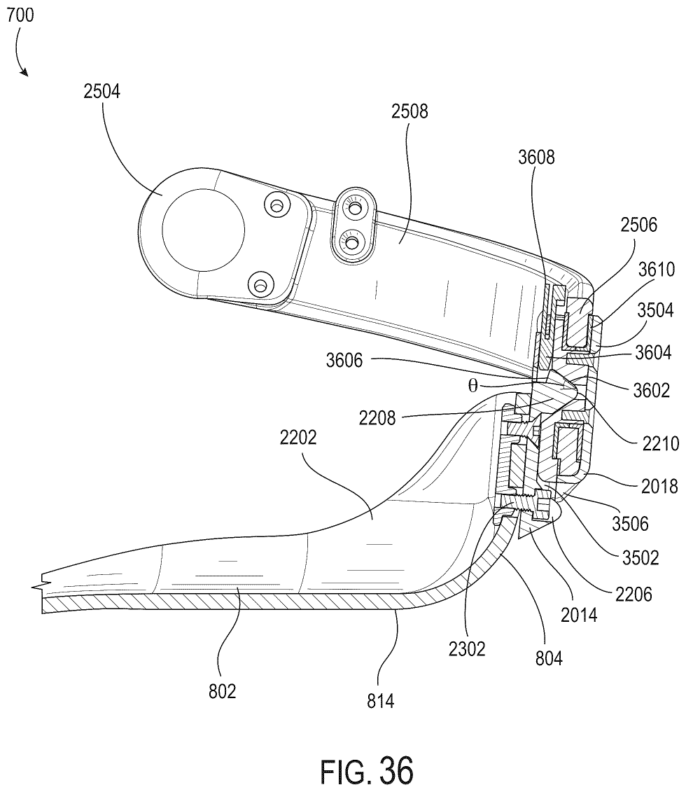

The footplate adapter 2014 can include the catch 2208. The actuator adapter 2018 can define a recess 3602 (e.g., cavity, receiving space, etc.) as shown in FIG. 36, among others. The recess 3602 can be disposed between the distal portion 3502 and the proximal portion 3504. The recess 3602 can be configured to receive the catch 2208. As the actuator adapter 2018 rotates towards the outer surface 906 (e.g., as engagement of the actuator adapter 2018 and the footplate adapter 2014 is completing, etc.), the catch 2208 begins to enter the recess 3602. The catch 2208 can be at least one of coupled with the shaft 2206 or integrally formed with the catch 2208. For example, the catch 2208 can be contiguous with the shaft 2206. In some implementations, the shaft 2206 and the catch 2208 are formed separately and are not in contact.

The actuator adapter 2018 can include at least one latch 3604. The actuator adapter 2018 can include at least one spring 3804 in contact with the latch 3604 such that the latch 3604 is spring-loaded. For example, the spring 3804 can impart a spring force on the latch 3604. The latch 3604 can be disposed in the proximal portion 3504, and can at least partially define the recess 3602. As the catch 2208 enters the recess 3602, the catch 2208 can come into contact with the latch 3604, and displace the latch 3604 (e.g., adjust a position of the latch 3604, move the latch 3604, etc.). The latch 3604 can be configured to engage with the catch 2208.

The catch 2208 can include the ramp 2210. The ramp 2210 can be configured to engage with the latch 3604. For example, the latch 3604 can first come into contact with the catch 2208 at the ramp 2210. The ramp 2210 can have an angle θ large enough to mitigate back-driving of the latch 3604 (e.g., latch 3604 moves back to original position, etc.), but can have an angle small enough to remove backlash (e.g., movement between latch 3604 and ramp 2210, etc.) that may be due to manufacturing tolerances or wear. In various implementations, the ramp 2210 can have an angle between 40 to 60 degrees, inclusive. In various implementations, the ramp 2210 can have an angle less than 40 degrees or greater than 60 degrees. The catch 2208 have a shape matching the recess 3602 to minimize a thickness of the catch 2208.

The latch 3604 can lock the actuator adapter 2018 to the footplate adapter 2014. For example, as the actuator adapter 2018 rotates towards the outer surface 906, the catch 2208 begins to enter the recess 3602 and the latch 3604 comes into contact with the ramp 2210. The latch 3604 moves up the ramp 2210 as the actuator adapter 2018 continues to rotate until the ramp 2210 drops to a receiving space 3606. The catch 2208 can define a receiving space 3606 contiguous with the ramp 2210, and potential energy of the spring can build as the latch 3604 moves up the ramp 2210. Once the latch 3604 moves past the ramp 2210, the potential energy can convert to kinetic energy as the latch 3604 falls into the receiving space 3606, thus completing the engagement and locking the actuator adapter 2018 to the footplate adapter 2014. The receiving space 3606 can be located between the outer surface 906 and the ramp 2210.

The subtalar joint 2506 can at least partially define the recess 3602. The subtalar joint 2506 can allow the link 2508 to evert and invert with the user. The footplate adapter 2014 and the actuator adapter 2018 can include draft angles to facilitate engagement of the footplate adapter 2014 with the actuator adapter 2018, and rotation of the actuator adapter 2018 until the footplate adapter 2014 and the actuator adapter 2018 are fully engaged. The draft angles can be between 40 to 70 degrees, inclusive. In various implementations, the draft angles can be less than 40 degrees or greater than 70 degrees.

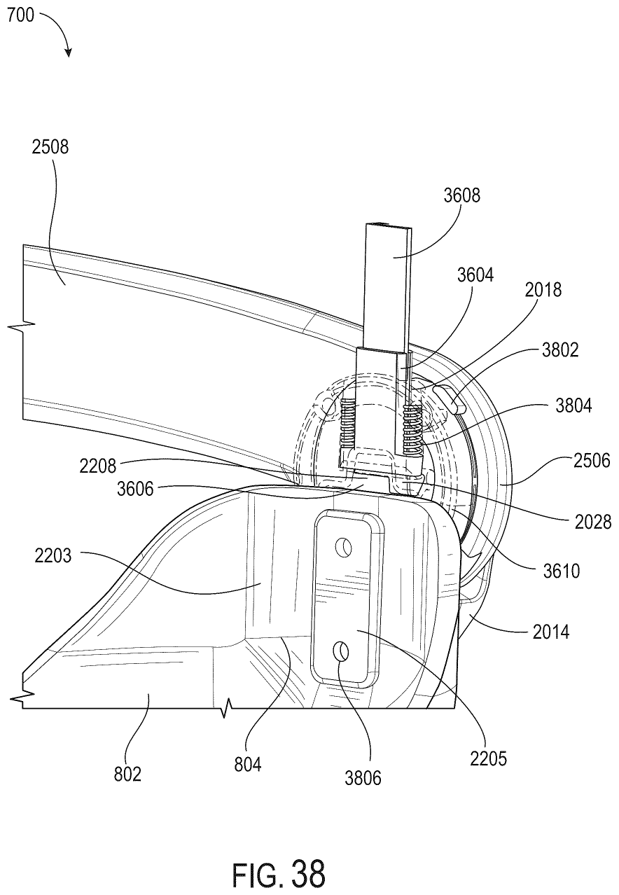

In some implementations, as shown in FIG. 38, among others, the footplate insert 2205 can be coupled to the footplate 802. The footplate insert 2205 can define at least one aperture 3806. The aperture 3806 can include threads, and can be aligned with at least one of the first aperture 902 or the second aperture 904. To couple the footplate adapter 2014 to the footplate 802, the bolt 2302 can extend through the footplate adapter 2014 via at least one of the first aperture 902 or the second aperture 904, through the footplate 802, and extend at least partially through the aperture 3806 of the footplate insert 2205.

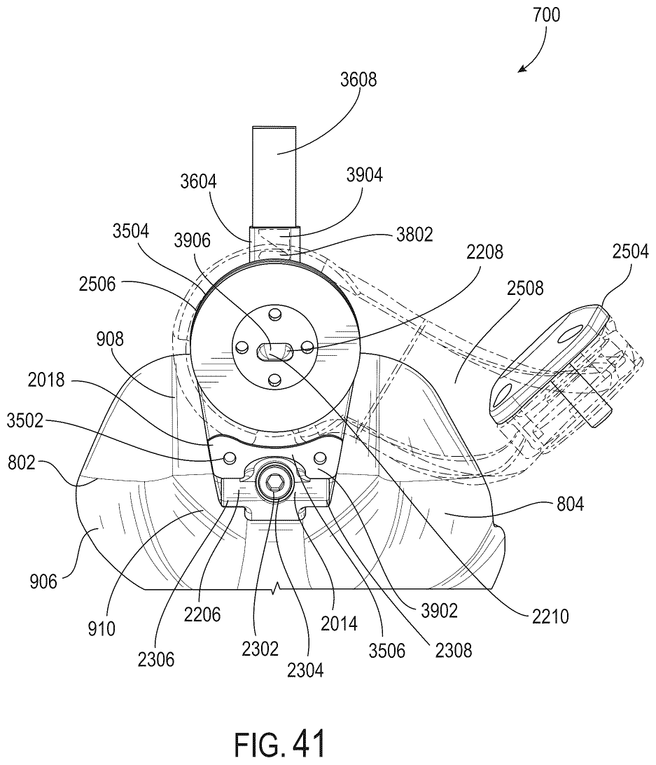

The latch 3604 can be removed (e.g., disengaged, disconnected, etc.) from the footplate adapter 2014 to disconnect the actuator adapter 2018 from the footplate adapter 2014. As shown in FIG. 38, among others, the link 2508 can include at least one stop 3802 (e.g., protrusion, raised surface, etc.). The stop 3802 can rotate around the subtalar joint 2506 as the link 2508 rotates. During excessive eversion of the link 2508, as described above, the stop 3802 can engage with the latch 3604 as shown in FIG. 41, among others. FIG. 38 depicts a non-excessively everted link 2508 while FIG. 41 shows an excessively everted link 2508. The stop 3802 can be a cam surface and the latch 3604 can include a ramp 3904 as shown in FIG. 39, among others. The ramp 3904 can be an angled surface and can extend from the latch 3604 towards a surface of the link 2508. As the stop 3802 continues to rotate upon engagement with the latch 3604, the stop 3802 can contact the ramp 3904 and lift the ramp 3904 to disengage the latch 3604 from the catch 2208. For example, the stop 3802 can push the latch 3604 out from the receiving space 3606. Once disengaged, momentum and moment of the actuator adapter 2018, the link 2508, and the actuator module 2016 falling to a lateral side (e.g., side, etc.) of the leg of the user (e.g., footplate 802, etc.) can cause the actuator adapter 2018 to completely disengage with the footplate adapter 2014 (e.g., not in contact with the footplate adapter 2014, etc.), thereby mitigating potential discomfort.

In some implementations, the user can remove the actuator adapter 2018 from the footplate adapter 2014 by excessively everting the actuator module 2016 by hand. For example, the user can unstrap the shin guard 104 from the leg of the user, and rotate the actuator module 2016 towards the ground. Upon excessive eversion, the user can then lift the actuator adapter 2018 off the footplate adapter 2014 and decoupling the actuator adapter 2018 from the footplate adapter 2014.

An application of force to the latch 3604 can release the actuator adapter 2018 from the footplate adapter 2014, such as by pulling the latch 3604 out from the receiving space 3606. The apparatus 700 can include at least one tab 3608 (e.g., panel, hook etc.) as shown in FIG. 36, among others. The tab 3608 can be coupled to the latch 3604. An application of force to the tab 3608 can release the actuator adapter 2018 from the footplate adapter 2014. The tab 3608 can allow the user to disengage the actuator adapter 2018 from the footplate adapter 2014 without everting the actuator module 2016. The tab 3608 can be formed from a material, such as a polymer, metal, ceramic, fabric, elastomer, or any other material. The tab 3608 can be rigid or flexible, such as a fabric or rubber.

A force applied to the tab 3608, such as a pulling force, can lift the latch 3604. Once the latch 3604 is depressed (e.g., not in contact with the catch 2208, etc.), the user can lift and/or rotate the actuator adapter 2018 out from the footplate adapter 2014. For example, once the latch 3604 is depressed, the actuator adapter 2018 can be rotated (e.g., rotated away from the outer surface 906, etc.) such that the latch 3604 contacts the ramp 2210, moves down the ramp 2210, and the catch 2208 is removed from the recess 3602.

The tab 3608 can be designed such that a purpose and action to apply to the tab 3608 is intuitive to the user. For example, the tab 3608 can be a different color from its surrounding parts, such as the link 2508 and the actuator adapter 2018. At least one of a shape, size, or texture of the tab 3608 can mimic tabs used on a posterior of footwear. The tab 3608 can include texts or graphics to indicate its purpose, such as the phase “pull to release.” The tab 3608 can be a loop of a material, such as a fabric, thus allowing the user to hook at least one finger into to apply a force to. In some implementations, the user can pinch the tab 3608 to apply the force or the tab 3608 can include a lip that provides a surface for the user to apply a force to.

At least one of the actuator adapter 2018 or the footplate adapter 2014 can include one or more features to mitigate jamming of the apparatus 700 or contaminants. For example, at least one of the actuator adapter 2018 or the footplate adapter 2014 can include an aperture to mitigate material such as contaminants from accumulating in the actuator adapter 2018 or the footplate adapter 2014 and mitigating engagement. The actuator adapter 2018 can be configured such that engagement with the footplate adapter 2014 can push out any contaminants within the actuator adapter 2018. In some implementations, the catch 2208 and the recess 3602 can include draft angles that allow for an initial misalignment of the catch 2208 and the recess 3602 to mitigate jamming of rotation of the actuator adapter 2018. The draft angles can be in a range between 30 to 60 degrees. In various implementations, the draft angles are larger than 60 degrees or less than 30 degrees.

To maintain the actuator adapter 2018 at an angle for engagement with the footplate adapter 2014, the subtalar joint 2506 can include at least one stop to limit a range of motion of the subtalar joint 2506 in eversion and inversion. The range of motion can be between 20 to 50 degrees, inclusive, in either direction (e.g., counterclockwise or clockwise). In some implementations, the range of motion can have a minimum less than 20 degrees and a maximum greater than 50 degrees.

As shown in FIG. 36, among others, the actuator adapter 2018 can include at least one bushing 3610. The bushing 3610 can reduce friction of rotation of the link 2508 against other components, such as the latch 3604 or the subtalar joint 2506. The bushing 3610 can be located between at least one of the latch 3604 and the subtalar joint 2506 or the link 2508 and the subtalar joint 2506 to reduce friction and provide rotational support and stability to the link 2508. The bushing 3610 can be or include at least one of ball bearings, metal bushings, or plastic bushings.

The audible cue can be created (e.g., generated, etc.) by the latch 3604 moving from a depressed (e.g., in contact with the ramp 2210, etc.) to an undepressed position (e.g., in contact with the receiving space 3606, etc.). The audible cue can be generated along with the latch 3604 moving past a mating catch surface (e.g., the ramp 2210, etc.), at which point potential energy (e.g., spring energy, etc.) can be converted to kinetic energy as the latch 3604 moves to contact the receiving space 3606. The latch 3604 can collide with the receiving space 3606 and create a sound.

As shown in FIG. 39, among others, the cues can include a visual cue 3906. The visual cue 3906 can be defined by the actuator adapter 2018, and can be used to align the actuator adapter 2018 with the ramp 2210. The visual cue 3906 can be an aperture having a shape to mate with the ramp 2210. In some implementations, the visual cue 3906 can be 2-dimensional and can be applied by etching, painting, or other surface treatments. For example, the visual cue 3906 can be a shape painted on at least one of the actuator adapter 2018 or the footplate adapter 2014.

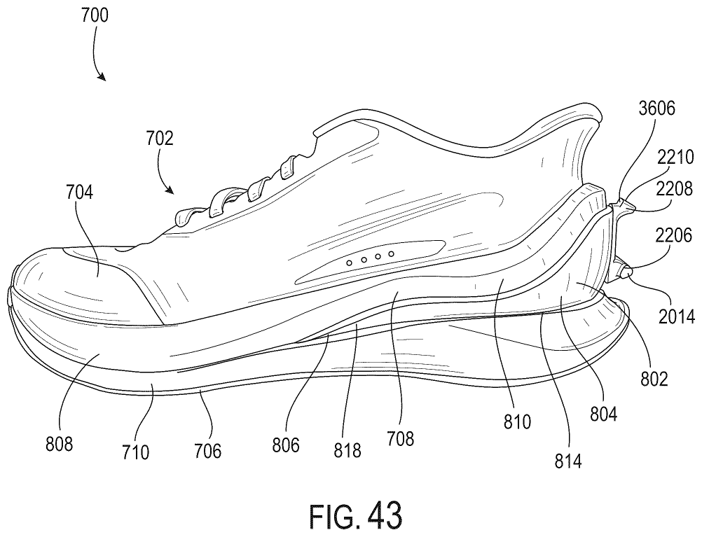

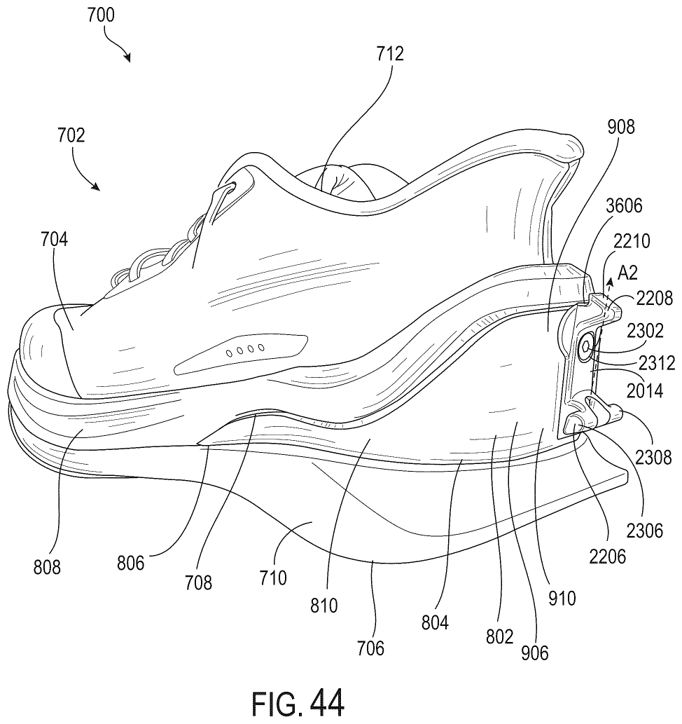

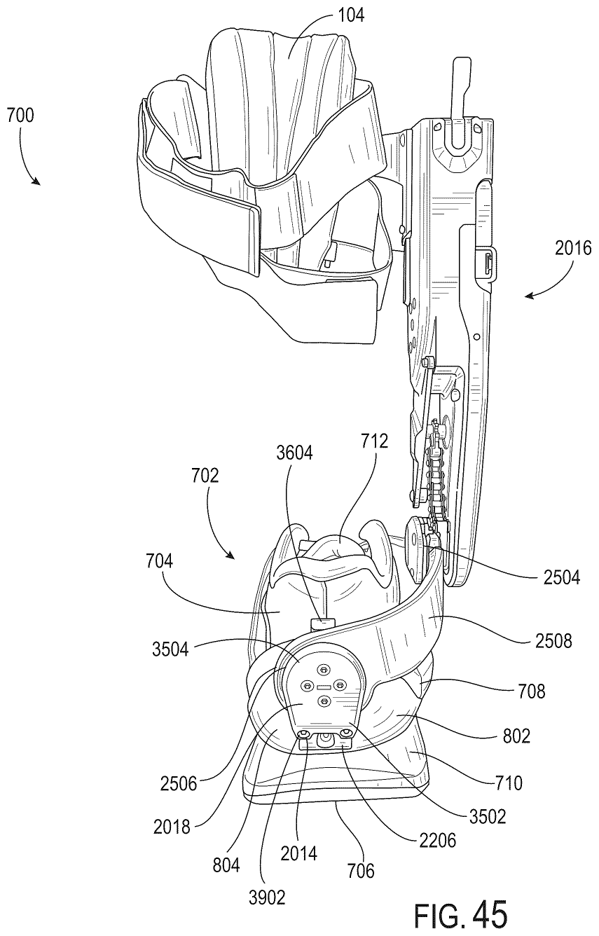

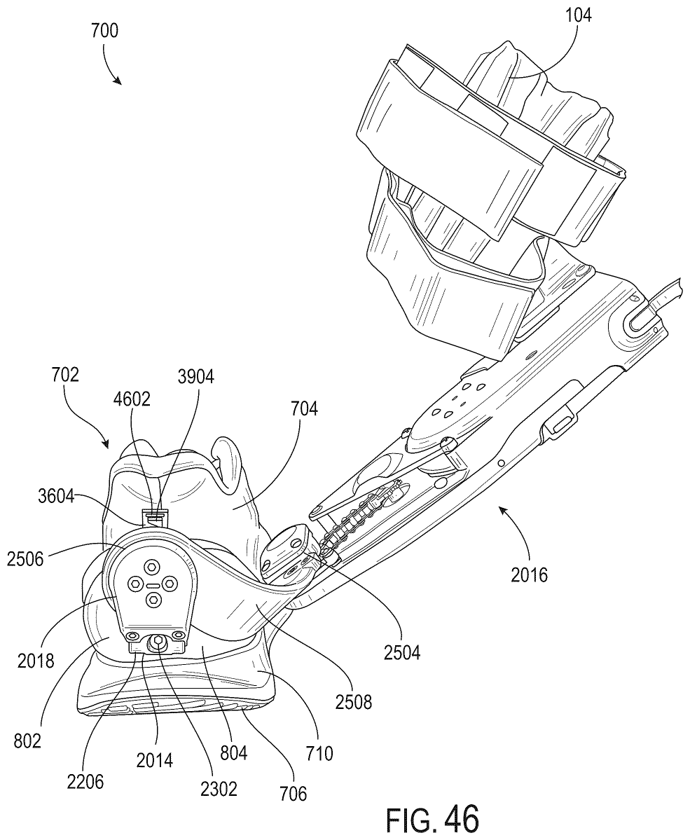

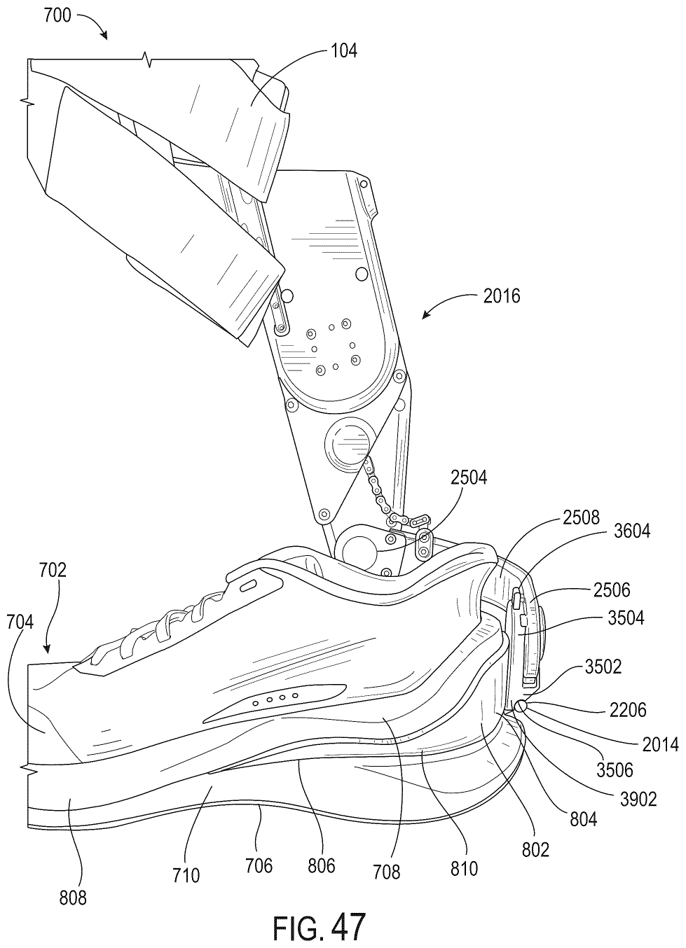

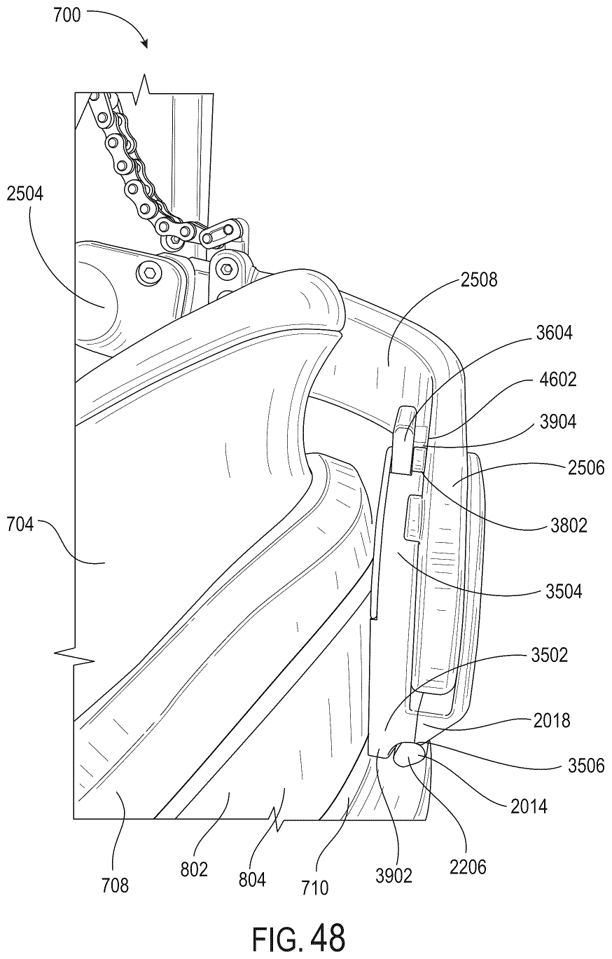

FIGS. 43-44 depict the shoe 702 including the footplate adapter 2014 described with respect to FIGS. 35-42. FIGS. 45-48 depict the shoe 702 including the footplate adapter 2014 and the actuator adapter 2018 described with respect to FIGS. 35-42. FIG. 46 can depict a maximum eversion of the actuator module 2016, and can correspond to a position of the stop 3802 coming into contact with the ramp 3904.

In the implementations shown in FIGS. 45-48, the tab 3608 can be made of a metal, such as stainless steel, and can include a shelf 4602. To pull the latch 3604 from the receiving space 3606 and disconnect the actuator adapter 2018 from the footplate adapter 2014, the user can apply a force to the shelf 4602 to lift the tab 3608 and subsequently the latch 3604. In some implementations, the shelf 4602 can be the same as the ramp 3904. Both the actuator adapter 2018 and the footplate adapter 2014 can be formed from at least one metal. For example, the latch 3604 and the shaft 2206 can be formed from stainless steel. The link 2508 can be formed from aluminum.

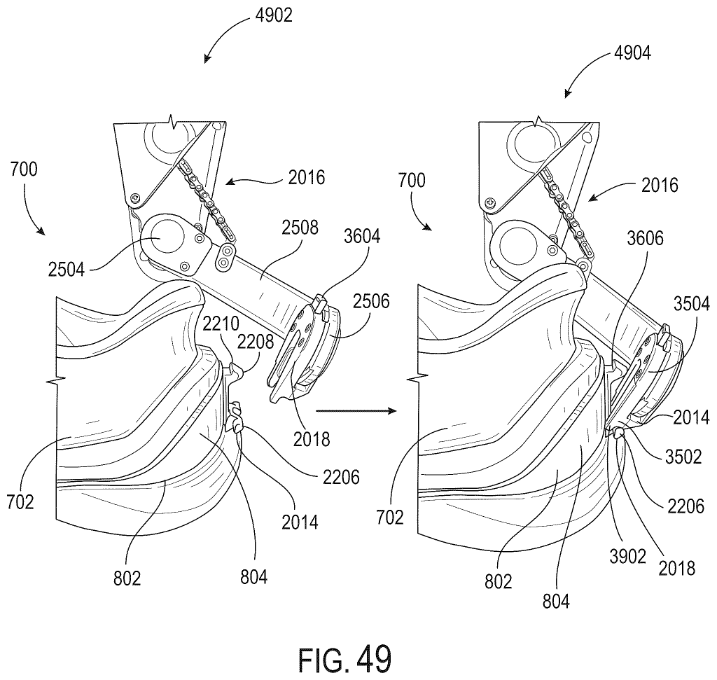

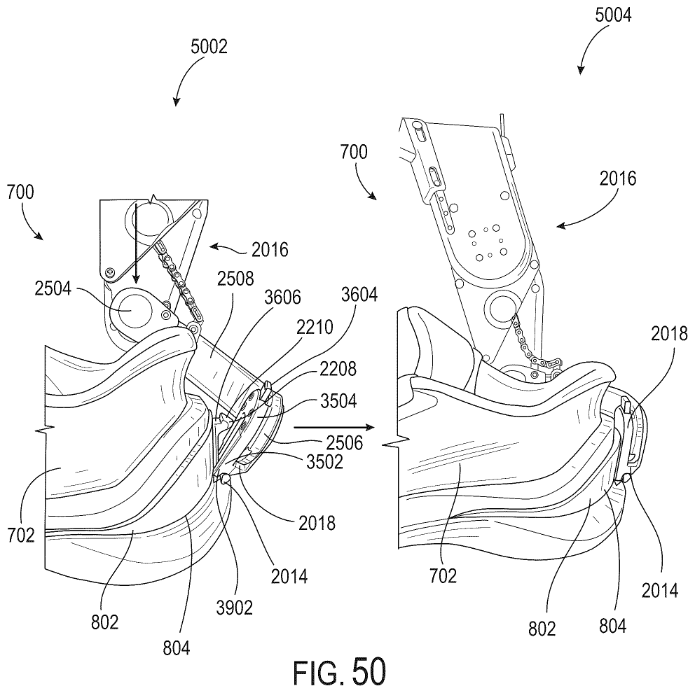

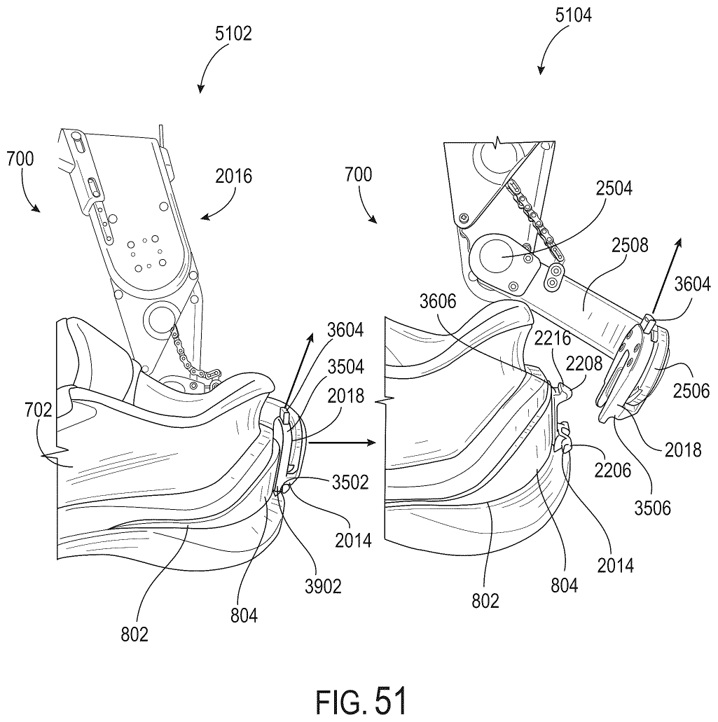

FIGS. 49-51 depict an attachment and detachment process of the actuator adapter 2018 to the footplate adapter 2014. At step 4902, the user can be holding the actuator module 2016, and can be positioning the actuator adapter 2018 to contact the footplate adapter 2014. At step 4904, the user can angle the actuator adapter 2018 such that a surface of the actuator adapter 2018 that first comes into contact with the footplate adapter 2014 can be the protrusion 3902. The protrusion 3902 and then the concave portion 3506 can contact the shaft 2206. At step 5002, the user can push on the link 2508 towards the outsole 706 such that the protrusion 3902 and the concave portion 3506 mates with the shaft 2206, and the proximal portion 3504 moves towards the footplate adapter 2014. At step 5004, the catch 2208 can enter the recess 3602, and the latch 3604 can come into contact with the ramp 2210. As the user continues to apply force to, for example, the link 2508, the actuator adapter 2018 moves closer towards the footplate adapter 2014, and the latch 3604 moves up the ramp 2210 until the latch 3604 moves downwards to the receiving space 3606, signifying attachment of the actuator adapter 2018 with the footplate adapter 2014.

To detach the actuator adapter 2018 from the footplate adapter 2014, at step 5102, the user can apply a force, such as a pulling force, on the tab 3608. The user can pull the tab 3608 in a direction upwards and away from the footplate adapter. As the user pulls on the tab 3608, the latch 3604 moves upwards and away from the receiving space 3606, detaching the actuator adapter 2018 from the footplate adapter 2014. The actuator adapter 2018 can be moved such that the catch 2208 moves out of the recess 3602 and then the concave portion 3506 and the protrusion 3902 are removed from being in contact with the shaft 2206. At step 5104, the actuator adapter 2018 can be disconnected from the footplate adapter 2014 as a result of continuous application of force on the tab 3608 starting at step 5102.

### C. Magnetic Attachment

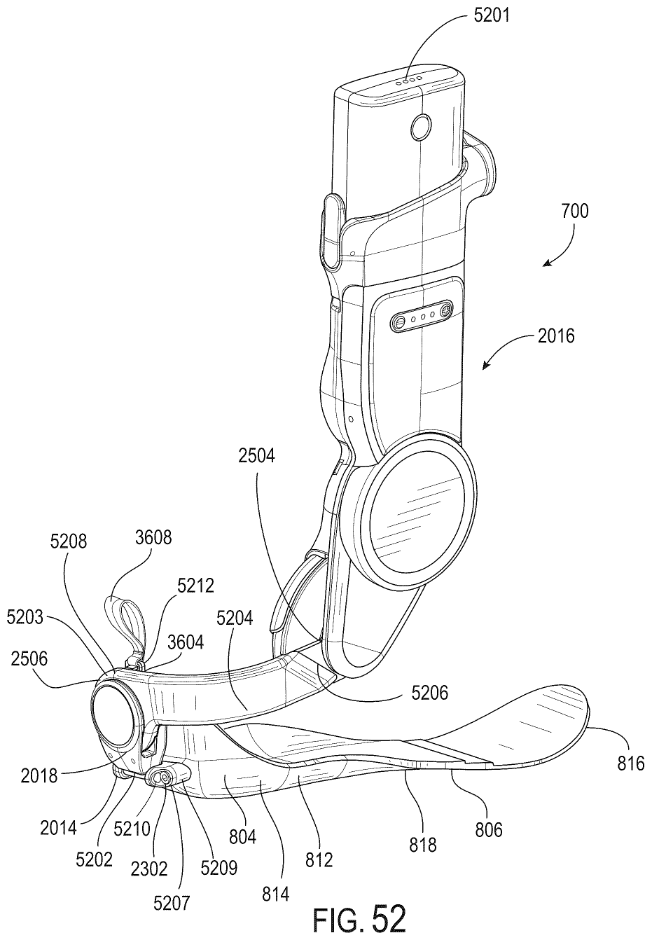

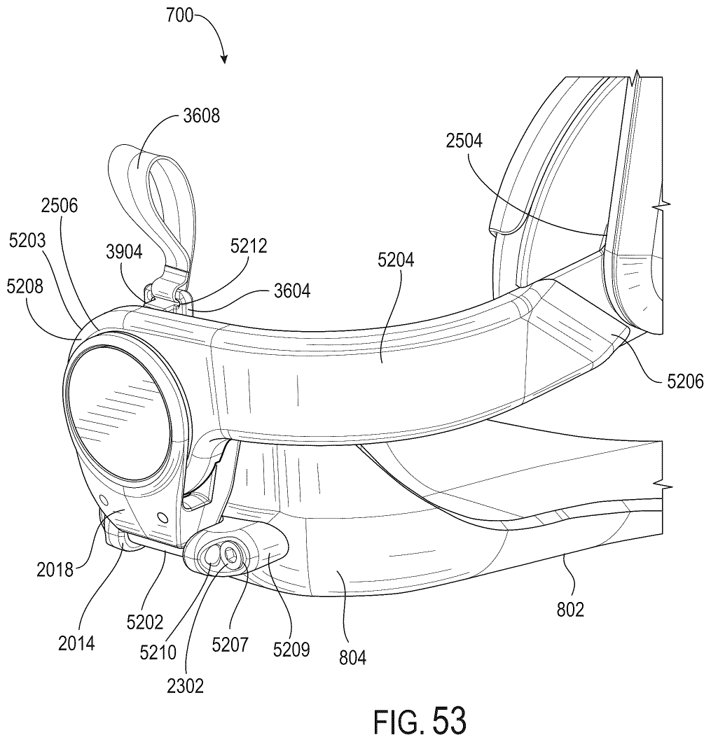

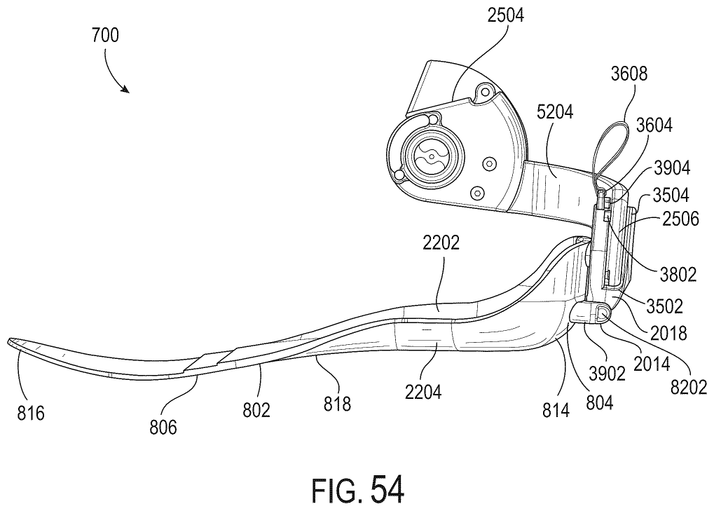

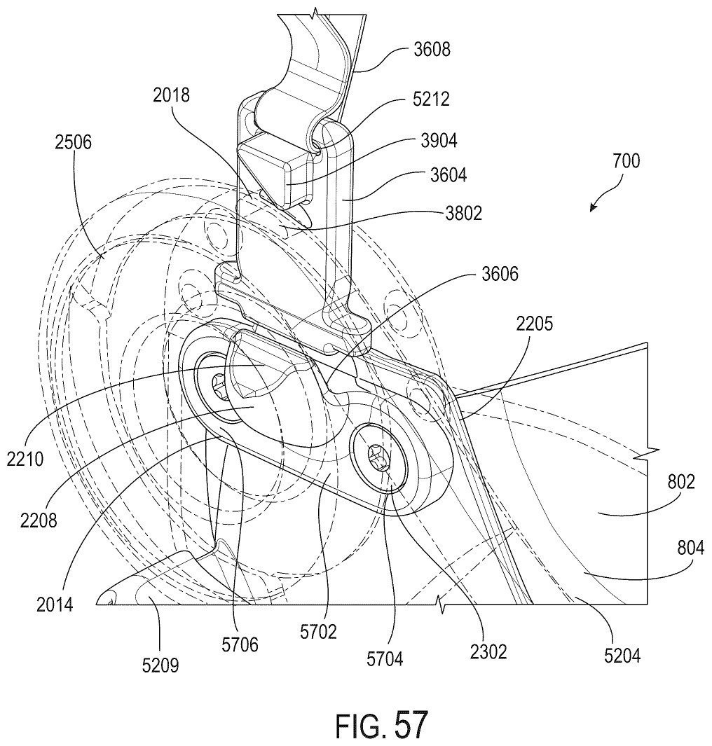

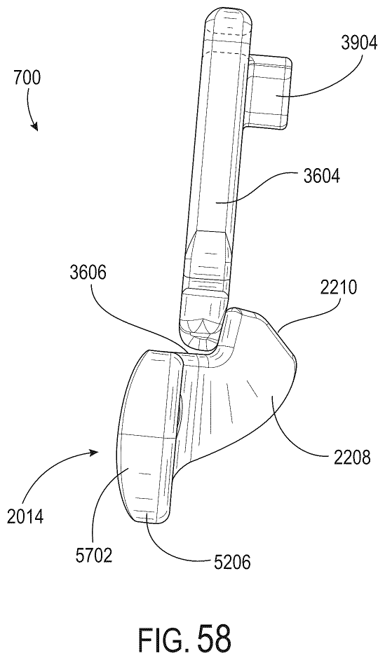

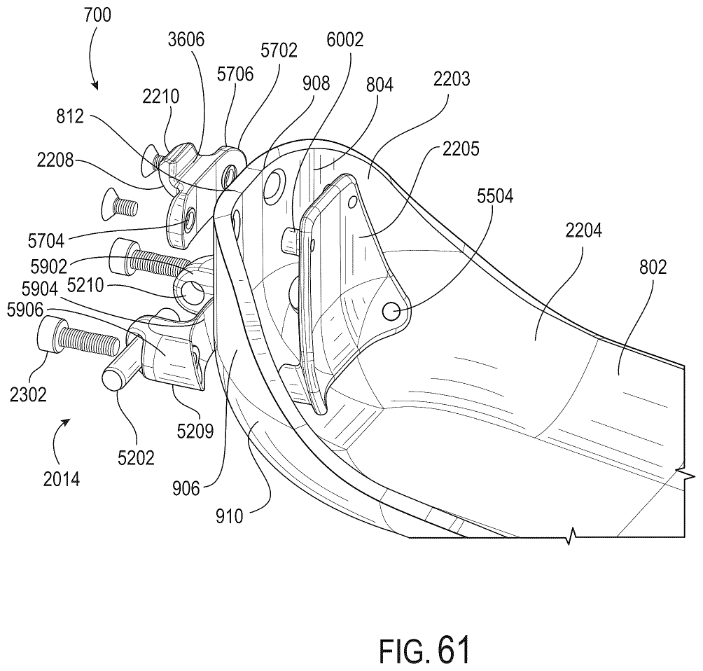

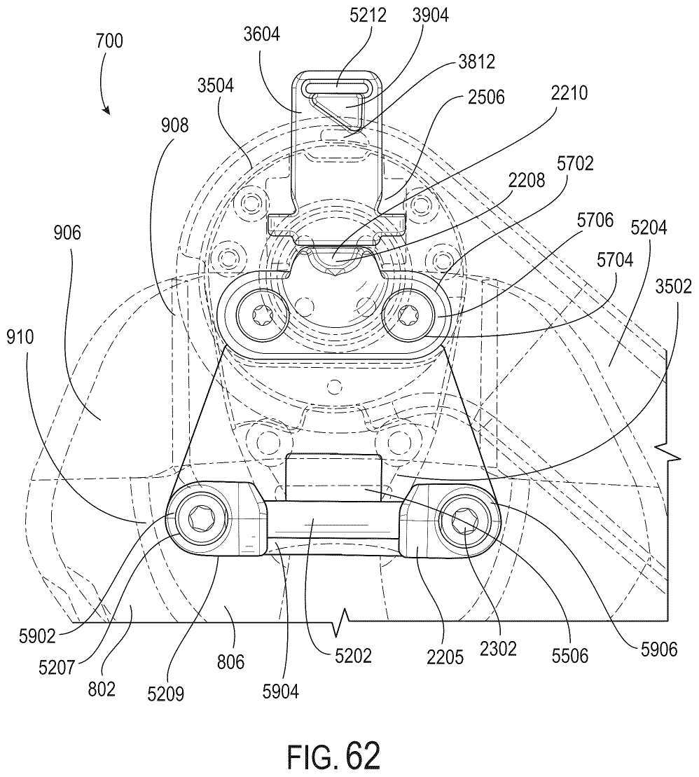

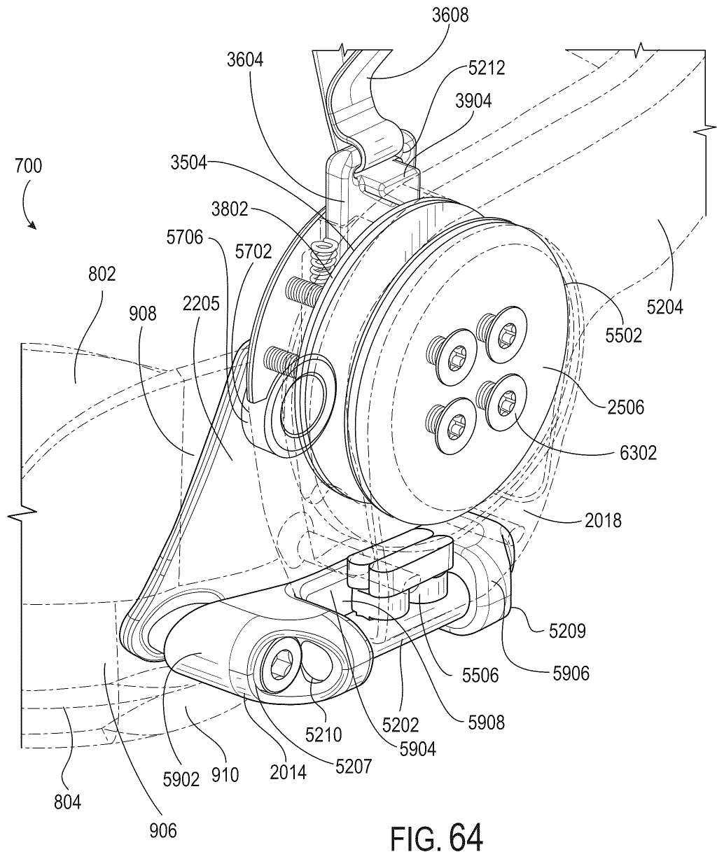

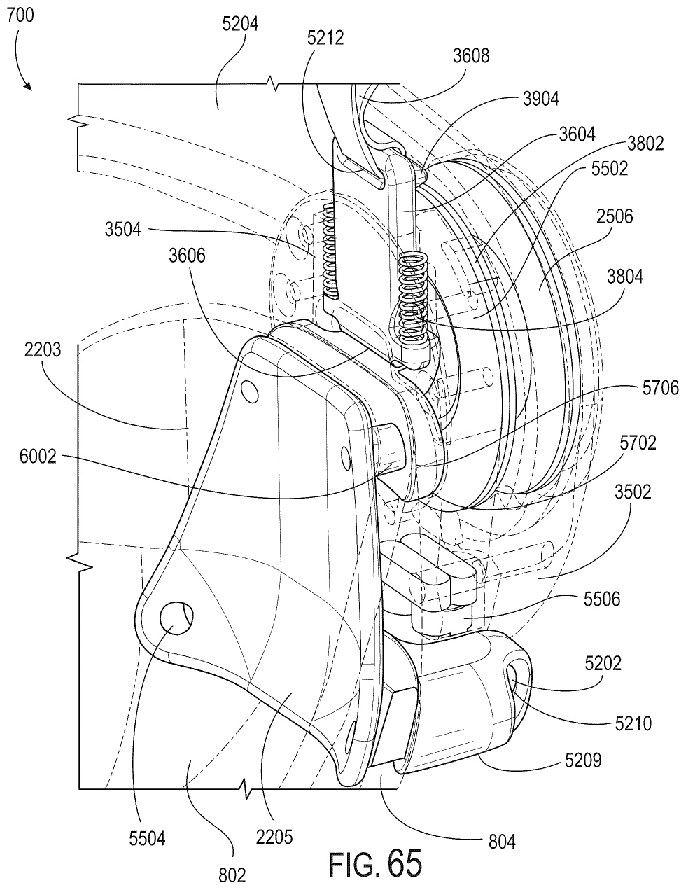

Referring now to FIGS. 52-67, the actuator adapter 2018 can connect to the footplate adapter 2014 using a magnetic (e.g., attractive, etc.) attachment mechanism. The magnetic attachment mechanism can be a toolless method to attach a lower limb exoskeleton (e.g., actuator module 2016, etc.) or powered shoe actuator to (e.g., actuator module 2016, etc.) a shoe (e.g., shoe 702). The magnetic attachment mechanism can allow the user to hold a proximal end 5201 of the actuator module 2016 and engage the actuator adapter 2018 with the footplate adapter 2014 with multiple joints and degrees of freedom between the user's hand and the actuator adapter 2018. A distal end 5203 of the actuator module 2016 can include the actuator adapter 2018. The magnetic attachment mechanism may not include backlash (e.g., clearance, etc.) and can enable the actuator adapter 2018 to connect to the footplate adapter 2014 without line of sight (e.g., of the user, etc.). The magnetic attachment mechanism can enable the actuator adapter 2018 to disengage from the footplate adapter 2014 in response to at least one of the actuator module 2016 being disconnected from the shin of the user or the actuator adapter 2018 undergoes extreme eversion. The magnetic attachment mechanism can enable the actuator adapter 2018 to disengage from the footplate adapter 2014 in response to the user pulling a tab, such as the tab 3608, near the heel of the user.

The apparatus 700 can include at least one arm 5204 (e.g., member, connection, etc.) The arm 5204 can include one or more ends. The arm 5204 can include a first end 5206 and a second end 5208 opposite the first end 5206. The first end 5206 can be coupled to the actuator module 2016. The second end 5208 can be coupled to the actuator adapter 2018. In some implementations, the arm 5204 is the link 2508. The actuator adapter 2018 can be coupled to the second end 5208 via the subtalar joint 2506. The first end 5206 can be coupled to the actuator module 2016 via the ankle joint 2504. The arm 5204 can exert a torque across the ankle joint 2504.

The arm 5204 can be formed from a material. For example, the arm 5204 can be formed from a metal, ceramic, polymer, composite, or any combination thereof. The arm 5204 can be formed from a different material or the same material as the actuator module 2016 or the actuator adapter 2018. The arm 5204 can be formed from at least one of aluminum or steel. The arm 5204 can be curved. For example, the ankle joint 2504 can extend along a first plane, and the subtalar joint 2506 can extend along a second plane, the second plane perpendicular to the first plane. At least a portion of the arm 5204 can extend along the first plane and at least a portion of the arm 5204 can extend along the second plane.

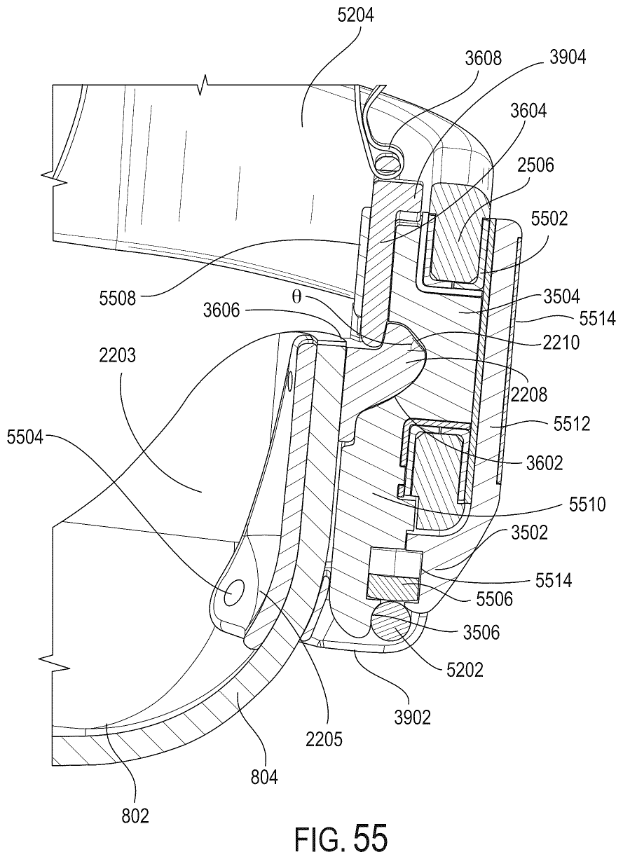

The subtalar joint 2506 can include at least one bearing 5502, shown in FIG. 55, among others. The bearing 5502 can be formed from a material, such as a metal, polymer, ceramic, or any other wear-resistant material. For example, the bearing 5502 can be formed from bronze or plastic. The bearing 5502 can stabilize rotation of the arm 5204 about the subtalar joint 2506 and reduce friction of the subtalar joint 2506 against the arm 5204 and the actuator adapter 2018.

As shown in FIG. 55, among others, the footplate 802 can include the footplate insert 2205. The footplate insert 2205 can be bonded to the footplate 802 via, for example, an adhesive or an epoxy. The footplate insert 2205 can be bonded to the footplate 802 prior to coupling of the footplate adapter 2014 with the footplate 802. Following attachment of the footplate insert 2205 with the footplate 802, the footplate adapter 2014 can be coupled to the footplate 802. The footplate insert 2205 can define at least one aperture 5504. To connect the footplate adapter 2014 to the footplate 802, the apparatus 700 can include at least one of the bolts 2302 to attach the footplate adapter 2014 to the footplate 802 via the bolt 2302 and the aperture 5504. The bolt 2302 can extend at least partially through the footplate adapter 2014, the footplate 802, and the aperture 5504 to couple the footplate adapter 2014 to the footplate 802.

The footplate adapter 2014 can include at least one ferrous pin 5202 (e.g., bar, shaft, etc.) as shown in FIG. 52, among others. The footplate adapter 2014 can include at least one pin connector 5209. The pin connector 5209 can be coupled to the footplate 802 via the bolts 2302. The pin connector 5209 can define at least one aperture 5207. The bolt 2302 can extend through the aperture 5207 to couple the pin connector 5209 to the footplate 802. The bolts 2302 can extend at least partially through the footplate insert 2205. The pin connector 5209 can define at least one aperture 5210. The ferrous pin 5202 can extend through the aperture 5210. The ferrous pin 5202 can be formed of a material, such as metal. The pin connector 5209 can be formed from a material, such as a metal. The pin connector 5209 can be coupled to the lower portion 910 of the posterior portion 804, and the ferrous pin 5202 can be disposed on the lower portion 910. At least a portion of the pin connector 5209 can be perpendicular to the outer surface 906. In some implementations, the ferrous pin 5202 is coupled to the pin connector 5209. For example, the ferrous pin 5202 can be welded, adhered to, or integrated with the pin connector 5209, among others.

The ferrous pin 5202 may not be in contact with the outer surface 906. The ferrous pin 5202 can extend laterally relative to the outer surface 906. For example, the outer surface 906 can extend along a first plane, and the ferrous pin 5202 can extend along a second plane, the second plane parallel to and offset from the first plane. The ferrous pin 5202 can be in contact with the bolt 2302.

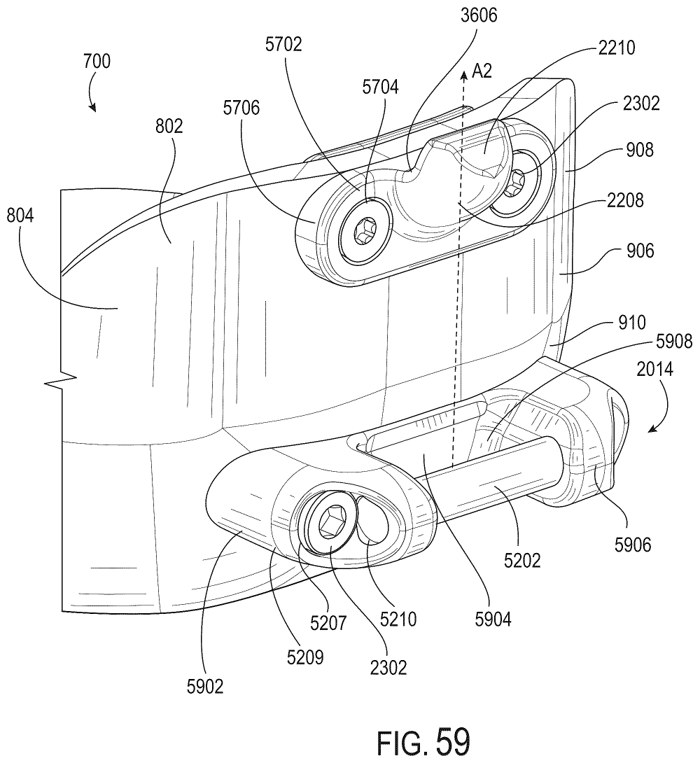

Referring now to FIG. 59, the footplate adapter can include the catch 2208. The catch 2208 can be coupled to the footplate 802 via at least one catch connector 5702. The catch 2208 can be contiguous with the catch connector 5702. The catch connector 5702 can be coupled to the upper portion 908 of the posterior portion 804, and the catch 2208 can be disposed on the upper portion 908. The catch connector 5702 and the pin connector 5209 can be separated on the posterior portion 804 by a distance. The distance can be between 10 to 40 millimeters (mm), inclusive. For example, the catch connector 5702 and the pin connector 5209 can be separated by 25 mm. The catch 2208 and the catch connector 5702 can be formed of a material, such as metal.

The catch 2208 can be aligned with the ferrous pin 5202. For example, a midpoint of the catch 2208 can be aligned with a midpoint of the ferrous pin 5202. The catch connector 5702 and the pin connector 5209 can be centered on an axis A2, enabling the catch 2208 to be aligned with the ferrous pin 5202.

The catch connector 5702 can define at least one aperture 5704. The catch connector 5702 can be coupled to the footplate 802 via the bolts 2302 extending through the aperture 5704 and to the footplate insert 2205. The catch connector 5702 can include at least one wing 5706 (e.g., portion, extension, etc.). The wing 5706 can distribute a load of and experienced by the catch 2208. For example, the catch 2208 can contact the actuator adapter 2018, and the wing 5706 can distribute a load of the actuator adapter 2018 across the catch connector 5702. The wing 5706 can define the aperture 5704, and the catch connector 5702 can be attached to the footplate 802 at the wing 5706. In some implementations, at least one of the pin connector 5209, the ferrous pin 5202, the catch connector 5702, or the catch 2208 are formed from stainless steel, steel, iron, or any combination thereof.

As shown in FIG. 59, the pin connector 5209 can include one or more portions. The pin connector 5209 can include a first portion 5902, a second portion 5904, and a third portion 5906. At least one of the first portion 5902, the second portion 5904, and the third portion 5906 can be contiguous with at least one of the first portion 5902, the second portion 5904, and the third portion 5906. The first portion 5902 and the third portion 5906 can define the aperture 5207 and the aperture 5212. The first portion 5902 and the third portion 5906 can define the aperture 5207 and the aperture 5212 such that the aperture 5212 extends perpendicular to the aperture 5207.

The footwear adapter 2014 can define a space 5908 between the ferrous pin 5202 and the pin connector 5209. For example, the ferrous pin 5202 can be in contact with the first portion 5902 and the third portion 5906, and not in contact with the second portion 5904. The space 5908 can receive the actuator adapter 2018 such that the distal portion 3502 extends at least partially through the space 5908 and is in contact with the ferrous pin 5202 and the second portion 5904. A distance from the second portion 5904 to the ferrous pin 5202 can be less than a length of the ferrous pin 5202. In various implementations, the catch connector 5702 and the catch 2510 can extend a distance away from the outer surface 906 equal to a distance the pin connector 5209 extends away from the outer surface 906. In other implementations, the distance that the catch connector 5702 and the catch 2510 extends away from the outer surface 906 is less than or greater than the distance the pin connector 5209 extends away from the outer surface 906.

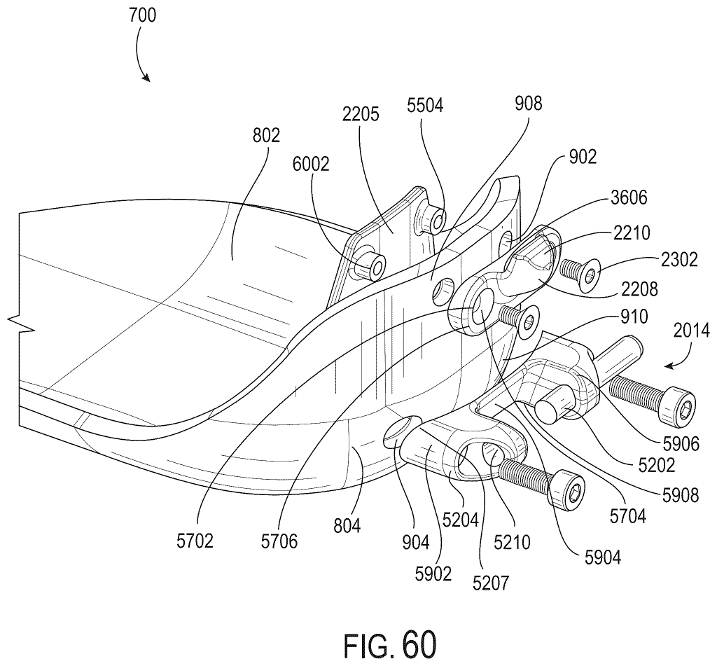

As shown in FIG. 60, among others, in various implementations, the first aperture 902 can be a plurality of first apertures 902, and the second aperture 904 can be a plurality of second apertures 904. The apertures 5207 and the apertures 5504 can align with the first apertures 902 to couple the catch connector 5702 to the footplate 802 and the footplate insert 2205. The apertures 5207 and the apertures 5504 can align with the second apertures 904 to couple the pin connector 5209 to the footplate 802 and the footplate insert 2205. The footplate insert 2205 can include at least one protrusion 6002 (e.g., bores, etc.). The protrusions 6002 can define the apertures 5504. The protrusions 6002 can extend at least partially through the footplate 802 via the first apertures 902 and the second apertures 904. In various implementations, the protrusions 6002 extend partially through at least one of the apertures 5207 or the apertures 5207.

The actuator adapter 2018, as shown in at least FIG. 55, among others, can include one or more magnets 5506 configured to engage with the footplate adapter 2014. The magnets 5506 can be disposed on the distal portion 3502. The magnets 5506 can be configured to engage with the ferrous pin 5202. For example, the magnets 5506 and the ferrous pin 5202 can generate a magnetic force to attract the actuator adapter 2018 to the ferrous pin 5202. The magnetic force can align the actuator adapter 2018 with the footplate adapter 2014. The ferrous pin 5202 and the magnets 5506 can be formed from a magnetic material, such as ferromagnetic, alnico, ferrite, or any other magnetic material. For example, the ferrous pin 5202 can be formed from iron and the magnets 5506 can be formed from steel. The magnets 5506 can include neodymium magnets.

The distal portion 3502 can define (e.g., include, etc.) a concave portion 3506. The concave portion 3506 can be configured to receive and contact the ferrous pin 5202 upon attraction of the magnets 5506 to the ferrous pin 5202. In some implementations, a portion of the magnets 5506 can be exposed by the distal portion 3502 at the concave portion 3506. The concave portion 3506 while in contact with the ferrous pin 5202 can extend at least partially around the ferrous pin 5202.

The actuator adapter 2018 can include the latch 3604. The latch 3604 can be configured to engage with the footplate adapter 2014. For example, the latch 3604 can couple the actuator adapter 2018 to the footplate adapter 2014 by contacting and, for example, hooking onto a portion of the footplate adapter 2014. The latch 3604 can be disposed on the proximal portion 3504. The latch 3604 can be configured to engage with the catch 2208. The actuator adapter 2018 can define the recess 3602 disposed between the distal portion 3502 and the proximal portion 3504. The recess 3602 can be configured to receive and be in contact with the catch 2208. The recess 3602 can receive the catch 2208 following contact of the concave portion 3506 with the ferrous pin 5202. In some implementations, the latch 3604 can define a portion of the recess 3602.

As the recess 3602 receives the catch 2208, the latch 3604 can contact the ramp 2210. The ramp 2210 can be configured to engage with the latch 3604, and as the catch 2208 moves towards contact with the actuator adapter 2018, the latch 3604 can move on the ramp 2210. For example, the latch 3604 can move up the ramp 2210 towards the outer surface 906. As the actuator adapter 2018 moves towards the outer surface 906 and subsequently the latch 3604 moves up the ramp 2210, the latch 3604 can drop to the receiving space 3606, thereby attaching the actuator adapter 2018 to the footplate adapter 2014. The actuator adapter 2018 can include the spring 3804 in contact with the latch 3604. Consequently, the latch 3604 can be spring-loaded such that as the latch 3604 moves up the ramp 2210, the spring 3804 is compressed and stores potential energy and upon the latch 3604 dropping to the receiving space 3606, the spring 3804 turns the potential energy into kinetic energy. An angle of the ramp 2210 and the latch 3604 can allow for removal of backlash while mitigating back driving.

To attach the actuator adapter 2018 to the footplate adapter 2014, the magnetic force of the magnets 5506 and the ferrous pin 5202 can attract the actuator adapter 2018 to the ferrous pin 5202 while the user moves the arm 5204 and actuator module 2016 to engage the latch 3604 with the ramp 2210. For example, the user can move at least the actuator adapter 2018 about, for example, the sagittal plane 214, to engage the latch 3604 with the ramp 2210 following contact of the concave portion 3506 with the ferrous pin 5202. The user can hold the actuator module 2016 at the proximal end 5201 to engage the latch 3604 with the ramp 2210, thereby mitigating significant bending of the user. For example, the user can actuate a force towards the footplate 802 once the actuator adapter 2018 and the ferrous pin 5202 are in contact to rotate the recess 3602 towards the outer surface 906 and engage the latch 3604 with the ramp 2210.

The audible cue can be created (e.g., generated, etc.) by the latch 3604 moving from a depressed (e.g., in contact with the ramp 2210, etc.) to an undepressed position (e.g., in contact with the receiving space 3606, etc.). The audible cue can be generated along with the latch 3604 moving past a mating catch surface (e.g., the ramp 2210, etc.), at which point potential energy (e.g., spring energy, etc.) can be converted to kinetic energy as the latch 3604 moves to contact the receiving space 3606. The latch 3604 can collide with the receiving space 3606 and create a sound.

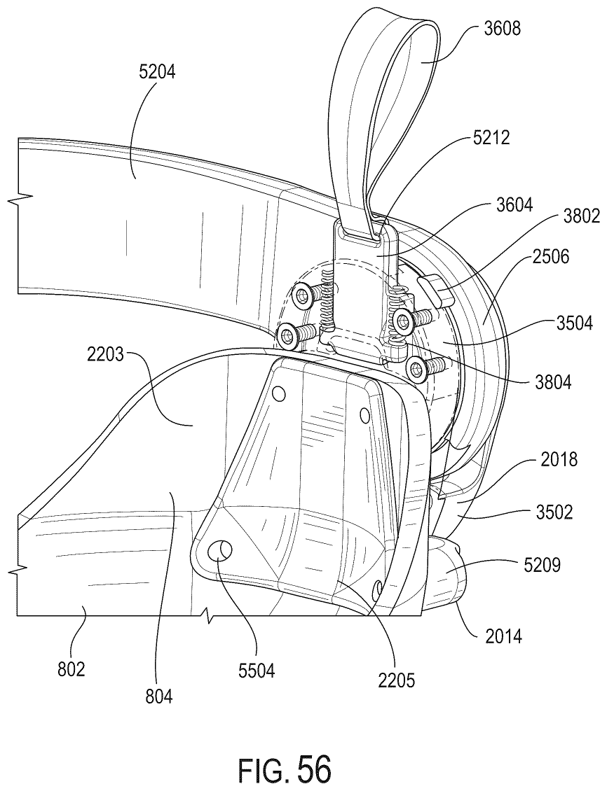

In response to the actuator module 2016 being in use, such as applying force to the footplate 802 to augment movement of the user, loads exerted by the actuator module 2016 may be exerted on the ferrous pin 5202 and distributed to the wings 5706. To mitigate the footplate adapter 2014 from being removed from the footplate 802 by the loads, the footplate insert 2205, as shown in FIG. 56, among others, can include at least four aperture 5504, and can span an area greater than the footplate insert 2205 of FIG. 22. The footplate insert 2205 can extend from the upper portion 908 to the lower portion 910 of the posterior portion 804. The footplate insert 2205 in at the upper portion 908 can have a length less than a length of the footplate insert 2205 in the lower portion 910. The length of the footplate insert 2205 in the lower portion 910 can correspond to (e.g., be equal to, etc.) a length of the pin connector 5209. The length of the footplate insert 2205 in the upper portion 908 can correspond to (e.g., be equal to, etc.) a length of the catch connector 5702. The footplate insert 2205 can provide stability to the footplate adapter 2014, distribute a load experienced by the footplate adapter 2014 to the footplate 802, and maintain the coupling of the footplate adapter 2014 to the footplate 802.

To disconnect the actuator adapter 2018 from the footplate adapter 2014, the apparatus 700 can include the stop 3802 and the latch 3604 can include the ramp 3904. The stop 3802 can engage the latch 3604 upon rotation of the subtalar joint 2506 by, for example, the arm 5204. The stop 3802 can contact the ramp 3904 in response to excessive eversion of the subtalar joint 2506. The stop 3802 can raise (e.g., push up, push away from the footplate 802, etc.) the latch 3604 such that the latch 3604 is moved out from the receiving space 3606 and disengages the actuator adapter 2018 from the footplate adapter 2014. The disengagement allows the actuator adapter 2018 to rotate off the footplate 802, allowing for safe removal of the actuator module 2016 in situations where, for example, the actuator module 2016 is accidentally disconnected from a shin of the user.

In other implementations, to disconnect the actuator adapter 2018 from the footplate adapter 2014, the user can apply force to the latch 3604, such as applying a force to move the latch 3604 from the receiving space 3606. The actuator adapter 2018 can include the tab 3608. As shown in at least FIG. 52, among others, the latch 3604 can define an aperture 5212, and the tab 3608 can extend through the aperture 5212. The user can apply the force to the tab 3608 to pull the latch 3604 from the receiving space 3606 and disconnect the actuator adapter 2018 from the footplate adapter 2014.

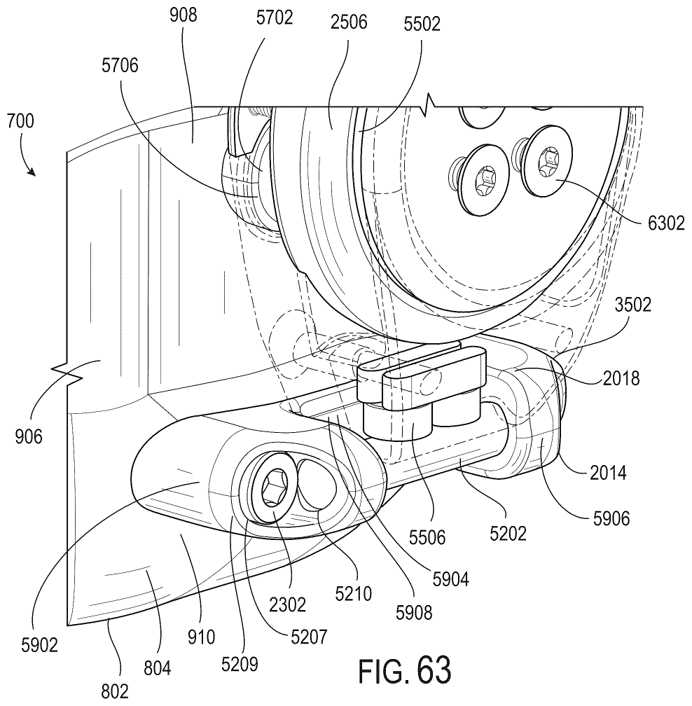

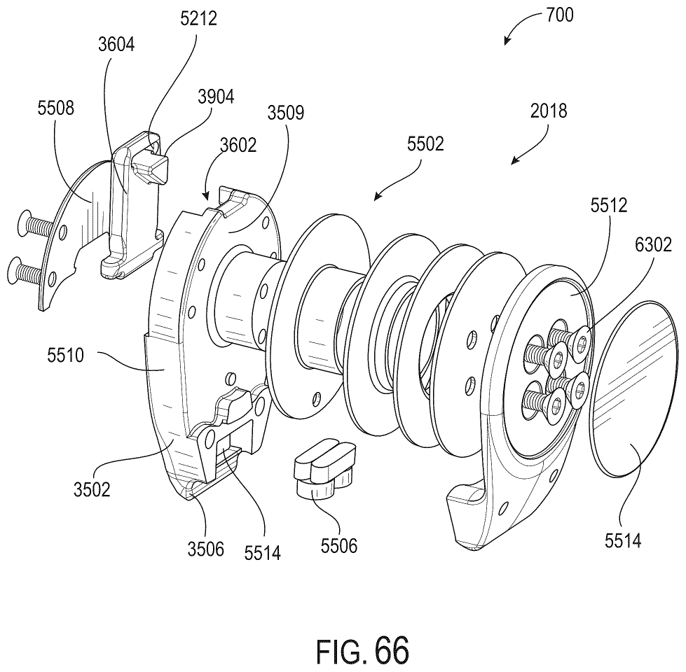

FIG. 66 depicts an example of the actuator adapter 2018, and in various implementations, a portion of the subtalar joint 2506. The concave portion 3506 can be located on the distal portion 3502 of the actuator adapter 2018, and can be located below the magnets 5506. Referring back to FIG. 55, the actuator adapter 2018 can include a first panel 5508 (e.g., portion, piece, etc.), a second panel 5510, and a third panel 5512. Referring back to FIG. 63, the first panel 5508, the second panel 5510, and the third panel 5512 can be coupled by one or more bolts 6302. The latch 3604 can be located between the first panel 5508 and the second panel 5510. The concave portion 3506 can be defined by a portion of the second panel 5510 and the third panel 5512. The magnets 5506 can be located between the second panel 5510 and the third panel 5512. The second panel 5510 and the third panel 5512 can define a recess 5514, and the magnets 5506 can be located in the recess 5514.

The second panel 5510 can define the recess 3602. The first panel 5508 can be coupled to the second panel 5510 by the bolts 6302, and the latch 3604 can be in contact with the first panel 5508 and the second panel 5510. The bearing 5502 can be located between the second panel 5510 and the third panel 5512. In some implementations, the subtalar joint 2506 can include at least one of the bearing 5502. The second panel 5510 can be coupled to the third panel 5512 via the bolts 6302. In various implementations, the actuator adapter 2018 includes a fourth panel 5514. The fourth panel 5514 can be in contact with the third panel 5512, and can obscure the bolts 6302 from the external environment.

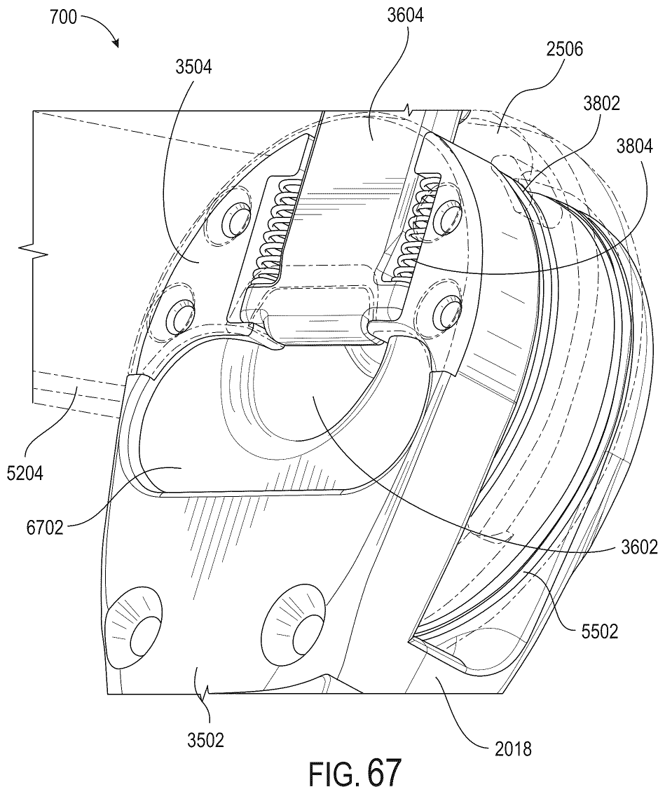

As shown in FIG. 67, among others, the actuator adapter 2018 can define at least one recess 6702. The recess 6702 can be contiguous with the recess 3602. The recess 6702 can have a shape matching the catch connector 5702, and the catch connector 5702 can be received by the recess 6702 and in contact with the actuator adapter 2018 within the recess 6702. The recess 6702 can receive and have a shape matching the wings 5706.

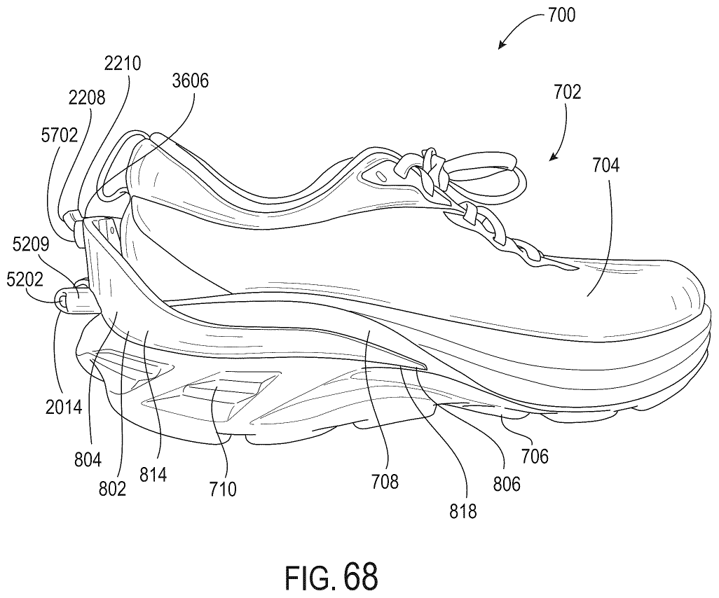

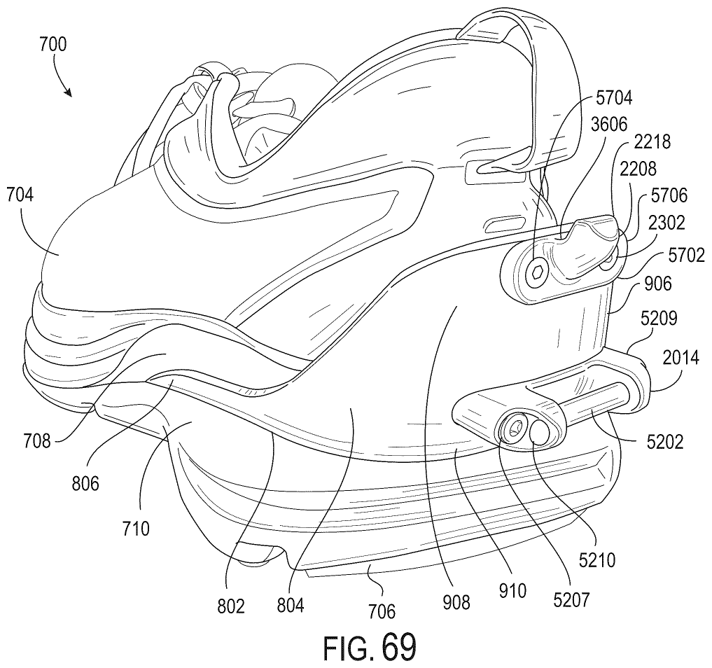

FIGS. 68-69 depict the shoe 702 with the footplate adapter 2014 as described with respect to FIGS. 52-67. The catch connector 5702 can be coupled to the upper portion 908 of the posterior portion 804, and the pin connector 5209 can be coupled to the lower portion 910 of the posterior portion 804. As shown in FIG. 68, among others, in some implementations, the posterior portion 804 may not be in contact with at least a portion of the shoe 702, such as the upper 704. The footplate 802 can be bonded to at least one of the lower midsole 710 or the upper midsole 708 via at least one of an adhesive, epoxy, or any other form of coupling.

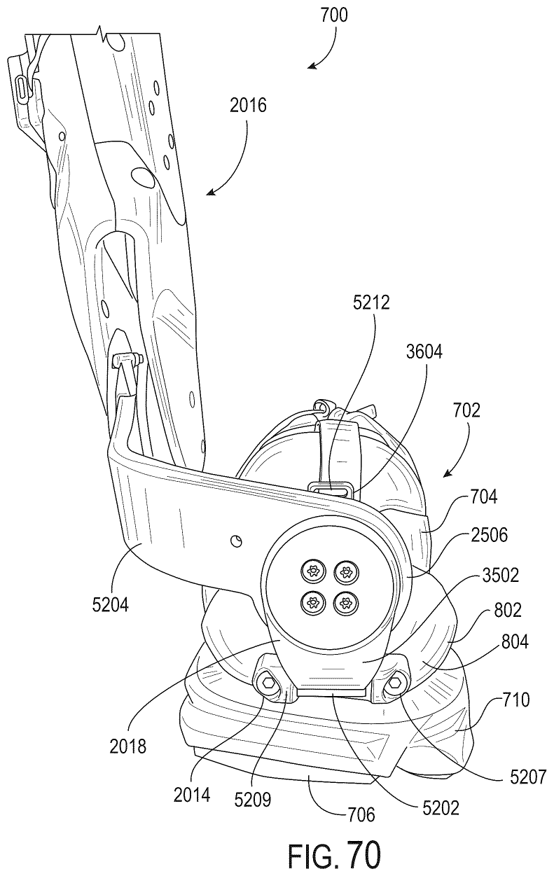

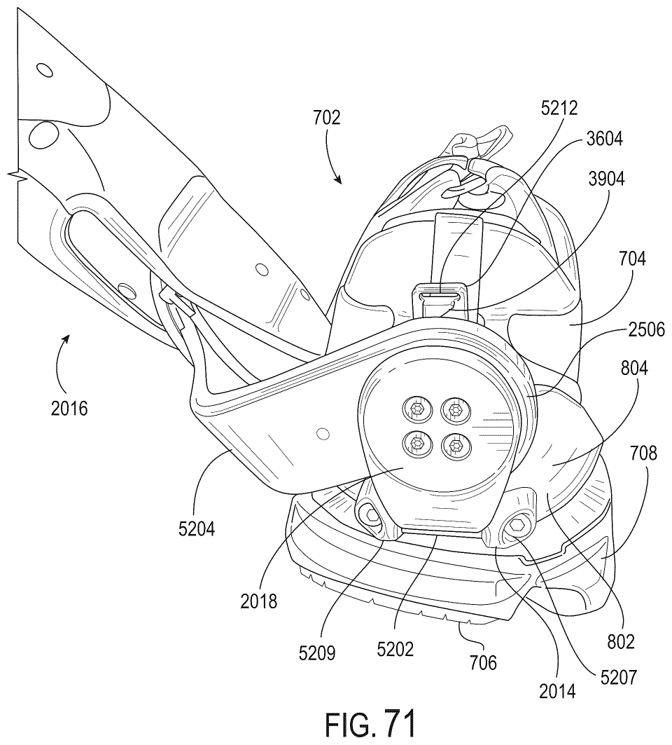

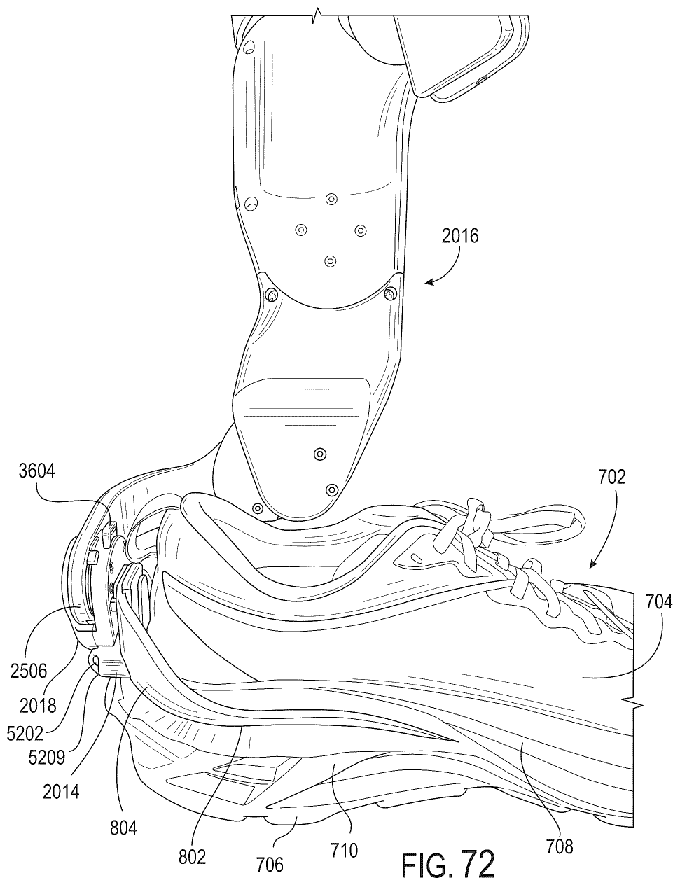

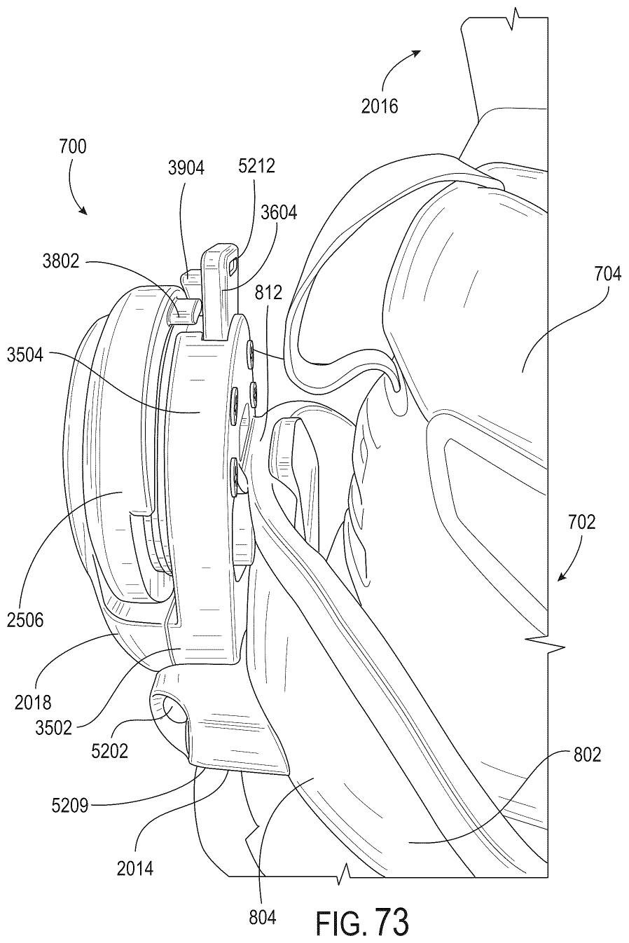

FIGS. 70-74 depict the shoe 702 of FIGS. 68-69 with the actuator module 2016, arm 5204, and the actuator adapter 2018 as described with respect to FIGS. 52-67. The actuator adapter 2018 can be coupled to and engaged with the footplate adapter 2014 in FIGS. 70-73. The actuator adapter 2018 may not include the tab 3608. Consequently, to disconnect the actuator adapter 2018 from the footplate adapter 2014, the user can apply a force to the latch 3604. The latch 3604 shown in FIGS. 70-73, among others, can be in contact with the receiving space 3606.

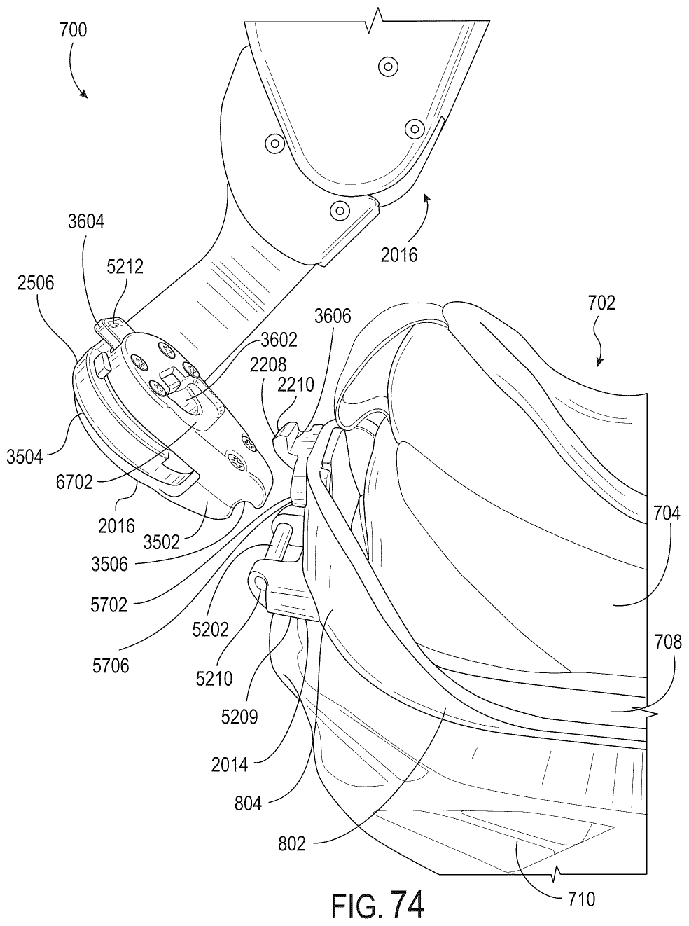

FIG. 74 depicts the actuator adapter 2018 angled to contact and engage with the ferrous pin 5202. To engage the actuator adapter 2018 with the footplate adapter 2014, the actuator adapter 2018 can first contact the ferrous pin 5202 via the magnetic attraction of the magnets 5506 with the ferrous pin 5202. Following contact of the concave portion 3506 with the ferrous pin 5202, the actuator adapter 2018 can be rotated towards the catch 2208 such that the catch 2208 enters the recess 3602 and the latch 3604 can contact the ramp 2210. The actuator adapter 2018 can be rotated towards the catch 2208 until the latch 3604 contacts the receiving space 3606, indicating a complete engagement (e.g., connection, etc.) of the actuator adapter 2018 with the footplate adapter 2014.

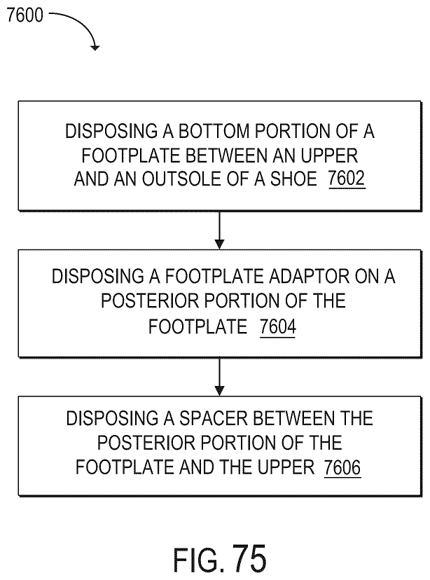

Referring now to FIG. 75, an example method 7500 for assembling the apparatus 700 is shown. The method 7500 can include an ACT 7502 for disposing a bottom portion of a footplate between an upper and an outsole of a shoe. The method 7500 can include an ACT 7504 for disposing a footplate adapter on a posterior portion of the footplate. The method 7500 can include an ACT 7506 for disposing a spacer between the posterior portion of the footplate and the upper. At least a portion of the method 7500 can be performed by any manufacturing system, apparatus, or device. A least a portion of the method 7500 can be performed by a technician, manufacturing individual, assembly individual, etc.

At ACT 7502, the method 7500 can include disposing a bottom portion of a footplate between an upper and an outsole of a shoe. The method 7500 can include disposing an upper midsole between the upper and the footplate. The method 7500 can include disposing a lower midsole between the footplate and the outsole. The method 7500 can include partially encapsulating a heel portion of the footplate and a midfoot portion of the footplate by the upper midsole and the lower midsole. The method 7500 can include entirely encapsulating a forefoot portion of the footplate by the upper midsole and the lower midsole.

In some implementations, the method 7500 can include disposing fibers in the footplate to increase at least one of stiffness, strength, or flexibility of the footplate. The method 7500 can include orienting the fibers in the footplate to increase at least one of stiffness, strength, or flexibility of the footplate. The method 7500 can include forming the footplate with one or more layers of a material, such as a composite material, and can include orienting the fibers of each of the layers. The method 7500 can include forming the footplate with a drop between a heel portion and a midfoot portion, and a lift between the midfoot portion and a forefoot portion.

At ACT 7504, the method 7500 can include disposing a footplate adapter on a posterior portion of the footplate. The method 7500 can include configuring the footplate adapter to couple with an actuator adapter coupled with an actuator module. The method 7500 can include disposing the footplate adapter on an outer surface of the posterior portion of the footplate. The method 7500 can include forming the footplate to include the bottom portion and the posterior portion. To dispose the footplate adapter on the footplate, the method 7500 can include coupling the footplate adapter to the footplate. For example, the method 7500 can include coupling footplate adapter to the footplate by at least one of welding, fasteners, adhesives, or any combination thereof.

At ACT 7506, the method 7500 can include disposing a spacer between the posterior portion of the footplate and the upper. The method 7500 can include configuring the spacer to compress upon application of force to the footplate by the actuator module. The method 7500 can include separating the posterior portion of the footplate and the upper by a gap. The method 7500 can include disposing the spacer in the gap. The method 7500 can include disposing a protrusion of the spacer over an upper edge of the posterior portion of the footplate. The method 7500 can include forming the spacer with at least one of a foam, elastomer, gel, or a combination thereof. The method 7500 can include forming the spacer with the protrusion. In some implementations, the method 7500 can include coupling the spacer to at least one of the posterior portion or the upper. For example, the method 7500 can include adhering the spacer to at least one of the posterior portion or the upper.

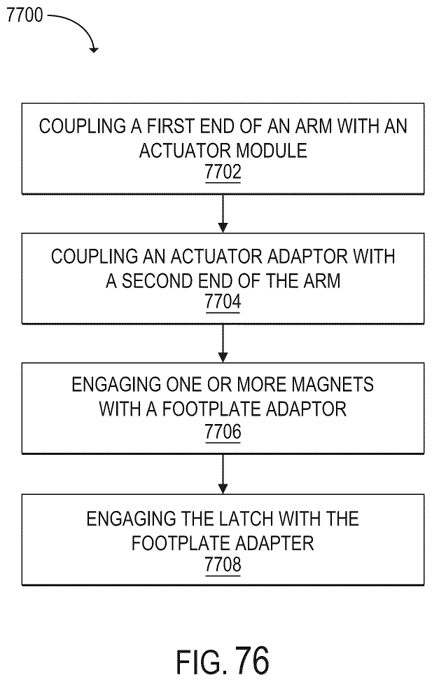

Referring now to FIG. 76, an example method 7600 for assembling the apparatus 700 is shown. The method 7600 at ACT 7602 can include coupling a first end of an arm with an actuator module. The method 7600 at ACT 7604 can include coupling an actuator adapter with a second end of the arm. The method 7600 at ACT 7606 can include engaging one or more magnets with a footplate adapter. The method 7600 at ACT 7608 can include engaging a latch with the footplate adapter. At least a portion of the method 7600 can be performed by any manufacturing system, apparatus, or device. A least a portion of the method 7600 can be performed by a technician, manufacturing individual, assembly individual, etc.

At ACT 7602, the method 7600 can include coupling a first end of an arm with an actuator module. The method 7600 can include coupling the first end with the actuator module by at least one of welding, adhesives, fasteners, or any combination thereof. The method 7600 can include providing and forming the actuator module, and providing and forming the arm. The method 7600 can include forming the arm from a material, such as a metal, ceramic, polymer, or any combination thereof.

At ACT 7604, the method 7600 can include coupling an actuator adapter with a second end of the arm. The method 7600 can include forming the actuator adapter with one or more magnets and a latch. The method 7600 can include forming the actuator adapter to include a distal portion and a proximal portion, the one or more magnets disposed on the distal portion and the latch disposed on the proximal portion. The method 7600 can include coupling the magnets to the actuator adapter. The method 7600 can include forming the latch from a material, such as a metal, ceramic, polymer, or any combination thereof.

At ACT 7606, the method 7600 can include engaging one or more magnets with a footplate adapter. The method 7600 can include disposing the footplate adapter on a posterior portion of a footplate of a shoe. The method 7600 can include coupling a recess of the actuator adapter with a catch disposed on an upper portion of the posterior portion of the footplate. The method 7600 can include coupling a concave portion of the distal portion with a ferrous pin disposed on a lower portion of the posterior portion of the footplate. The method 7600 can include disposing a ferrous pin on a lower portion of the posterior portion of the footplate. The method 7600 can include disposing a catch on an upper portion of the posterior portion of the footplate.

At ACT 7608, the method 7600 can include engaging a latch with the footplate adapter. The method 7600 can include decoupling the actuator adapter with the footplate adapter by releasing the latch. The method 7600 can include coupling the actuator adapter with the footplate adapter by setting the latch. The method 7600 can include engaging the latch with a catch disposed on an upper portion of the posterior portion of the footplate. The method 7600 can include applying, by the actuator module, a force to rotate the arm and the actuator adapter. The method 7600 can include disconnecting or connecting the actuator adapter to the footplate adapter along with rotation of the arm.

As utilized herein, the terms “approximately,” “about,” “substantially,” and similar terms are intended to have a broad meaning in harmony with the common and accepted usage by those of ordinary skill in the art to which the subject matter of this disclosure pertains (e.g., plus or minus 10%). It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

1. An apparatus, comprising:
a shoe including an upper and an outsole;
a footplate including a posterior portion and a bottom portion, the bottom portion of the footplate disposed between the upper and the outsole;
a footplate adapter disposed on the posterior portion of the footplate and configured to couple with an actuator adapter coupled with an actuator module; and
a spacer disposed between the posterior portion of the footplate and the upper, the spacer configured to compress upon application of force to the footplate by the actuator module.

2. The apparatus of claim 1, wherein:
the posterior portion of the footplate and the upper is separated by a gap, and
the spacer is disposed in the gap.

3. The apparatus of claim 1, wherein the shoe includes an upper midsole disposed between the upper and the footplate and a lower midsole disposed between the footplate and the outsole.

4. The apparatus of claim 3, wherein:
the spacer has a first durometer, the upper midsole has a second durometer, and the lower midsole has a third durometer, and
the first durometer is less than the second durometer and the third durometer.

5. The apparatus of claim 3, wherein:
the footplate includes a heel portion, a forefoot portion, and a midfoot portion extending between the heel portion and the forefoot portion,
the heel portion and the midfoot portion are partially encapsulated by the upper midsole and the lower midsole, and
the forefoot portion is entirely encapsulated by the upper midsole and the lower midsole.

6. The apparatus of claim 3, wherein:
a back portion of the upper midsole defines a recess, and
the spacer is disposed in the recess.

7. The apparatus of claim 1, wherein the spacer includes a protrusion disposed over an upper edge of the posterior portion of the footplate.

8. The apparatus of claim 1, wherein the spacer comprises at least one of a foam, elastomer, gel, or a combination thereof.

9. The apparatus of claim 1, wherein the footplate adapter includes:
a ferrous pin disposed on a lower portion of the posterior portion of the footplate and configured to couple with a distal portion of the actuator adapter; and
a catch disposed on an upper portion of the posterior portion of the footplate and configured to engage with a latch of the actuator adapter.

10. The apparatus of claim 9, wherein the catch includes a ramp configured to engage with the latch.

11. The apparatus of claim 1, wherein the footplate includes fibers configured to increase at least one of stiffness, strength, or flexibility of the footplate.

12. The apparatus of claim 1, wherein the footplate adapter is disposed on an outer surface of the posterior portion of the footplate.

13. A method, comprising:
disposing a bottom portion of a footplate between an upper and an outsole of a shoe;
disposing a footplate adapter on a posterior portion of the footplate, the footplate adapter configured to couple with an actuator adapter coupled with an actuator module; and
disposing a spacer between the posterior portion of the footplate and the upper, the spacer configured to compress upon application of force to the footplate by the actuator module.

14. The method of claim 13, comprising:
separating the posterior portion of the footplate and the upper by a gap; and
disposing the spacer in the gap.

15. The method of claim 13, comprising:
disposing an upper midsole between the upper and the footplate; and
disposing a lower midsole between the footplate and the outsole.

16. The method of claim 15, comprising:
partially encapsulating a heel portion of the footplate and a midfoot portion of the footplate by the upper midsole and the lower midsole, and
entirely encapsulating a forefoot portion of the footplate by the upper midsole and the lower midsole.

17. The method of claim 13, comprising:
disposing a protrusion of the spacer over an upper edge of the posterior portion of the footplate.

18. The method of claim 13, wherein the spacer comprises at least one of a foam, elastomer, gel, or a combination thereof.

19. The method of claim 13, comprising:
disposing fibers in the footplate to increase at least one of stiffness, strength, or flexibility of the footplate.

20. The method of claim 13, comprising:
disposing the footplate adapter on an outer surface of the posterior portion of the footplate.

21-40. (canceled)
